(19) United States
(12) Patent Application Publication
(10) Pub. No.: US 2023/0382934 A1
(43) Pub. Date: Nov. 30, 2023

(54) HIGH ENTROPY OXIDES AND METHODS OF SYNTHESIS AND USE THEREOF

(71) Applicant: Auburn University, Auburn, AL (US)

(72) Inventors: Christian R. Goldsmith, Auburn, AL (US); Sana Karbalaei, Auburn, AL (US)

(21) Appl. No.: 18/324,555

(22) Filed: May 26, 2023

Related U.S. Application Data
(60) Provisional application No. 63/346,641, filed on May 27, 2022.

(51) Int. Cl. C07F 13/00; C07F 15/02

(52) U.S. Cl. CPC C07F 13/00; C07F 15/02

(57) ABSTRACT

The present invention provides compositions of compounds comprising a metal M and a macrocyclic ligand represented by General Formula I, and contrast agents comprising the compositions thereof. In various embodiments, the present invention also relates to methods of enhancing methods of enhancing magnetic resonance imaging (MRI) in a living subject, the method comprising administering to a subject an effective amount of a contrast agent comprising a solution or suspension of the composition thereof.

### CROSS REFERENCE TO RELATED APPLICATIONS

This application claims priority to and the benefit of U.S. Provisional Application No. 63/346,641, filed May 27, 2022, the disclosure of which is incorporated herein by reference herewith in its entirety.

### STATEMENT REGARDING FEDERALLY SPONSORED RESEARCH OR DEVELOPMENT

This invention was made with government support under Award Nos. 1662875 and 1954336 awarded by the National Science Foundation. The government has certain rights in the invention.

### BACKGROUND OF THE INVENTION

Imaging-related medications or contrast agents are commonly utilized to improve the visualization of radiographic, computed tomography (CT), and magnetic resonance (MRI) images. Such contrast agents contain molecules that have high X-ray attenuation. For instance, iodine and barium-based contrast agents are used in medical applications owing to the high atomic number and high X-ray attenuation properties of iodine. These agents are essential to accurate diagnoses and are nearly always safe and effective when administered correctly.

Reactive oxygen species (ROS), including singlet oxygen, superoxide, hydrogen peroxide, and hydroxyl radical, have long been subjects of research due to their central role in cell signaling, the aging process, and the pathogenesis of a variety of diseases such as cardiovascular conditions, diabetes, cancer, Alzheimer's and Parkinson's diseases. However, ROS's high reactivity and short lifetime make them very challenging to detect with current magnetic resonance imaging (MRI) contrasting agents (Tain, R. W. et al., 2018, J. Magn. Reson. Imaging, 47:222).

There are several Food and Drug Administration (FDA)-approved contrast agents for nuclear imaging and diagnosis of disease. Magnetic resonance contrast agents, particularly gadolinium-based agents, are incredibly safe and lack the nephrotoxicity of iodinated contrast media. Seven gadolinium agents are available in one or more countries, of which five are available for clinical use in the United States (Gadopiclenol, Magnevist ProHance, Omniscan, & Optimark). (Hall, J. 2022, Diagnostic Imaging, www.diagnosticimaging.com/view/fda-approves-new-mri-contrast-agent-gadopiclenol; Pierre, V. C. et al., 2014, J. Biol. Inorg. Chem., 19:127) Several methods have been developed for ROS measurement, including optical redox scanning, exogenous contrast magnetic resonance (MR), Overhauser-enhanced MRI, proton-electron double resonance, and obtaining contrast from irradiated radicals. Still, they require exogenous reagents to trap such radicals. Other emerging MRI methods rely on exogenous contrast agents with paramagnetic metallic ions. An ideal ROS imaging should be endogenous and able to determine changes in vivo with high spatial resolution and sensitivity.

The over-production of ROS, such as H₂O₂ and O₂⁻ has been implicated in a wide array of pathologies, including a host of neurological and cardiovascular health conditions (Tretter, L. et al., 2004, Neurochem. Res., 29:569; Roberts, C. K. et al., 2009, Life Sci., 84, 705; Mosley, R. L. et al., 2006, Clin. Neurosci. Res., 6:261; Fearon, I. M. et al., 2009, J. Mol. Cell. Cardiol., 47:372, Eskici, G. et al., 2012, Biochemistry, 51:6289). Given the possible roles of ROS in disease, molecular probes that can be used to non-invasively monitor ROS concentrations in physiological environments are of increased interest. Such sensors could potentially distinguish pathologies with similar clinical symptoms and better inform preventative and ameliorative therapies. To this end, a series of complexes that respond to H₂O₂ with changes in their T₁-weighted relaxivity (r₁) have already been reported (Yu, M. et al., 2014, J. Am. Chem. Soc., 136:12836; Yu, M. et al., 2012, Inorg. Chem., 51:9153; Yu, M. et al., 2017, Inorg. Chem., 56:2812; Hutchinson, T. E. et al., 2019, Inorg. Chim. Acta, 496:119045).

Furthermore, although ROS such as H₂O₂ and O²⁻ have been found to serve beneficial roles in biology, the over-accumulation of these species is often observed in a wide array of pathologies, including several rightly feared cardiovascular and neurological disorders (Laforge, M. et al., 2020, Nat. Rev. Immunol., 20:515; Roberts, C. K. et al., 2009, Life Sci., 84:705; Ahmed, M. I. et al., 2010, J. Am. Coll. Cardiol., 55:671; Sies, H., 2014, J. Biol. Chem., 289:8735). The involvement of ROS in disease has motivated the development of methods to detect ROS in biological settings (Chang, M. C. Y. et al., 2004, J. Am. Chem. Soc., 126:15392; Ekanger, L. A. et al., 2014, Chem. Commun., 50:14835; Lippert, A. R. et al., 2011, Acc. Chem. Res. 44:793; Lou, Z. et al., 2015, Acc. Chem. Res., 48:1358; Miller, E. W. et al., 2005, J. Am. Chem. Soc., 127:16652; Song, B. et al., 2013, Dalton Trans., 42:8066; Srikun, D. et al., 2008, J. Am. Chem. Soc., 130:4596; Tsitovich, P. B. et al., 2014, J. Inorg. Biochem., 133:143; Loving, G. S. et al., 2013, J. Am. Chem. Soc., 135:4620; Wang, H. et al., 2019, J. Am. Chem. Soc., 141:5916).

Thus, there is a need in the art for improved imaging agents for ROS disease diagnosis with MRI. This invention satisfies this unmet need.

### BRIEF SUMMARY OF THE INVENTION

In one aspect, the present invention relates to a compound comprising a metal M and a macrocyclic ligand represented by General Formula I, and any ionic variant thereof:

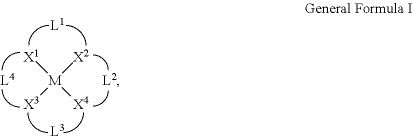

wherein M is a metal is selected from the group consisting of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, rhenium, osmium, iridium, platinum, and any oxidation state thereof,
wherein L¹ to L⁴ are divalent linking groups,
wherein X¹ to X⁴ are each independently selected from O, S, or NR¹,
wherein R¹ is selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, or any conjugate or combination thereof,
wherein at least one of X¹ to X⁴ is represented by NR¹ wherein R¹ is represented by Formula A:

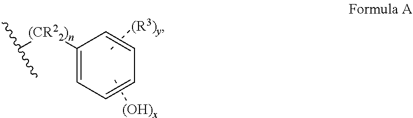

wherein R² and R³ are each independently selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, or combination thereof,
wherein x is an integer from 1 through 5,
wherein y is an integer from 1 through 4,
wherein n is an integer from 1 through 3, and
wherein when the compound is ionic, the compound further comprises a counterion.

In one embodiment, X¹ and X³ are represented by NR¹ wherein R¹ is represented by Formula A. In one embodiment, R² are each hydrogen. In one embodiment, n is 1. In one embodiment, x is 2.

In one embodiment, the metal M is selected from the group consisting of manganese, iron, cobalt, nickel, molybdenum, technetium, ruthenium, cobalt, copper, and rhodium. In one embodiment, the metal is manganese or iron.

In one embodiment, Formula A is represented by Formula B:

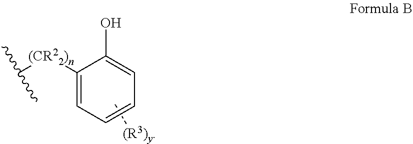

In one embodiment, y is at least 1 and at least one R³ represents hydroxyl. In one embodiment, the OH is coordinated to the metal M. In one embodiment, X¹ and X³ are both represented by NR¹ wherein R¹ is represented by Formula B. In one embodiment, both OH groups are coordinated to the metal M.

In one embodiment, Formula A is represented by Formula C:

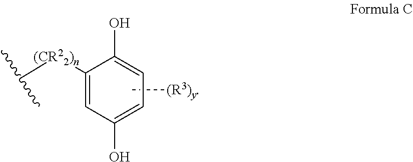

In one embodiment, X¹ and X³ are both represented by NR¹ wherein R¹ is represented by Formula C. In one embodiment, M is further bonded to water.

In one embodiment, a contrast agent comprises the compound.

In one embodiment, the contrast agent is used in an imaging technique selected from the group consisting of magnetic resonance imaging, photoacoustic imaging, thermal imaging, photothermal imaging, and any combination thereof.

In another aspect, the present invention provides a method of enhancing magnetic resonance imaging (MRI) in a living subject, the method comprising the steps of: administering to a subject an effective amount of a composition comprising a contrast agent, and imaging the patient by MRI, wherein the MRI image is enhanced as compared to an MRI image obtained without said contrast agent, wherein the contrast agent comprises a metal M and a macrocyclic ligand represented by General Formula I, or a salt thereof:

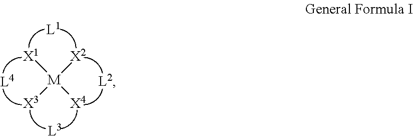

wherein M is a metal is selected from the group consisting of scandium, titanium, vanadium, chromium, manganese, iron, cobalt, nickel, copper, zinc, yttrium, zirconium, niobium, molybdenum, technetium, ruthenium, rhodium, palladium, and silver,
wherein L¹ to L⁴ are divalent linking groups,
wherein X¹ to X⁴ are each independently selected from O, S, or NR¹,
wherein R¹ is selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, or any conjugate or combination thereof,
wherein at least one of X¹ to X⁴ is represented by NR¹ wherein R¹ is represented by Formula A:

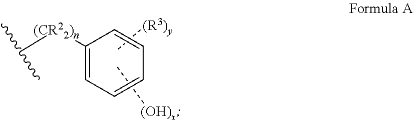

wherein R² and R³ are each independently selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, or any conjugate or combination thereof,
wherein x is an integer from 1 through 5,
wherein y is an integer from 1 through 4,
wherein n is an integer from 1 through 3, and
wherein when the compound is ionic, the compound further comprises a counterion.

In one embodiment, the method further comprises the step of oxidizing the contrast agent with a reactive oxygen species.

In one embodiment, the reactive oxygen species comprises H₂O₂.

In one embodiment, the contrast agent is administered in a concentration of 0.10 to 1.00 mM.

In one embodiment, the contrast agent is administered subcutaneously, intravenously, peritoneally, orally, intramuscular, topical, nasally, intradermally, ocularly, rectally, vaginally, or combinations thereof.

### BRIEF DESCRIPTION OF THE DRAWINGS

The following detailed description of embodiments of the invention will be better understood when read in conjunction with the appended drawings. It should be understood that the invention is not limited to the precise arrangements and instrumentalities of the embodiments shown in the drawings.

FIG. 1 depicts the synthetic scheme of H₄qp4.

FIG. 2, comprising FIG. 2A and FIG. 2B, depicts ORTEP representations. FIG. 2A depicts [H₆qp4]²⁺. FIG. 2B depicts [Mn(H₂qp4)]⁺ (4). All hydrogen atoms, solvent molecules, and counteranions have been removed for clarity. All ellipsoids depict 50% probability.

FIG. 3 depicts UV/Vis spectra depicting the stability of a 0.10 mM solution of 1 in MeCN to air. The reaction was scanned at 0, 1, 2, 3, and 12 h. The band at 304 nm is characteristic of quinol functional groups, whereas the band at 388 nm is characteristic of a quinolate.

FIG. 4 depicts molecular structures of the quinol-containing polydentate ligands and the compositions of coordination complexes mentioned.

FIG. 5 depicts raw potentiometric pH titration data for the addition of 0.08419 M KOH to acidic aqueous solutions containing 100 mM KCl and either A) 1.0 mM H₄qp4 or B) 1.0 mM 1. Each titration was performed at 25° C. under an argon atmosphere.

FIG. 6 depicts a Hyperquad model (red line) overlaid on the experimental data from the potentiometric titration of H₄qp4 (blue). The data above pH 9.5 have been excluded from the calculations since precipitation was observed above this value. The parameters for the Hyperquad model are provided in FIG. 7. The residuals for the fit are provided below. The curves represent the formation of various species including H₂qp4²⁻ (blue), H₃qp4⁻ (purple), H₄qp4 (pine green), Hsqp4⁺ (indigo), and H₆qp4²⁺ (orange).

FIG. 7 depicts parameters for the Hyperquad model used in FIG. 6.

FIG. 8 depicts pMn, log K_{ML}, and pKₐ Values Determined by Potentiometric Titration at 25° C.

FIG. 9, comprising FIG. 9A and FIG. 9B, depicts predicted speciation as a function of pH. FIG. 9A depicts predicted speciation for 1.0 mM H₄qp4 in 100 mM KCl solution. FIG. 9B depicts predicted speciation for a 1:1 mixture of H₄qp4 and MnCl₂ in 100 mM KCl solution.

FIG. 10 depicts a Hyperquad model (red line) overlaid on the experimental data from the potentiometric titration of a 1:1 mixture of MnCl₂ and H₄qp4 (blue). The data above pH 9 have been excluded from the calculations since precipitation was observed above this value. The parameters for the Hyperquad model are provided in FIG. 7. The fit assumes an initial total of 0.178 mmol H⁺. The residuals for the fit are provided below. The curves represent the formation of various species including [Mn(H₂qp4)] (purple), [Mn(H₃qp4)]⁺ (pine green), and [Mn(H₄qp4)]²⁺ (light blue).

FIG. 11 depicts a representative LC trace for the free H₄qp4 ligand run under method 1. The ligand elutes at 2.33 min.

FIG. 12 depicts a representative LC trace for [Mn(H₃qp4)]⁺ run under method 1. The Mn(II) complex elutes at 5.22 min.

FIG. 13 depicts UV/vis spectra of 0.10 mM solutions of H₄qp4 and 1 in aqueous solutions containing 50 mM HEPES buffered to pH 7.00. The data indicated that the H₄qp4 ligand has been deprotonated to H₃qp4⁻ in complex 1.

FIG. 14 depicts UV/vis spectra of a 0.05 mM solution of 1 in water adjusted to various pH values between 4 and 9 through the addition of either KOH or HCl. All spectra were obtained at 298 K under air using a 1.0 cm path length cuvette.

FIG. 15, comprising FIG. 15A and FIG. 15B, depicts cyclic voltammetry experiments of 1.0 mM 1 in 0.10 M phosphate buffer (NaH₂PO₄/Na₂HPO₄, pH=7.2). The scan rate was 100 mV/s. FIG. 15A depicts a redox event: E_{1/2}=100 mV vs. Ag/AgCl, ΔE=260 mV. An irreversible feature with Epc=1250 mV is observed. FIG. 15B depicts an extended window which also contains an irreversible feature but this appeared to lead to the oxidation of the buffer as well; the additional feature at ˜400 mV was also observed in the CV of a blank sample containing phosphate buffer.

FIG. 16 depicts plots of r₂° as a function of temperature for 1 before and after oxidation by H₂O₂. Experimental conditions for pre-activated sensor (black squares): [1]=6.0 mM in 60 mM HEPES buffered to pH 7.4 and 10% (v/v) of 10% ¹⁷OH₂, B=9.4 T. Experimental conditions for activated sensor (red circles): [1]=2.5 mM in 60 mM MOPS buffered to pH 7.4 with 15 equiv. H₂O₂ and 10% (v/v) of 10% ¹⁷OH₂, B=9.4 T. NMR data acquisition began 15 min after the start of the oxidation reaction.

FIG. 17 depicts water exchange activation parameters obtained for quinol-containing Mn(II) complexes 1, 2, and 3.

FIG. 18, comprising FIG. 18A and FIG. 18B, depicts representative spectrophotometric spectra. FIG. 18A depicts spectrophotometric analysis of the reaction between 0.1 mM Fe(ClO₄)₂ and 0.1 mM 1 in MeCN at 298 K. The UV/vis spectra of the product formed from 0.1 mM Fe(ClO₄)₂ and 0.1 mM H₄qp4 (blue) and that corresponding to 0.1 mM 1 are provided for comparison. FIG. 18B depicts spectrophotometric analysis of the reaction between 0.1 mM Fe(OTf)₂ and 0.1 mM 1 in aqueous solutions containing 50 mM HEPES buffered to pH 7.00 at 298 K. The UV/vis spectrum of the product formed from 0.1 mM Fe(OTf)₂ and 0.1 mM H₄qp4 (blue) and that corresponding to 0.1 mM 1 are provided for comparison.

FIG. 19, comprising FIG. 19A and FIG. 19B, depicts representative NMR data. FIG. 19A depicts a reaction between 20 mM Zn(ClO₄)₂ and 10 mM 1 in CD₃CN. The reaction equilibrated at 295 K for 24 h prior to data acquisition. FIG. 19B depicts the ¹H NMR spectrum of the product of the reaction between 10 mM Zn(ClO₄)₂ and 10 mM metal-free H₄qp4.

FIG. 20 depicts oxidized forms of the H₄qp4 ligand.

FIG. 21 depicts other Mn(II)-binding ligands used in NMR contrast agents.

FIG. 22 depicts a plot of RI (1/T₁) versus pH for a 0.50 mM solution of 1 in unbuffered water. The pH was controlled via the addition of HCl and KOH. All samples were analyzed at 298 K using a 3 T field provided by a clinical MRI scanner. Slight precipitation is observed above pH 8.5.

FIG. 23 depicts MS (ESI+) of the product of the reaction between 1 and 2,3-dichloro-5,6-dicyano-1,4-benzoquinone (DDQ) in MeCN. The m/z features at 495.1793, 496.1878, and 497.1957 are assigned to complexes with partially or fully oxidized ligands: [Mn(qp4)]⁺ (calculated m/z=495.1804), [Mn(Hqp4)]⁺ (calculated m/z=496.1883), and [Mn(H₂qp4)]⁺ (calculated m/z=497.1961). The m/z feature at 441.2488 is assigned to the monoprotonated form of the fully oxidized ligand, (Hqp4)⁺ (calculated m/z=441.2502).

FIG. 24 depicts an IR spectrum of the product of the reaction between 1 and DDQ. The 1656 cm⁻¹ band is assigned to the C═O stretches of the para-quinone portions of the ligand.

FIG. 25 depicts UV/vis spectra of a 0.10 mM solutions of 1 in MeCN before and after the addition of 1 equiv. of DDQ. The peak at 350 nm is from the reduced DDQ.

FIG. 26 depicts mass spectrometry (ESI) of a mixture of 1 in acetonitrile and 10 equiv. of H₂O₂. The reaction was allowed to proceed for 10 min. The 495.1862 m/z feature is assigned to [Mn(qp4)]⁺ (calculated m/z=495.1804), the complex with the fully oxidized (diquinone) form of the ligand. The 496.1956 m/z feature is assigned to [Mn(Hqp4)]⁺ (calculated m/z=496.1883), the complex with the singly oxidized and singly deprotonated (monoquinone/quinolate) form of the ligand. The 497.2015 m/z feature is assigned to [Mn(H₂qp4)]⁺ (calculated m/z=497.1961), which could be either the complex with the singly oxidized but protonated form of the ligand (monoquinone/quinol) or the doubly deprotonated reduced form of the ligand (diquinolate).

FIG. 27, comprising FIG. 27A through FIG. 27D, depicts responses of 1 to H₂O₂.

FIG. 27A depicts UV/vis spectra acquired during a reaction between 0.07 mM 1 and 10 mM H₂O₂ in 50 mM HEPES buffered to pH 7.00 at 298 K. FIG. 27B depicts UV/vis spectra acquired during a reaction between 0.10 mM 1 and 0.60 mM H₂O₂ in 50 mM HEPES buffered to pH 7.00 at 298 K. FIG. 27C depicts X-band EPR spectra of 1.0 mM solutions of 1 in 50 mM HEPES buffered to pH 7.00 in the absence and presence of 10 mM H₂O₂. The reactions between 1 and H₂O₂ proceeded for 60 min (blue) and 90 min (red) before the samples was frozen and analyzed at 77 K. FIG. 27D depicts plots of 1/T₁ versus Mn(II) concentration for 1 in the presence (blue, red) and absence (black) of 10 mM H₂O₂. All samples were run in 298 K aqueous solutions containing 50 mM HEPES buffered to pH 7.00, using a 3 T field provided by a clinical MRI scanner. All samples were prepared under air. The oxidized samples were prepared by directly adding H₂O₂ to solutions of 1 in aqueous solutions buffered to pH 7.0. Two sets of oxidation reactions were allowed to proceed for 60 min at 298 K before T₁ was measured (blue). A third set of oxidation reactions was allowed to proceed for 120 min before data acquisition. The data were fit to the indicated linear equations; the y-intercepts were within error of 1/T₁ measurements associated with two control samples that contained no Mn(II): pure water (0.35 s⁻) and 50 mM HEPES buffer (0.34 s⁻).

FIG. 28 depicts mass spectrometry (ESI) a sample of 1 that was sequentially oxidized by H₂O₂ and reduced by sodium dithionite (Na₂S₂O₄). Complex 1 first reacted with 4 equiv. of H₂O₂ for 60 min at RT in MeOH. The solvent and excess H₂O₂ was removed and the crude was allowed to react with 4 equiv. of Na₂S₂O₄ for an additional 60 min. The 497.1942 m/z feature is assigned to [Mn(H₂qp4)]⁺ (calculated m/z=497.1961).

FIG. 29 depicts a plot of RI (1/T₁) versus pH for a 0.50 mM solution of 1 in unbuffered water. The pH was controlled via the addition of HCl and KOH. All samples were analyzed at 298 K using a 3 T field provided by a clinical MRI scanner. Slight precipitation is observed above pH 8.5.

FIG. 30 depicts proposed competing catalase and quinol oxidation pathways.

FIG. 31 depicts representative kinetic traces for the reaction between 100 nM 1 and 10 mM H₂O₂ in 100 mM phosphate solution buffered to pH 7.0. The absorbance at 240 nm was monitored over time. Activity values were calculated using the UV-1601PC Kinetics program and converted to an initial rate (vₒ/[1]_{T}) using the following equation: vₒ/[1]_{T}=(activity)/[60 s×0.01 μM×0.0000394 μM⁻¹ cm⁻¹×1.0 cm].

FIG. 32 depicts a scheme of oxidation of an Fe(II)-quinol to a more aquated Fe(III)-para-quinone.

FIG. 33 depicts the structure of H₄qp4 and compositions of isolated and solution-state iron complexes described herein. The H₄qp4 ligand coordinates to the iron as H₃qp4⁻ and H₂qp4².

FIG. 34 depicts a representative LC trace for 1. The only observed peak is at 7.50 min. The peak is distinct from that observed for the free H₄qp4 ligand which elutes at 2.32 min when run under the same conditions. The following method was used: Gradient 90% A and 10% B to 100% B over 20 min. Flow rate=0.20 mL/min, injection volume=25.0 μL, column temperature=37.0° C. Before each run, the HPLC instrument was flushed with eluent 100% A to 100% B over 16 min with a flow rate of 0.49 ml/min and an injection volume of 25.0 μL.

FIG. 35 depicts ¹H NMR spectrum of a 1 mM solution of 1 in CD₃CN (500 MHz). The peak at 1.94 ppm corresponds to MeCN.

FIG. 36 depicts pFe, log K_{ML}, and pKₐ Values Determined by Potentiometric Titration at 25° C.

FIG. 37 depicts Parameters for the Hyperquad model used in FIG. 42.

FIG. 38 depicts comparative UV/vis spectra of 0.10 mM solutions of H₄qp4 and 1 in aqueous solutions containing 50 mM HEPES buffered to pH 7.0. Both spectra were obtained at 298 K under air using a 1.0 cm pathlength cuvette.

FIG. 39 depicts UV/vis spectra of a 0.05 mM solution of 1 in water adjusted to various pH values between 9 to 3 through the addition of either KOH or HCl. All spectra were obtained at 298 K under nitrogen using a 1.0 cm pathlength cuvette. The data are consistent with the deprotonation of the Fe(II)-bound quinols between pH 4.6 and 8.4.

FIG. 40 depicts predicted speciation as a function of pH for 1.0 mM 1 in an aqueous solution containing 100 mM KCl at 25° C.

FIG. 41 depicts Hyperquad model (red line) overlaid on the experimental potentiometric pH titration data collected for 1 (blue). The curves represent the formation of various species including [Fe^{II}(H₄qp4)]²⁺ (light blue), [Fe^{II}(H₃qp4)]⁺ (green), and [Fe^{II}(H₂qp4)](pink). The deviations from the fit as a function of titre volume are provided in FIG. 38.

FIG. 42 depicts cyclic voltammetry of 1.0 mM 1 in 0.10 M phosphate buffer (NaH₂PO₄/Na₂HPO₄, pH=7.2). The scan rate was 100 mV/s and began at −1.0 V. Two features are observed: a reversible feature with E_{1/2}=−450 mV vs. Ag/AgCl (ΔE=60 mV) and an irreversible feature with E_{1/2}=90 mV vs. Ag/AgCl (ΔE=300 mV).

FIG. 43 depicts UV/vis spectra depicting the stability of a 0.10 mM solution of 1 in MeCN to air. The reaction monitored over 19 h. All spectra were obtained at 298 K using a 1.0 cm pathlength cuvette under air.

FIG. 44 depicts UV/vis spectra depicting the stability of a 0.10 mM solution of 1 in buffered water (50 mM HEPES, pH 7.0) to air. The reaction monitored over 12 h. All spectra were obtained at 298 K using a 1.0 cm pathlength cuvette under air.

FIG. 45 depicts ORTEP representation of [Fe^{III}(H₂qp4)]⁺ (2). All H atoms, solvent molecules, and counteranions have been omitted for clarity. All ellipsoids are drawn at 50% probability.

FIG. 46, comprising FIG. 46A through FIG. 46C, depicts UV/vis spectra of 1. FIG. 46A depicts UV/vis spectra showing the reaction between 0.10 mM 1 and 10 mM H₂O₂ in 50 mM HEPES solution buffered to pH 7.00 under N2 over 4 h. The absorbance initially increases slightly due to the unreacted H₂O₂. All spectra were obtained at 298 K using a 1.0 cm pathlength cuvette. FIG. 46B depicts expansion of the 400-700 nm region. FIG. 46C depicts change in the absorbance at 297 nm, which corresponds to the intraligand transition for the quinol portion of the H₄qp4 ligand, over this time. The data are consistent with the oxidation of the quinols.

FIG. 47 depicts a representative IR spectrum of the crude product from the reaction between 1.0 mM 1 and 10 mM H₂O₂ in 50 mM HEPES solution buffered to pH 7.0. After the reaction proceeded for 60 min, the solvents were removed, yielding the crude solid. The solid was mixed into a KBr pellet for IR analysis. The peak at 1655 cm⁻¹ was not observed for 1 and is assigned to the C═O stretches of the para-quinone subunits.

FIG. 48 depicts X-band EPR spectra depicting the reaction of 1.0 mM 1 with 10 mM H₂O₂ in 50 mM HEPES buffered to pH 7.0. The sample was frozen to 77 K 30 min after the addition of H₂O₂ prior to data acquisition. The signal at g=4.3 is indicative of high-spin Fe(III), the smaller signals at g=2.55, 2.27, and 1.99 are consistent with low-spin Fe(III) species FIG. 49 depicts mass spectrometry (ESI) of a sample of 1 that was oxidized by H₂O₂ and subsequently reduced by cysteine. Complex 1 first reacted with 4 equiv. of H₂O₂ for 60 min at RT in MeOH. The solvent and excess H₂O₂ was removed, and the crude was allowed to react with 4 equiv. cysteine for an additional 60 min. The excess cysteine was removed via filtration prior to analysis. The 498.1923 m/z feature is assigned to [Fe^{III}(H₂qp4)]⁺ (calculated m/z=498.1929).

FIG. 50 depicts mass spectrometry (ESI) of a sample of 1 that was sequentially oxidized by H₂O₂ and reduced by sodium dithionite. Complex 1 first reacted with 4 equiv. of H₂O₂ for 60 min at RT in MeOH. The solvent and excess H₂O₂ was removed, and the crude was allowed to react with 4 equiv. sodium dithionite for an additional 60 min. The excess sodium dithionite was removed via filtration prior to analysis. The 498.1924 m/z feature is assigned to [Fe(H₂qp4)]⁺ (calculated m/z=498.1929).

FIG. 51, comprising FIG. 51A and FIG. 51B, depicts relaxivity measurements of 1. FIG. 51A depicts plots of 1/T₁ versus iron concentration for 1 in the presence (blue, green) and absence (red) of 10 mM H₂O₂. All samples were run in 298 K aqueous solutions containing 50 mM HEPES buffered to pH 7.00, using a 3 T field provided by a clinical MRI scanner. All samples were prepared under air. The oxidized samples were prepared by directly adding H₂O₂ to solutions of 1 in aqueous solutions buffered to pH 7.00. T₁ measurements were taken 30 min (blue) and 60 min (green) after the reactions with H₂O₂ began. The data were fit to the indicated linear equations; the y-intercepts were within error of 1/T₁ measurements associated with two control samples that contained no iron: pure water (0.35 s⁻) and 50 mM HEPES buffer (0.34 s⁻). FIG. 51B depicts phantom images of solutions containing 0.1-1.0 mM 1 in the absence and presence of 10 mM H₂O₂. All solutions were given 60 min to equilibrate and imaged with time of inversion (TI)=1750 ms.

FIG. 52 depicts a plot of R₁ (1/T₁) versus pH for a 0.50 mM solution of 1 in unbuffered water. The pH was controlled via the addition of HCl and KOH. All samples were analyzed at 298 K using a 3 T field provided by a clinical MRI scanner. The R₁ for the iron-free water reference was 0.36 s⁻¹.

FIG. 53 depicts water exchange at the Fe(II) center in 1 in an aqueous solution containing 0.06 M MOPS buffered to pH 7.4 followed by ¹⁷O NMR. The NMR data were fit to the Swift-Connick equation. The q_{H2O} variable was set as free parameter, and the B value was fixed. The number of exchanging water molecules was optimized at q_{H2O}=1.6. This is the mean value for the two Fe(II) species existing in equilibrium at pH 7.4: [Fe^{II}(H₂qp4)] and [Fe^{II}(H₃qp4)]⁺.

FIG. 54 depicts ¹⁷O NMR signals of the bulk solvent in the absence (black line, reference) and presence of a 1:10 mixture of 1 and H₂O₂ at various temperatures. Experimental conditions: [1]ₒ=9.8 mM in 0.06 M MOPS buffered to pH 7.4, 20% (v/v) MeCN, 1% ¹⁷O enrichment. The nearly identical line-widths suggest that water molecules do not exchange rapidly on the Fe(III) metal centers in the oxidized products.

FIG. 55 depicts mass spectrometry (ESI) of 3 in MeCN. The 498.1921 m/z feature is assigned to the doubly deprotonated Fe(III) complex [Fe(H₂qp4)]⁺ (calculated m/z=498.1929).

FIG. 56 depicts IR spectrum of [Fe^{III}(H₃qp4)](OTf)₂ (3). The 3458 cm⁻¹ feature is assigned to the O—H stretches associated with the quinol groups of the H₄qp4 ligand.

FIG. 57, comprising FIG. 57A and FIG. 57B, depicts UV/vis spectra of 3. FIG. 57A depicts a UV/vis spectrum of a 0.10 mM solution of 3 in an aqueous solution containing 50 mM HEPES buffered to pH 7.0. This spectrum was obtained at 298 K using a 1.0 cm pathlength cuvette under air. The spectrum of 1 obtained under the same conditions is provided as a reference. FIG. 57B depicts the spectrophotometric pH titration of 3 at 298 K with a 1.0 cm pathlength cuvette.

FIG. 58 depicts X-band EPR spectrum for a 1.0 mM solution of 3 in an aqueous solution containing 50 mM HEPES buffered to pH 7.0. The sample was frozen to 77 K prior to data collection.

FIG. 59 depicts a representative LC trace for 3. The only observed peak is at 8.02 min. The peak is distinct from that observed for the free H₄qp4 ligand which elutes at 2.32 min when run under the same conditions. The following method was used: Gradient 90% A and 10% B to 100% B over 20 min. Flow rate=0.20 mL/min, injection volume=25.0 μL, column temperature=37.0° C. Before each run, the HPLC instrument was flushed with eluent 100% A to 100% B over 16 min with a flow rate of 0.49 ml/min and an injection volume of 25.0 μL.

FIG. 60 depicts Hyperquad model (red line) overlaid on the experimental potentiometric pH titration data collected for 3 (blue). The curves represent the formation of various species including [Fe^{III}(H₃qp4)]²⁺ (light blue), [Fe^{III}(H₂qp4)]⁺ (green), and [Fe^{III}(Hqp4)](pink). Alternatively, [Fe^{III}(Hqp4)] may be [Fe^{III}(H₂qp4)(OH)]. The deviations from the fit as a function of titre volume are provided below. Precipitate began to form at pH 8.0, halting the collection of data.

FIG. 61 depicts parameters for the Hyperquad model used in FIG. 60.

FIG. 62 depicts predicted speciation as a function of pH for 1.0 mM 3 in an aqueous solution containing 100 mM KCl at 25° C. Alternatively, [Fe^{III}(Hqp4)] may be [Fe^{III}(H₂qp4)(OH)].

FIG. 63, comprising FIG. 63A and FIG. 63B, depicts representative NMR data. FIG. 63A depicts the reaction between 20 mM Zn(ClO₄)₂ and 10 mM 3 in D20. The reaction equilibrated at 295 K for 48 h prior to data acquisition. FIG. 63B depicts a ¹H NMR spectrum of the product of the reaction between 10 mM Zn(ClO₄)₂ and 10 mM metal-free H₄qp4 in D20.

FIG. 64 depicts a plot of 1/T₁ versus iron concentration for 3 in 298 K aqueous solutions containing 50 mM HEPES buffered to pH 7.00 using a 3 T field provided by a clinical MRI scanner. All samples were prepared under air. The data were fit to the provided linear equation. The calculated r₁ for 3 under these conditions is 0.87 mM⁻¹ s⁻¹.

FIG. 65, comprising FIG. 65A and FIG. 65B, depicts representative UV/vis spectra.

FIG. 65A depicts UV/vis spectra for the reaction between 0.10 mM 1 and 0.60 mM H₂O₂ in an aqueous solution containing 50 mM HEPES buffered to pH 7.0. The Fe(II) complex oxidizes much more quickly than in FIG. 46. FIG. 65B depicts a plot of the absorbance at 297 nm as a function of time.

FIG. 66 depicts representative kinetic traces for the reaction between 100 nM 1 and 10 mM H₂O₂ in 200 mM phosphate solution buffered to pH 7.0. The absorbance at 240 nm was monitored over time. Activity values were calculated using the UV-1601PC Kinetics program and converted to an initial rate (vₒ/[1]_{T}) using the following equation: vₒ/[1]_{T}=(activity)/[60 s×0.1 μM×0.0000394 μM⁻¹ cm⁻¹×1.0 cm]

FIG. 67, comprising FIG. 67A and FIG. 67B, depicts a Michaelis-Menten fit of the activity of 1. FIG. 67A depicts activity of 1 with increasing concentrations of H₂O₂. All reactions were performed in 200 mM phosphate buffered to pH 7.0 at 25° C. with an initial 100 nM concentration of 1. The reaction was run five times per H₂O₂ concentration. FIG. 67B depicts a fit of the data to the Michaelis-Menten equation. The best fit provides k_{cat}=2.73×10⁴ s⁻¹ and kₒₙ=6.03×10⁵ M⁻¹ s⁻¹.

FIG. 68, comprising FIG. 68A and FIG. 68B, depicts cytotoxicity experiments of [Fe(H₃qp4)](OTf) and [Mn(H₃qp4)](OTf) complexes toward H9c2 cells. H9c2 cells were obtained from the American Type Culture Collection (Manassas, VA, USA) and grown in Dulbecco's modified Eagle's medium (DMEM) supplemented with 10% fetal bovine serum at 37° C. with 95% humidity and 5% CO₂. Experiments were performed at 70-80% confluence. To determine the cytotoxic effects of these compounds, H9c2 cells were exposed to increasing concentrations of the iron or manganese compound (0.1-1000 μM) or their vehicles in DMEM. FIG. 68A depicts exposure for 4 h. FIG. 68B depicts exposure for 24 h. The cell number was assessed using the CyQUANT Cell Proliferation Assay Kit (Life Technologies Corporation, Carlsbad, CA) per manufacturer's instructions. Cell number was expressed as percentage of the vehicle-treated cells. Values are expressed as mean and standard deviation and represent 3 experiments performed in triplicate.

FIG. 69 depicts selected crystallographic data for [H₆qp4](OTf)₂ and 4.

### DETAILED DESCRIPTION

The present invention is based, in part, on the unexpected discovery and results of an effective method for sensing reactive oxygen species (ROS) in clinical imaging technology comprising a composition comprising a redox-active metal complex comprising at least one metal and at least one macrocyclic ligand. In various embodiments, the composition can undergo a reaction with reactive oxygen species. In some embodiments, the chelating ligand comprises at least one aryl group substituted with a hydroxyl. In some embodiments, the chelating ligand comprises at least one para-quinone. In various embodiments, the composition is used to enhance magnetic resonance imaging (MRI) in living subjects.

### Definitions

Unless defined otherwise, all technical and scientific terms used herein have the same meaning as commonly understood by one of ordinary skill in the art to which this invention belongs.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of 20%, ±10%, ±5%, ±1%, or ±0.1% from the specified value, as such variations are appropriate to perform the disclosed methods.

The terms “halo,” “halogen,” or “halide” as used interchangeably and refer to fluorine, chlorine, bromine, and iodine.

The term “acyl” refers to a substituted carbonyl radical (C(O)—Rₛ).

The term “ester” refers to a substituted oxycarbonyl (—O—C(O)—Rₛ or —C(O)—O—Rₛ) radical.

The term “ether” refers to an —ORₛ radical.

The terms “sulfanyl” or “thio-ether” are used interchangeably and refer to a —SRₛ radical.

The term “sulfinyl” refers to a —S(O)—Rₛ radical.

The term “sulfonyl” refers to a −SO₂—Rₛ radical.

The term “phosphino” refers to a —P(Rₛ)₃ radical, wherein each Rₛ can be same or different.

The term “silyl” refers to a —Si(Rₛ)₃ radical, wherein each Rₛ can be same or different.

In each of the above, Rₛ can be hydrogen or a substituent selected from the group consisting of deuterium, halogen, alkyl, cycloalkyl, heteroalkyl, heterocycloalkyl, arylalkyl, alkoxy, aryloxy, amino, silyl, alkenyl, cycloalkenyl, heteroalkenyl, alkynyl, aryl, heteroaryl, and combination thereof. Preferred Rₛ is selected from the group consisting of alkyl, cycloalkyl, aryl, heteroaryl, and combination thereof.

The term “alkyl” refers to and includes both straight and branched chain alkyl radicals. Preferred alkyl groups are those containing from one to fifteen carbon atoms and includes methyl, ethyl, propyl, 1-methylethyl, butyl, 1-methylpropyl, 2-methylpropyl, pentyl, 1-methylbutyl, 2-methylbutyl, 3-methylbutyl, 1,1-dimethylpropyl, 1,2-dimethylpropyl, 2,2-dimethylpropyl, and the like. Additionally, the alkyl group may be optionally substituted.

The term “cycloalkyl” refers to and includes monocyclic, polycyclic, and spiro alkyl radicals. Preferred cycloalkyl groups are those containing 3 to 12 ring carbon atoms and includes cyclopropyl, cyclopentyl, cyclohexyl, bicyclo[3.1.1]heptyl, spiro[4.5]decyl, spiro[5.5]undecyl, adamantyl, and the like. Additionally, the cycloalkyl group may be optionally substituted.

The terms “heteroalkyl” or “heterocycloalkyl” refer to an alkyl or a cycloalkyl radical, respectively, having at least one carbon atom replaced by a heteroatom. Optionally the at least one heteroatom is selected from O, S, N, P, B, Si and Se, preferably, O, S or N. Additionally, the heteroalkyl or heterocycloalkyl group is optionally substituted.

The term “alkenyl” refers to and includes both straight and branched chain alkene radicals. Alkenyl groups are essentially alkyl groups that include at least one carbon-carbon double bond in the alkyl chain. Cycloalkenyl groups are essentially cycloalkyl groups that include at least one carbon-carbon double bond in the cycloalkyl ring. The term “heteroalkenyl” as used herein refers to an alkenyl radical having at least one carbon atom replaced by a heteroatom. Optionally the at least one heteroatom is selected from O, S, N, P, B, Si and Se, preferably, O, S or N. Preferred alkenyl, cycloalkenyl, or heteroalkenyl groups are those containing two to fifteen carbon atoms. Additionally, the alkenyl, cycloalkenyl, or heteroalkenyl group is optionally substituted.

The term “alkynyl” refers to and includes both straight and branched chain alkyne radicals. Preferred alkynyl groups are those containing two to fifteen carbon atoms. Additionally, the alkynyl group is optionally substituted.

The terms “aralkyl” or “arylalkyl” are used interchangeably and refer to an alkyl group that is substituted with an aryl group. Additionally, the aralkyl group is optionally substituted.

The term “heterocyclic group” refers to and includes aromatic and non-aromatic cyclic radicals containing at least one heteroatom. Optionally the at least one heteroatom is selected from O, S, N, P, B, Si and Se, preferably, O, S or N. Hetero-aromatic cyclic radicals may be used interchangeably with heteroaryl. Preferred hetero-non-aromatic cyclic groups are those containing 3 to 7 ring atoms which includes at least one hetero atom, and includes cyclic amines such as morpholino, piperidino, pyrrolidino, and the like, and cyclic ethers/thio-ethers, such as tetrahydrofuran, tetrahydropyran, tetrahydrothiophene, and the like. Additionally, the heterocyclic group may be optionally substituted.

The term “aryl” refers to and includes both single-ring aromatic hydrocarbyl groups and polycyclic aromatic ring systems. The polycyclic rings may have two or more rings in which two carbons are common to two adjoining rings (the rings are “fused”) wherein at least one of the rings is an aromatic hydrocarbyl group, e.g., the other rings can be cycloalkyls, cycloalkenyls, aryl, heterocycles, and/or heteroaryls. Preferred aryl groups are those containing six to thirty carbon atoms, preferably six to twenty carbon atoms, more preferably six to twelve carbon atoms. Especially preferred is an aryl group having six carbons, ten carbons or twelve carbons. Suitable aryl groups include phenyl, biphenyl, triphenyl, triphenylene, tetraphenylene, naphthalene, anthracene, phenalene, phenanthrene, fluorene, pyrene, chrysene, perylene, and azulene, preferably phenyl, biphenyl, triphenyl, triphenylene, fluorene, and naphthalene.

Additionally, the aryl group may be optionally substituted.

The term “heteroaryl” refers to and includes both single-ring hetero-aromatic groups and polycyclic aromatic ring systems that include at least one heteroatom. The heteroatoms include, but are not limited to O, S, N, P, B, Si and Se. In many instances, 0, S or N are the preferred heteroatoms. Hetero-single ring aromatic systems are preferably single rings with 5 or 6 ring atoms, and the ring can have from one to six heteroatoms. The hetero-polycyclic ring systems can have two or more rings in which two atoms are common to two adjoining rings (the rings are “fused”) wherein at least one of the rings is a heteroaryl, e.g., the other rings can be cycloalkyls, cycloalkenyls, aryl, heterocycles, and/or heteroaryls. The hetero-polycyclic aromatic ring systems can have from one to six heteroatoms per ring of the polycyclic aromatic ring system. Preferred heteroaryl groups are those containing three to thirty carbon atoms, preferably three to twenty carbon atoms, more preferably three to twelve carbon atoms. Suitable heteroaryl groups include dibenzothiophene, dibenzofuran, dibenzoselenophene, furan, thiophene, benzofuran, benzothiophene, benzoselenophene, carbazole, indolocarbazole, pyridylindole, pyrrolodipyridine, pyrazole, imidazole, triazole, oxazole, thiazole, oxadiazole, oxatriazole, dioxazole, thiadiazole, pyridine, pyridazine, pyrimidine, pyrazine, triazine, oxazine, oxathiazine, oxadiazine, indole, benzimidazole, indazole, indoxazine, benzoxazole, benzisoxazole, benzothiazole, quinoline, isoquinoline, cinnoline, quinazoline, quinoxaline, naphthyridine, phthalazine, pteridine, xanthene, acridine, phenazine, phenothiazine, phenoxazine, benzofuropyridine, furodipyridine, benzothienopyridine, thienodipyridine, benzoselenophenopyridine, and selenophenodipyridine, preferably dibenzothiophene, dibenzofuran, dibenzoselenophene, carbazole, indolocarbazole, imidazole, pyridine, triazine, benzimidazole, 1,2-azaborine, 1,3-azaborine, 1,4-azaborine, borazine, and aza-analogs thereof. Additionally, the heteroaryl group may be optionally substituted.

Of the aryl and heteroaryl groups listed above, the groups of triphenylene, naphthalene, anthracene, dibenzothiophene, dibenzofuran, dibenzoselenophene, carbazole, indolocarbazole, imidazole, pyridine, pyrazine, pyrimidine, triazine, and benzimidazole, and the respective aza-analogs of each thereof are of particular interest.

The terms alkyl, cycloalkyl, heteroalkyl, heterocycloalkyl, alkenyl, cycloalkenyl, heteroalkenyl, alkynyl, aralkyl, heterocyclic group, aryl, and heteroaryl, as used herein, are independently unsubstituted or substituted with one or more general substituents.

In many instances, the general substituents are selected from the group consisting of deuterium, halogen, alkyl, cycloalkyl, heteroalkyl, heterocycloalkyl, arylalkyl, alkoxy, aryloxy, amino, cyclic amino, silyl, alkenyl, cycloalkenyl, heteroalkenyl, alkynyl, aryl, heteroaryl, acyl, carbonyl, carboxylic acid, ether, ester, nitrile, isonitrile, sulfanyl, sulfinyl, sulfonyl, phosphino, and combinations thereof.

In some instances, the preferred general substituents are selected from the group consisting of deuterium, fluorine, alkyl, cycloalkyl, heteroalkyl, alkoxy, aryloxy, amino, silyl, alkenyl, cycloalkenyl, heteroalkenyl, aryl, heteroaryl, nitrile, isonitrile, sulfanyl, and combinations thereof.

In some instances, the preferred general substituents are selected from the group consisting of deuterium, fluorine, alkyl, cycloalkyl, alkoxy, aryloxy, amino, silyl, aryl, heteroaryl, sulfanyl, and combinations thereof.

In yet other instances, the more preferred general substituents are selected from the group consisting of deuterium, fluorine, alkyl, cycloalkyl, aryl, heteroaryl, and combinations thereof.

The term “substituted” refers to a substituent other than H that is bonded to the relevant position, e.g., a carbon. For example, where R¹ represents mono-substituted, then one R¹ must be other than H. Similarly, where R¹ represents di-substituted, then two of R¹ must be other than H. Similarly, where R¹ is unsubstituted, R¹ is hydrogen for all available positions. The maximum number of substitutions possible in a structure (for example, a particular ring or fused ring system) will depend on the number of atoms with available valencies.

As used herein, “combinations thereof” indicates that one or more members of the applicable list are combined to form a known or chemically stable arrangement that one of ordinary skill in the art can envision from the applicable list. For example, an alkyl and deuterium can be combined to form a partial or fully deuterated alkyl group; a halogen and alkyl can be combined to form a halogenated alkyl substituent; and a halogen, alkyl, and aryl can be combined to form a halogenated arylalkyl. In one instance, the term substitution includes a combination of two to four of the listed groups. In another instance, the term substitution includes a combination of two to three groups. In yet another instance, the term substitution includes a combination of two groups. Preferred combinations of substituent groups are those that contain up to fifty atoms that are not hydrogen or deuterium, or those which include up to forty atoms that are not hydrogen or deuterium, or those that include up to thirty atoms that are not hydrogen or deuterium. In many instances, a preferred combination of substituent groups will include up to twenty atoms that are not hydrogen or deuterium.

The “aza” designation in the fragments described herein, i.e. aza-dibenzofuran, aza-dibenzothiophene, etc. means that one or more of the C—H groups in the respective fragment can be replaced by a nitrogen atom, for example, and without any limitation, azatriphenylene encompasses both dibenzo[f,h]quinoxaline and dibenzo[f,h]quinoline. One of ordinary skill in the art can readily envision other nitrogen analogs of the aza-derivatives described above, and all such analogs are intended to be encompassed by the terms as set forth herein.

As used herein, “deuterium” refers to an isotope of hydrogen. Deuterated compounds can be readily prepared using methods known in the art. For example, U.S. Pat. No. 8,557,400, Patent Pub. No. WO 2006/095951, and U.S. Pat. Application Pub. No. US 2011/0037057, which are hereby incorporated by reference in their entireties, describe the making of deuterium-substituted organometallic complexes. Further reference is made to Ming Yan, et al., Tetrahedron 2015, 71, 1425-30 and Atzrodt et al., Angew. Chem. Int. Ed. (Reviews) 2007, 46, 7744-65, which are incorporated by reference in their entireties, describe the deuteration of the methylene hydrogens in benzyl amines and efficient pathways to replace aromatic ring hydrogens with deuterium, respectively.

It is to be understood that when a molecular fragment is described as being a substituent or otherwise attached to another moiety, its name may be written as if it were a fragment (e.g. phenyl, phenylene, naphthyl, dibenzofuryl) or as if it were the whole molecule (e.g. benzene, naphthalene, dibenzofuran). As used herein, these different ways of designating a substituent or attached fragment are considered to be equivalent.

The terms “patient,” “subject,” “individual,” and the like are used interchangeably herein, and refer to any animal, or cells thereof whether in vitro or in situ, amenable to the methods described herein. In certain non-limiting embodiments, the patient, subject or individual is a human.

The term “biological tissue” as used herein refers to a collection of interconnected cells and extracellular matrix that perform a similar function or functions within an organism Examples of biological tissues include, but are not limited to, connective tissue, muscle tissue, nervous tissue (of the brain, spinal cord, and nerves), epithelial tissue, organ tissue, cancer tissue, and any combination thereof. Connective tissue includes fibrous tissue like fascia, tendon, ligaments, heart valves, bone, and cartilage. Muscle tissue includes skeletal muscle tissue, smooth muscle tissue, such as esophageal, stomach, intestinal, bronchial, uterine, urethral, bladder, and blood vessel tissue, and cardiac muscle tissue. Epithelial tissue includes simple epithelial tissue, such as alveolar epithelial tissue, blood vessel endothelial tissue, and heart mesothelial tissue, and stratified epithelial tissue.

The term “abnormal” when used in the context of organisms, tissues, cells or components thereof, refers to those organisms, tissues, cells or components thereof that differ in at least one observable or detectable characteristic (e.g., age, treatment, time of day, etc.) from those organisms, tissues, cells or components thereof that display the “normal” (expected) respective characteristic. Characteristics which are normal or expected for one cell or tissue type, might be abnormal for a different cell or tissue type.

A “disease” is a state of health of an animal wherein the animal cannot maintain homeostasis, and wherein if the disease is not ameliorated then the animal's health continues to deteriorate.

In contrast, a “disorder” in an animal is a state of health in which the animal is able to maintain homeostasis, but in which the animal's state of health is less favorable than it would be in the absence of the disorder. Left untreated, a disorder does not necessarily cause a further decrease in the animal's state of health.

“Cancer,” as used herein, refers to the abnormal growth or division of cells. Generally, the growth and/or life span of a cancer cell exceeds, and is not coordinated with, that of the normal cells and tissues around it. Cancers may be benign, pre-malignant or malignant. Cancer occurs in a variety of cells and tissues, including, but not limited to, the oral cavity (e.g., mouth, tongue, pharynx, etc.), digestive system (e.g., esophagus, stomach, small intestine, colon, rectum, liver, bile duct, gall bladder, pancreas, etc.), respiratory system (e.g., larynx, lung, bronchus, etc.), bones, joints, skin (e.g., basal cell, squamous cell, meningioma, etc.), breast, genital system, (e.g., uterus, ovary, prostate, testis, etc.), urinary system (e.g., bladder, kidney, ureter, etc.), eye, nervous system (e.g., brain, etc.), head and neck, endocrine system (e.g., thyroid, etc.), soft tissues (e.g., muscle, fat, etc.), and hematopoietic system (e.g., lymphoma, myeloma, leukemia, acute lymphocytic leukemia, chronic lymphocytic leukemia, acute myeloid leukemia, chronic myeloid leukemia, etc.).

As used herein, the term “diagnosis” refers to the determination of the presence of a disease or disorder. In some embodiments of the present invention, methods for making a diagnosis are provided which permit determination of the presence of a particular disease or disorder.

As used herein, “treating a disease or disorder” means reducing the severity and/or frequency with which a sign or symptom of the disease or disorder is experienced by a subject.

A disease or disorder is “alleviated” if the severity of a sign or symptom of the disease or disorder, the frequency with which such a sign or symptom is experienced by a subject, or both, is reduced.

The term “derivative” refers to a small molecule that differs in structure from the reference molecule, but retains the essential properties of the reference molecule. A derivative may change its interaction with certain other molecules relative to the reference molecule. A derivative molecule may also include a salt, an adduct, tautomer, isomer, or other variant of the reference molecule.

The term “tautomers” are constitutional isomers of organic compounds that readily interconvert by a chemical process (tautomerization).

The term “isomers” or “stereoisomers” refer to compounds, which have identical chemical constitution, but differ with regard to the arrangement of the atoms or groups in space.

The term “effective amount” refers to a sufficient amount of an agent to provide the desired biological result. That result can be reduction and/or alleviation of a sign, symptom, or cause of a disease or disorder, or any other desired alteration of a biological system. An appropriate effective amount in any individual case may be determined by one of ordinary skill in the art using routine experimentation.

The term “solvate” in accordance with this invention should be understood as meaning any form of the active compound in accordance with the invention in which the said compound is bonded by a non-covalent bond to another molecule (normally a polar solvent), including especially hydrates and alcoholates.

The terms “effective amount” and “pharmaceutically effective amount” refer to a sufficient amount of an agent to provide the desired biological result. That result can be reduction and/or alleviation of a sign, symptom, or cause of a disease or disorder, or any other desired alteration of a biological system. An appropriate effective amount in any individual case may be determined by one of ordinary skill in the art using routine experimentation.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions disclosed herein. Thus, if there are a variety of additional steps that can be performed it is understood that each of these additional steps can be performed with any specific embodiment or combination of embodiments of the methods disclosed herein.

### Redox-Active Metal Complexes and Compositions Thereof

A compound comprising a metal M and a macrocyclic ligand represented by General Formula I, and any salt thereof:

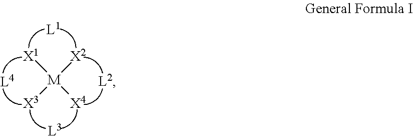

wherein M is a metal is selected from the group consisting of scandium, titanium, vanadium, chromium, manganese, iron, cobalt, nickel, copper, zinc, yttrium, zirconium, niobium, molybdenum, technetium, ruthenium, rhodium, palladium, and silver,
wherein L¹ to L⁴ are divalent linking groups,
wherein X¹ to X⁴ are each independently selected from O, S, or NR¹,
wherein R¹ is selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, or any combination thereof,
wherein at least one of X¹ to X⁴ is represented by NR¹ wherein R¹ is represented by Formula A:

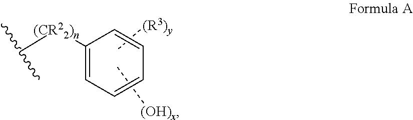

wherein R² and R³ are each independently selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, and any combination thereof,
wherein x is an integer from 1 through 5,
wherein y is an integer from 1 through 4,
wherein n is an integer from 1 through 3, and
wherein when the compound is ionic, the compound further comprises a counterion.

Exemplary metals M of the composition include but are not limited to titanium, vanadium, chromium, manganese, iron, cobalt, nickel, copper, zinc, zirconium, niobium, molybdenum, technetium, ruthenium, rhodium, palladium, silver, cadmium, hafnium, tantalum, tungsten, rhenium, osmium, iridium, platinum, gold, combinations thereof, oxides thereof, and any oxidation state thereof.

In one embodiment, the metal is high-spin. In one embodiment, the metal is low-spin. In one embodiment, the compound comprises a combination of high-spin metals and low-spin metals.

In one embodiment, the metal is redox-active. In one embodiment, the metal is redox-stable. In one embodiment, the metal undergoes oxidation in the presence of an oxidant. In one embodiment, the metal undergoes reduction in the presence of a reductant. In one embodiment, the metal does not undergo redox in the presence of an oxidant. In one embodiment, the metal does not undergo redox in the presence of a reductant.

In one embodiment, the metal is manganese. In one embodiment, the metal is iron. In one embodiment, the metal has a positive oxidation state. In one embodiment, the metal has an oxidation state of (I). In one embodiment, the metal has an oxidation state of (II). In one embodiment, the metal has an oxidation state of (III). In one embodiment, the compound has a positive formal charge. In one embodiment, the compound has a negative formal charge.

In one embodiment, the macrocyclic ligand is redox-active. In one embodiment, the macrocyclic ligand is redox-stable. In one embodiment, the macrocyclic ligand undergoes oxidation in the presence of an oxidant. In one embodiment, the macrocyclic ligand undergoes reduction in the presence of a reductant. In one embodiment, the macrocyclic ligand does not undergo redox in the presence of an oxidant. In one embodiment, the macrocyclic ligand does not undergo redox in the presence of a reductant.

In one embodiment, the composition further comprises a counterion. Exemplary counterions of the composition include but are not limited to halide, mesylate, acetate, fumarate, sulfate, maleate, citrate, tartrate, phosphate, acetate, hexafluoroantimonate, hexafluorophosphate, and triflate. In one embodiment, the counterion is triflate. In all embodiments, the number of counterions makes the overall complex neutral.

In some embodiments, the divalent linking group comprises an amide, ester, ether, thioether, carbamate, urea, amine, any alkyl chain, polyether chain, polymer chain, a cleavable bond, e.g. a bond that is unstable and/or is cleaved upon changes in certain environmental parameters (e.g., pH or redox potential) or upon exposure to certain reagents, chemicals, catalysts, or enzymes, a non-cleavable bond, any other linkage, or any combination thereof.

In one embodiment, each of X¹ to X⁴ is NR¹. In one embodiment, at least one of X¹ to X⁴ is NR¹. In one embodiment, at least two of X¹ to X⁴ is NR¹. In one embodiment, at least three of X¹ to X⁴ is NR¹.

In one embodiment, when each of X¹ to X⁴ is NR¹, at least one R¹ is hydrogen. In one embodiment, when each of X¹ to X⁴ is NR¹, at least two R¹ are hydrogen. In one embodiment, when each of X¹ to X⁴ is NR¹, at least one NR¹ is an alkyl, which is optionally further substituted. In one embodiment, when each of X¹ to X⁴ is NR¹, at least two NR¹ are an alkyl, which are optionally further substituted.

In one embodiment, each of X¹ to X⁴ is NR¹ wherein R¹ is represented by Formula A. In one embodiment, at least one of X¹ to X⁴ is NR¹ wherein R¹ is represented by Formula A. In one embodiment, at least two of X¹ to X⁴ is NR¹ wherein R¹ is represented by Formula A. In one embodiment, at least three of X¹ to X⁴ is NR¹ wherein R¹ is represented by Formula A. In one embodiment, X¹ and X³ are both represented by NR¹ wherein R¹ is represented by Formula A. In one embodiment, X¹ and X² are both represented by NR¹ wherein R¹ is represented by Formula A. In one embodiment, X¹ and X⁴ are both represented by NR¹ wherein R¹ is represented by Formula A. In one embodiment, X² and X³ are both represented by NR¹ wherein R¹ is represented by Formula A. In one embodiment, X² and X⁴ are both represented by NR¹ wherein R¹ is represented by Formula A. In one embodiment, X³ and X⁴ are both represented by NR¹ wherein R¹ is represented by Formula A.

In one embodiment, R¹ is an aryl, which is optionally further substituted. In one embodiment, R² is an aryl, which is optionally further substituted. In one embodiment, at least one of R¹ and R² are aryl, which are each independently further substituted.

In one embodiment, R¹ is substituted with at least one hydroxyl. In one embodiment, R² is substituted with at least one hydroxyl. In one embodiment, R¹ and R² are each substituted with at least one hydroxyl.

In one embodiment, x is 1. In one embodiment, x is 2. In one embodiment, x is 3. In one embodiment, x is 4. In one embodiment, x is 5.

In one embodiment, y is 1. In one embodiment, y is 2. In one embodiment, y is 3. In one embodiment, y is 4.

In one embodiment, n is 1. In one embodiment, n is 2. In one embodiment, n is 3.

In one embodiment, the compound is neutral. In one embodiment, the compound has a negative formal charge. In one embodiment, the compound has a positive formal charge.

In one embodiment, Formula A is represented by Formula B:

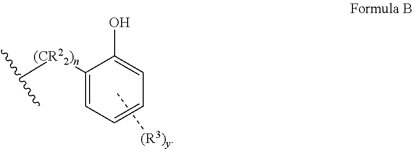

In one embodiment, the compound has at least one R³, wherein the at least one R³ is hydroxyl. In one embodiment, the compound R³ is hydrogen.

In one embodiment, the OH is bonded to the metal M. In one embodiment, the OH is not bonded to the metal M. In one embodiment, the OH is deprotonated.

In one embodiment, each of X¹ to X⁴ is NR¹ wherein R¹ is represented by Formula B. In one embodiment, at least one of X¹ to X⁴ is NR¹ wherein R¹ is represented by Formula B. In one embodiment, at least two of X¹ to X⁴ is NR¹ wherein R¹ is represented by Formula B. In one embodiment, at least three of X¹ to X⁴ is NR¹ wherein R¹ is represented by Formula B. In one embodiment, X¹ and X³ are both represented by NR¹ wherein R¹ is represented by Formula B. In one embodiment, X¹ and X² are both represented by NR¹ wherein R¹ is represented by Formula B. In one embodiment, X¹ and X⁴ are both represented by NR¹ wherein R¹ is represented by Formula B. In one embodiment, X² and X³ are both represented by NR¹ wherein R¹ is represented by Formula B. In one embodiment, X² and X⁴ are both represented by NR¹ wherein R¹ is represented by Formula B. In one embodiment, X³ and X⁴ are both represented by NR¹ wherein R¹ is represented by Formula B.

In one embodiment, at least two of X¹ to X⁴ is NR¹ wherein R¹ is represented by Formula B, both OH are bonded to the metal M. In one embodiment, at least two of X¹ to X⁴ is NR¹ wherein R¹ is represented by Formula B, one OH is bonded to the metal M. In one embodiment, at least two of X¹ to X⁴ is NR¹ wherein R¹ is represented by Formula B, none of the OH are bonded to the metal M.

In one embodiment, the metal M is further bonded to at least one water molecule. In one embodiment, the metal M is further bonded to two water molecules.

In one embodiment, Formula A is represented by Formula C:

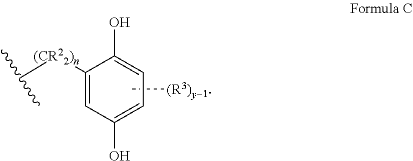

In one embodiment, the OH is bonded to the metal M. In one embodiment, the OH is not bonded to the metal M. In one embodiment, the OH is deprotonated.

In one embodiment, each of X¹ to X⁴ is NR¹ wherein R¹ is represented by Formula C. In one embodiment, at least one of X¹ to X⁴ is NR¹ wherein R¹ is represented by Formula C. In one embodiment, at least two of X¹ to X⁴ is NR¹ wherein R¹ is represented by Formula C. In one embodiment, at least three of X¹ to X⁴ is NR¹ wherein R¹ is represented by Formula C. In one embodiment, X¹ and X³ are both represented by NR¹ wherein R¹ is represented by Formula C. In one embodiment, X¹ and X² are both represented by NR¹ wherein R¹ is represented by Formula C. In one embodiment, X¹ and X⁴ are both represented by NR¹ wherein R¹ is represented by Formula C. In one embodiment, X² and X³ are both represented by NR¹ wherein R¹ is represented by Formula C. In one embodiment, X² and X⁴ are both represented by NR¹ wherein R¹ is represented by Formula C. In one embodiment, X³ and X⁴ are both represented by NR¹ wherein R¹ is represented by Formula C.

In one embodiment, the compounds of the present invention are stable to water. In one embodiment, the compounds of the present invention undergo ionization. In one embodiment, the compounds of the present invention undergo ionization in acidic conditions. In one embodiment, the compounds of the present invention undergo ionization in neutral conditions. In one embodiment, the compounds of the present invention undergo ionization in basic conditions.

In one embodiment, the compounds of the present invention undergo dissociation in acidic conditions. In one embodiment, the compounds of the present invention undergo dissociation in basic conditions. In one embodiment, the compounds of the present invention do not undergo dissociation.

In one embodiment, the compound reacts with a reactive oxygen species (ROS). Exemplary reactive oxygen species include but are not limited to peroxides, superoxides, hydroxyl radicals, singlet oxygen, and alpha oxygen. In one embodiment, the compound reacts with a radical forming compound.

Imaging and/or Contrast Agents

The present invention also provides an imaging and/or contrast agent comprising a composition comprising at least one compound of the present invention. In various aspects, the imaging and/or contrast agent is a magnetic resonance imaging contrast agent, photoacoustic imaging contrast agent, ultrasound imaging contrast agent, optical imaging contrast agent, computed tomography contrast agent, thermal imaging contrast agent, nuclear imaging contrast agent, magnetomotive imaging enhancement contrast agent, fluorescence imaging contrast agent, and any combination thereof.

In various aspects, the composition of the present invention acts as an imaging and/or contrast agent for magnetic resonance imaging, continuous wave photoacoustic imaging, combined photoacoustic and ultrasound imaging, magnetomotive imaging, optical coherent tomography, computed tomography, nuclear imaging modalities, or any combination thereof.

In some embodiments, the composition is used as contrast enhancement for magnetic resonance imaging, optical imaging methods, such as optical coherence tomography, computed tomography, fluorescence imaging, and photoacoustic imaging.

In one aspect, the imaging and/or contrast agent comprises the composition of the present invention and a pharmaceutically acceptable excipient. In various embodiments, the imaging and/or contrast agent further comprises an additional organic component.

To obtain selectivity, the imaging and/or contrast agent may be passively or actively targeted to regions of diagnostic interest, such as organs, vessels, sites of disease, tumorous tissue, or a specific organism in a subject. In active targeting, the imaging and/or contrast agents may be attached to biological recognition agents to allow them to accumulate in or to be selectively retained by or to be slowly eliminated from certain parts of the body, such as specific organs, parts of organs, bodily structures and disease structures and lesions. Active targeting is defined as a modification of biodistribution using chemical groups that will associate with species present in the desired tissue or organism to effectively decrease the rate of loss of contrast agent from the specific tissue or organism.

Active targeting of an imaging and/or contrast agent can be considered as localization through modification of biodistribution of the imaging and/or contrast agent by means of a targeting domain that is attached to or incorporated into the imaging and/or contrast agent. The targeting domain can associate or bind with one or more receptor species present in the tissue or organism of diagnostic interest. This binding will effectively decrease the rate of loss of contrast agent from the specific tissue or organism of diagnostic interest. In such cases, the imaging and/or contrast agent can be modified synthetically to incorporate the targeting domain. Targeted contrast agents can localize because of binding between the ligand and the targeted receptor. Alternatively, contrast agents can distribute by passive biodistribution, i.e., by passive targeting, into diseased tissues of interest such as tumors. Thus, even without synthetic manipulation to incorporate a targeting domain that can bind to a receptor site, passively targeted contrast agents can accumulate in a diseased tissue or in specific locations in the subject, such as the liver. The present invention comprises use of an imaging and/or contrast agent that is linked to a targeting domain that has an affinity for binding to a receptor. Preferably the receptor is located on the surface of a diseased or disease-causing cell in a human or animal subject.

The imaging and/or contrast agents are formulated in a pharmaceutically acceptable excipient, such as wetting agents, buffers, disintegrants, binders, fillers, flavoring agents and liquid carrier media such as sterile water, water/ethanol etc. The imaging and/or contrast agent should be suitable for administration either by injection or inhalation or catheterization or instillation or transdermal introduction into any of the various body cavities including the alimentary canal, the vagina, the rectum, the bladder, the ureter, the urethra, the mouth, etc. For oral administration, the pH of the composition is preferably in the acid range (e.g., 2 to 7) and buffers or pH adjusting agents may be used. The contrast media may be formulated in conventional pharmaceutical administration forms, such as tablets, capsules, powders, solutions, dispersion, syrups, suppositories etc.

### Method of Imaging

The present invention is further drawn to, in part, an imaging method comprising the steps of contacting a biological tissue with a composition comprising the compound of the present invention, applying energy to a biological tissue comprising the composition, and imaging the biological tissue comprising the composition.

In various embodiments, the method of imaging a biological tissue comprises application of at least one imaging technique. Exemplary imaging techniques include, but are not limited to, magnetic resonance imaging, photoacoustic imaging, ultrasound imaging, optical imaging, computed tomography, thermal imaging, nuclear imaging, magnetomotive imaging enhancement, and any combination thereof.

In some embodiments, the biological tissue is present in a mammal. In one embodiment, the biological tissue is present in mice. In one embodiment, the biological tissue is present in rats. In one embodiment, the biological tissue is present in humans.

In some embodiments, the method of imaging comprises applying energy to a biological tissue. In some embodiments, applying energy to a biological tissue comprises application of a radio frequency field. In some embodiments, applying energy to a biological tissue comprises application of a magnetic field. In some embodiments, applying energy to a biological tissue comprises irradiation of the biological tissue with a light source. In some embodiments, applying energy to a biological tissue comprises application of a magnetic field and a radio frequency field.

Contrast agents permit light absorption and sound generation in regions not otherwise possible. Contrast agents may also improve signal to noise ratio by increasing the amplitude of the sound wave. Increasing the sound wave amplitude allows an increase in the possible maximum depth of detection and thereby allows imaging of objects further below the surface of the body.

The use of contrast media provides significant amplification of the signal strength, and thus permits improved imaging. This may be achieved by selectively absorbing radiation in certain organs or healthy or diseased bodily structures or parts thereof, and/or by efficiently converting the radiation into heat, and/or by facilitating or improving heat-pressure conversion, and/or by scattering and diffusing the incident light so that it more uniformly illuminates the target organs.

Tissue of particular interest for imaging include, without limitation, tissues not shielded by bone, e.g., breast tissue, liver tissue: etc.; and blood vessels, which have been found to provide for unexpected amplification of signal. Subjects of interest for imaging include those suspected or know to have liver cancer, breast cancer, atherosclerosis, soft tissue sarcomas, and the like.

The preferred dosage of the contrast media will vary according to a number of factors, such as the administration route, the age, weight and species of the subject, but in general containing in the order of from 1 μmol/kg to 1 mmol/kg bodyweight of the contrast agent.

Administration may be parenteral (e.g., intravenously, intraarterially, intramuscularly, interstitially, subcutaneously, transdermally, or intrasternally) or into an externally voiding body cavity (e.g., the gastrointestinal tract, bladder, uterus, vagina, nose, ears or lungs), in an animate human or non-human (e.g., mammalian, reptilian or avian) body. Usually administration is accomplished by intravenous or intratumor injection.

Imaging of the desired area is performed by detection and appropriate analysis of the sound waves resulting from irradiation. Detection may be performed at the same surface of the sample as the source of incident radiation (reflection) or alternatively at another surface such as the surface diametrically opposed to the incident light, i.e., the sample's back surface (transmission). Suitable methods of detection include the use of a microphone, piezoelectric transducer, capacitance transducer, fiber-optic sensor, cMUT, or alternatively non-contact methods (see Tam, 1986, supra for a review). Techniques and equipment used in ultrasound imaging may be used.

The methods and uses described herein are especially useful for imaging blood-containing structures (e.g., blood vessels), which may be present in tumors, diseased tissue or particular organs, by the use of contrast agents with specificity for that region/structure, e.g., by use of biological recognition agents with the desired specificity.

Continuous wave radiation may be used with its amplitude or frequency modulated. When continuous wave radiation is used, the photoacoustic effects may be analyzed in the frequency domain by measuring amplitude and phase of one or several Fourier components. Alternatively, and preferably, short pulses (impulses) of radiation are employed which allow stress confinement. When pulses are used, analysis may be made in the time domain, i.e., on the basis of the time taken for the sound wave to reach the detector, thus simplifying analysis and aiding depth profiling.

Information obtained from the methods of the invention described herein can be used alone, or in combination with other information (e.g., age, family history, disease status, disease history, vital signs, blood chemistry, PSA level, Gleason score, lymph node staging, metastasis staging, expression of other gene signatures relevant to outcomes of a disease or disorder, such as cancer, etc.) from the subject or from the biological sample obtained from the subject. In some embodiments, the imaging data is combined or correlated with other data or test results that include, but are not limited to measurements or results from serologic testing methods, enzyme immunoassay (EIA), complement fixation (CF), immunodiffusion, clinical presentation, serology, radiography, histology, culture, and clinical parameters or other algorithms for developing or having a disease or disorder, such as cancer. In some embodiments, data include, but are not limited to age, ethnicity, PSA level, Gleason score, lymph node staging, metastasis staging, and other genomic data, and specific expression values of other gene signatures relevant to infection outcomes. In some embodiments, the data comprises subject information, such as medical history, travel history, and/or any relevant family history. Several serology techniques that can be used in combination with the compositions and methods of the present invention. Examples of serology techniques include, but are not limited to: ELISA, agglutination, precipitation, complement-fixation, fluorescent antibodies, and chemiluminescence.

The following are non-limiting examples of cancers that can be imaged, detected, and/or treated by the disclosed methods and compositions: acute lymphoblastic; acute myeloid leukemia; adrenocortical carcinoma; adrenocortical carcinoma, childhood; appendix cancer; basal cell carcinoma; bile duct cancer, extrahepatic; bladder cancer; bone cancer; osteosarcoma and malignant fibrous histiocytoma; liposarcoma and anaplastic liposarcoma; brain stem glioma, childhood; brain tumor, adult; brain tumor, brain stem glioma, childhood; brain tumor, central nervous system atypical teratoid/rhabdoid tumor, childhood; central nervous system embryonal tumors; cerebellar astrocytoma; cerebral astrocytotna/malignant glioma; craniopharyngioma; ependymoblastoma; ependymoma; medulloblastoma; medulloepithelioma; pineal parenchymal tumors of intermediate differentiation; supratentorial primitive neuroectodermal tumors and pineoblastoma; visual pathway and hypothalamic glioma; brain and spinal cord tumors; breast cancer; bronchial tumors; Burkitt lymphoma; carcinoid tumor; carcinoid tumor, gastrointestinal; central nervous system atypical teratoid/rhabdoid tumor; central nervous system embryonal tumors; central nervous system lymphoma; cerebellar astrocytoma cerebral astrocytoma/malignant glioma, childhood; cervical cancer; chordoma, childhood; chronic lymphocytic leukemia; chronic myelogenous leukemia; chronic myeloproliferative disorders; colon cancer; colorectal cancer; craniopharyngioma; cutaneous T-cell lymphoma; esophageal cancer; Ewing family of tumors; extragonadal germ cell tumor; extrahepatic bile duct cancer; eye cancer, intraocular melanoma; eye cancer, retinoblastoma; biliary track cancer, cholangiocarcinoma, anal cancer, neuroendocrine tumors, small bowel cancer, gallbladder cancer; gastric (stomach) cancer; gastrointestinal carcinoid tumor; gastrointestinal stromal tumor (gist); germ cell tumor, extracranial; germ cell tumor, extragonadal; germ cell tumor, ovarian; gestational trophoblastic tumor; glioma; glioma, childhood brain stem; glioma, childhood cerebral astrocytoma; glioma, childhood visual pathway and hypothalamic; hairy cell leukemia; head and neck cancer; hepatocellular (liver) cancer; histiocytosis, langerhans cell; Hodgkin lymphoma; hypopharyngeal cancer; hypothalamic and visual pathway glioma; intraocular melanoma; islet cell tumors; kidney (renal cell) cancer; Langerhans cell histiocytosis; laryngeal cancer; leukemia, acute lymphoblastic; leukemia, acute myeloid; leukemia, chronic lymphocytic; leukemia, chronic myelogenous; leukemia, hairy cell; lip and oral cavity cancer; liver cancer; lung cancer, non-small cell; lung cancer, small cell; lymphoma, aids-related; lymphoma, burkitt; lymphoma, cutaneous T-cell; lymphoma, non-Hodgkin lymphoma; lymphoma, primary central nervous system; macroglobulinemia, Waldenstrom; malignant fibrous histiocvtoma of bone and osteosarcoma; medulloblastoma; melanoma; melanoma, intraocular (eye); Merkel cell carcinoma; mesothelioma; metastatic squamous neck cancer with occult primary; mouth cancer; multiple endocrine neoplasia syndrome, (childhood); multiple myeloma/plasma cell neoplasm; mycosis; fungoides; myelodysplastic syndromes; myelodysplastic/myeloproliferative diseases; myelogenous leukemia, chronic; myeloid leukemia, adult acute; myeloid leukemia, childhood acute; myeloma, multiple; myeloproliferative disorders, chronic; nasal cavity and paranasal sinus cancer; nasopharyngeal cancer; neuroblastoma; non-small cell lung cancer; oral cancer; oral cavity cancer; oropharyngeal cancer; osteosarcoma and malignant fibrous histiocytoma of bone; ovarian cancer; ovarian epithelial cancer; ovarian germ cell tumor; ovarian low malignant potential tumor; pancreatic cancer, islet cell tumors; papillomatosis; parathyroid cancer; penile cancer; pharyngeal cancer; pheochromocytoma; pineal parenchymal tumors of intermediate differentiation; pineoblastoma and supratentorial primitive neuroectodermal tumors; pituitary tumor; plasma celt neoplasm/multiple myeloma; pleuropulmonary blastoma; primary central nervous system lymphoma; prostate cancer; rectal cancer; renal cell (kidney) cancer; renal pelvis and ureter, transitional cell cancer; respiratory tract carcinoma involving the nut gene on chromosome 15; retinoblastoma; rhabdomyosarcoma; salivary gland cancer; sarcoma, ewing family of tumors; sarcoma, Kaposi; sarcoma, soft tissue; sarcoma, uterine; Sezary syndrome; skin cancer (nonmelanoma); skin cancer (melanoma); skin carcinoma, Merkel cell; small cell lung cancer; small intestine cancer; soft tissue sarcoma; squamous cell carcinoma, squamous neck cancer with occult primary, metastatic; stomach (gastric) cancer; supratentorial primitive neuroectodermal tumors; T-cell lymphoma, cutaneous; testicular cancer; throat cancer; thymoma and thymic carcinoma; thyroid cancer; transitional cell cancer of the renal pelvis and ureter; trophoblastic tumor, gestational; urethral cancer; uterine cancer, endometrial; uterine sarcoma; vaginal cancer; vulvar cancer; Waldenstrom macroglobulinemia; and Wilms tumor.

In one aspect, the amount of cells associated with cancer are used to monitor subjects undergoing treatments and therapies for a cancer, subjects who have had a cancer, and subjects who are in remission of a previously diagnosed and treated cancer. In some embodiments, the amount of cells associated with a cancer are used to select or modify treatments in subjects having a cancer, subjects who have had a cancer, and subjects who are in remission of a previously diagnosed and treated cancer.

In some embodiments, the method of treating further comprises the step of allowing the composition to accumulate in at least one cell of interest, wherein the targeting domain facilitates accumulation of the composition in the at least one cell of interest.

In some embodiments, the imaging method further comprises the step of allowing the composition to accumulate in a region of the biological tissue.

In various aspects, the composition of the present invention may be delivered to a cell or biological tissue of interest by a red-blood cell-hitchhiking methods that are well-known to those of skill in the art, and such methods are incorporated herein by reference. Examples of such red-blood cell-hitchhiking methods are described in Brenner et al., 2018, Nature Commun., 9:2684.

The present invention is further drawn to, in part, a method of enhancing magnetic resonance imaging (MRI) in a living subject, the method comprising: administering to a subject an effective amount of a composition imaging the patient by MRI, wherein the MRI image is enhanced as compared to an MR image obtained without said contrast agent, wherein the contrast agent comprises a metal M and a macrocyclic ligand represented by General Formula I, or a salt thereof:

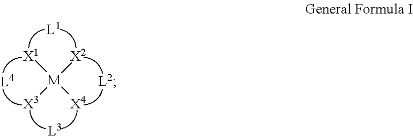

wherein M is a metal is selected from the group consisting of scandium, titanium, vanadium, chromium, manganese, iron, cobalt, nickel, copper, zinc, yttrium, zirconium, niobium, molybdenum, technetium, ruthenium, rhodium, palladium, and silver,
wherein L¹ to L⁴ are divalent linking groups,
wherein X¹ to X⁴ are each independently selected from O, S, or NR¹,
wherein R¹ is selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, or any conjugate or combination thereof, wherein at least one of X¹ to X⁴ is represented by NR¹ wherein R¹ is represented by Formula A:

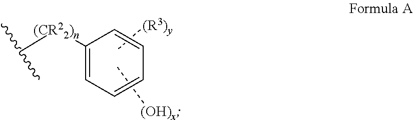

wherein R² and R³ are each independently selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, or any conjugate or combination thereof,
wherein x is an integer from 1 through 5,
wherein y is an integer from 1 through 4,
wherein n is an integer from 1 through 3,
wherein when the compound is ionic, the compound further comprises a counterion, and
imaging the patient by MRI, wherein the MRI image is enhanced as compared to an MR image obtained without said contrast agent.

In some embodiments, the contrast agent undergoes a reaction with a reactive oxygen species (ROS). Exemplary reactive oxygen species include but are not limited to peroxides, superoxides, hydroxyl radicals, singlet oxygen, and alpha oxygen. In one embodiment, the compound reacts with a radical forming compound. In one embodiment, the reactive oxygen species is H₂O₂. In one embodiment, the reactive oxygen species is superoxide. In one embodiment, the reactive oxygen species is molecular oxygen.

In some embodiments, the contrast agent undergoes a reaction with a reactive oxygen species in a solution. In one embodiment, the solution is aqueous. In one embodiment, the solution is organic. In one embodiment, the solution is a biological fluid. Exemplary bodily fluids include, but are not limited to, sweat, whole blood, urine, stool, saliva, lymph fluid, cerebrospinal fluid, synovial fluid, cystic fluid, ascites, pleural effusion, fluid obtained from a pregnant woman in the first trimester, fluid obtained from a pregnant woman in the second trimester, fluid obtained from a pregnant woman in the third trimester, maternal blood, amniotic fluid, chorionic villus sample, fluid from a preimplantation embryo, maternal urine, maternal saliva, placental sample, fetal blood, lavage, cervical vaginal fluid, interstitial fluid, ocular fluid, blood, plasma, serum, sputum, feces, semen, mucous, lymph, nasal lavage, eye lavage, peritoneal cavity lavage, vaginal lavage, bladder lavage, rectal lavage, fine needle aspiration of spinal fluid, and synovial fluid aspiration.

In one embodiment, the composition comprises the contrast agent in solution. In one embodiment, the composition comprises the contrast agent in organic solution. In one embodiment, the composition comprises the contrast agent in aqueous solution. In one embodiment, the composition comprises the contrast agent in a suspension. In one embodiment, the composition comprises the contrast agent in a pharmaceutically acceptable carrier.

As used herein, the term “pharmaceutically acceptable carrier” means a pharmaceutically acceptable material, composition or carrier, such as a liquid or solid filler, stabilizer, dispersing agent, suspending agent, diluent, excipient, thickening agent, solvent or encapsulating material, involved in carrying or transporting a compound useful within the invention within or to the subject such that it may perform its intended function. Typically, such constructs are carried or transported from one organ, or portion of the body, to another organ, or portion of the body. Each carrier must be “acceptable” in the sense of being compatible with the other ingredients of the formulation, including the compound useful within the invention, and not injurious to the subject. Some examples of materials that may serve as pharmaceutically acceptable carriers include: sugars, such as lactose, glucose, and sucrose; starches, such as corn starch and potato starch; cellulose, and its derivatives, such as sodium carboxymethyl cellulose, ethyl cellulose, and cellulose acetate; powdered tragacanth; malt; gelatin; talc; excipients, such as cocoa butter and suppository waxes; oils, such as peanut oil, cottonseed oil, safflower oil, sesame oil, olive oil, corn oil, and soybean oil; glycols, such as propylene glycol; polyols, such as glycerin, sorbitol, mannitol, and polyethylene glycol; esters, such as ethyl oleate and ethyl laurate; agar; buffering agents, such as magnesium hydroxide and aluminum hydroxide; surface active agents; alginic acid; pyrogen-free water; isotonic saline; Ringer's solution; ethyl alcohol; phosphate buffer solutions; and other non-toxic compatible substances employed in pharmaceutical formulations. As used herein, “pharmaceutically acceptable carrier” also includes any and all coatings, antibacterial and antifungal agents, and absorption delaying agents, and the like that are compatible with the activity of the compound useful within the invention, and are physiologically acceptable to the subject. Supplementary active compounds may also be incorporated into the compositions. The “pharmaceutically acceptable carrier” may further include a pharmaceutically acceptable salt of the compound useful within the invention. Other additional ingredients that may be included in the pharmaceutical compositions used in the practice of the invention are known in the art.

In one embodiment, the contrast agent is administered in a concentration of 0.01 to 5.00 mM. In one embodiment, the contrast agent is administered in a concentration of 0.01 to 4.00 mM. In one embodiment, the contrast agent is administered in a concentration of 0.01 to 3.00 mM. In one embodiment, the contrast agent is administered in a concentration of 0.01 to 2.00 mM. In one embodiment, the contrast agent is administered in a concentration of 0.01 to 1.00 mM. In one embodiment, the contrast agent is administered in a concentration of 0.05 to 1.00 mM. In one embodiment, the contrast agent is administered in a concentration of 0.10 to 1.00 mM. In one embodiment, the contrast agent is administered in a concentration of 0.15 to 1.00 mM. In one embodiment, the contrast agent is administered in a concentration of 0.20 to 1.00 mM. In one embodiment, the contrast agent is administered in a concentration of 0.25 to 1.00 mM. In one embodiment, the contrast agent is administered in a concentration of 0.30 to 1.00 mM. In one embodiment, the contrast agent is administered in a concentration of 0.35 to 1.00 mM. In one embodiment, the contrast agent is administered in a concentration of 0.40 to 1.00 mM. In one embodiment, the contrast agent is administered in a concentration of 0.45 to 1.00 mM. In one embodiment, the contrast agent is administered in a concentration of 0.50 to 1.00 mM. In one embodiment, the contrast agent is administered in a concentration of 0.55 to 1.00 mM. In one embodiment, the contrast agent is administered in a concentration of 0.60 to 1.00 mM. In one embodiment, the contrast agent is administered in a concentration of 0.65 to 1.00 mM. In one embodiment, the contrast agent is administered in a concentration of 0.70 to 1.00 mM. In one embodiment, the contrast agent is administered in a concentration of 0.85 to 1.00 mM. In one embodiment, the contrast agent is administered in a concentration of 0.90 to 1.00 mM. In one embodiment, the contrast agent is administered in a concentration of 0.95 to 1.00 mM. In one embodiment, the contrast agent is administered in a concentration of 0.10 to 0.95 mM. In one embodiment, the contrast agent is administered in a concentration of 0.10 to 0.90 mM. In one embodiment, the contrast agent is administered in a concentration of 0.10 to 0.85 mM. In one embodiment, the contrast agent is administered in a concentration of 0.10 to 0.80 mM. In one embodiment, the contrast agent is administered in a concentration of 0.10 to 0.75 mM. In one embodiment, the contrast agent is administered in a concentration of 0.10 to 0.70 mM. In one embodiment, the contrast agent is administered in a concentration of 0.10 to 0.65 mM. In one embodiment, the contrast agent is administered in a concentration of 0.10 to 0.60 mM. In one embodiment, the contrast agent is administered in a concentration of 0.10 to 0.55 mM. In one embodiment, the contrast agent is administered in a concentration of 0.10 to 0.50 mM. In one embodiment, the contrast agent is administered in a concentration of 0.10 to 0.45 mM. In one embodiment, the contrast agent is administered in a concentration of 0.10 to 0.40 mM. In one embodiment, the contrast agent is administered in a concentration of 0.10 to 0.35 mM. In one embodiment, the contrast agent is administered in a concentration of 0.10 to 0.30 mM. In one embodiment, the contrast agent is administered in a concentration of 0.10 to 0.25 mM. In one embodiment, the contrast agent is administered in a concentration of 0.10 to 0.20 mM. In one embodiment, the contrast agent is administered in a concentration of 0.10 to 0.15 mM. In one embodiment, the contrast agent is administered in a concentration of 0.01 to 0.10 mM. In one embodiment, the contrast agent is administered in a concentration of 0.01 to 0.20 mM. In one embodiment, the contrast agent is administered in a concentration of 0.01 to 0.30 mM. In one embodiment, the contrast agent is administered in a concentration of 0.01 to 0.40 mM. In one embodiment, the contrast agent is administered in a concentration of 0.01 to 0.50 mM. In one embodiment, the contrast agent is administered in a concentration of 0.01 to 0.60 mM. In one embodiment, the contrast agent is administered in a concentration of 0.01 to 0.70 mM. In one embodiment, the contrast agent is administered in a concentration of 0.01 to 0.80 mM. In one embodiment, the contrast agent is administered in a concentration of 0.01 to 0.90 mM.

The present compositions and contrast agents can be adapted for administration using a wide variety of methods of delivery, including, but not limited to, e.g., subcutaneously, intravenously, peritoneally, orally, intramuscular, topical, nasally, intradermally, ocularly, rectally, vaginally, or combinations thereof.

EXPERIMENTAL EXAMPLES The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

The present approach involves the preparation redox-responsive contrast agents for magnetic resonance imaging (MRI) that activate upon reaction with H₂O₂ (Karbalaei, S. et al., 2021, Inorg. Chem., 60:8368; Yu, M. et al., 2014, J. Am. Chem. Soc., 136:12836; Yu, M. et al., 2017, Inorg. Chem., 56:2812; Yu, M. et al., 2012, Inorg. Chem. 51:9153).

Recently reported sensors have consisted of Mn(II) ions complexed to quinol-containing polydentate ligands. Positive r₁ responses to H₂O₂ are observed with N₄O₂ or N₅O coordination spheres, where the N-donors come from either neutral pyridine or amine groups. With a weakly anionic coordination sphere, the Mn(III/II) reduction potential is high enough to discourage oxidation of the metal to the less paramagnetic+3 oxidation state. Terminal oxidants, such as H₂O₂, instead preferentially oxidize the ligand, differentiating the present sensors from redox-responsive MRI contrast agents reported by Gale, Caravan, and others (Wang, H. et al., 2019, J. Am. Chem. Soc., 141:5916; Loving, G. S. et al., 2013, J. Am. Chem. Soc., 135:4620; Gale, E. M. et al., 2014, Inorg. Chem., 53:10748). The oxidation of the quinol portions of the ligands to para-quinones is accompanied by an increase in r₁. Water molecules are proposed to displace para-quinones from the metal center, enhancing r₁ through better aquation of the Mn(II). Having a second quinol in the coordination sphere generally improves the r₁ response to H₂O₂. The relaxivities of [Mn(H₂qp1)(MeCN)]²⁺ and [Mn(H₄qp2)Br₂] increase by 10% and 30%, respectively, upon oxidation by excess H₂O₂.

This strategy necessarily relies on reducing the ligand's affinity for the Mn(II), and in the case of [Mn(H₄qp2)Br₂], a substantial portion of the metal ion is likely released upon oxidation by H₂O₂. Anionic groups and macrocycles are frequently used to stabilize Gd(III)- and Mn(II)-containing MRI contrast agents (Caravan, P. et al., 1999, Chem. Rev., 99:2293; Drahos, B. et al., 2012, Eur. J. Inorg. Chem., 2012:1975). H₄qp2 pyridines were previously replaced with carboxylic acids in order to stabilize Mn(II) complexes; the carboxylic acids entirely deprotonate to carboxylates at pH 7. Although the more anionic H3qc13- and H2qc14-forms of the H6qc1 ligand do indeed allow it to coordinate more tightly to the dicationic metal center, the additional negative charges in the coordination sphere render the manganese more susceptible to oxidation. The oxidation of the metal center to the less paramagnetic Mn(III) eliminates the r₁ response of this complex to H₂O₂. A Mn(II) complex with a fluorinated tetradentate ligand with nearly identical chelating groups likewise gets readily oxidized to a lower relaxivity Mn(III) species upon reaction with excess H₂O₂ (Chen, H. et al., 2020, Chem. Commun., 56:4106). The other strategy to discourage metal release would be to incorporate a macrocycle into the ligand framework to stabilize the resultant transition metal complexes both thermodynamically and kinetically (Hubin, T. J. 2003, Coord. Chem. Rev., 241:27).

In this work, a new macrocyclic ligand, 1,8-bis(2,5-dihydroxybenzyl)-1,4,8,11-tetraazacyclotetradecane (H₄qp4), and its complex with Mn(II) were synthesized. It was found that the redox reactivity of the Mn(II) compound was similar to those of Mn(II) complexes with H₂qp1 and H₄qp2 in that 1) the reactivity with air is slight and 2) the reactivity with H₂O₂ primarily oxidizes the ligand rather than the metal ion. In addition to the anticipated stabilization of the Mn(II) complexes with the quinol- and para-quinone forms of the ligand, the inclusion of the macrocycle improves the maximal MRI response, with r₁ increasing by 130% upon oxidation by H₂O2.

Furthermore, a highly water- and air-stable Fe(II) complex with the quinol-containing macrocyclic ligand H₄qp4 reacts with H₂O₂ to yield Fe(III) complexes with less highly chelating forms of the ligand that have either one or two para-quinones. The reaction increased the T₁-weighted relaxivity over four-fold, enabling the complex to detect H₂O₂ using clinical MRI technology. The iron-containing sensor differed from its manganese analog, which also detects H₂O₂, in that it was the oxidation of the metal center, rather than the ligand, that primarily enhanced the relaxivity.

### Example 1: A Macrocyclic Ligand Framework Improves Both the Stability and T₁-Weighted MRI Response of Quinol-Containing H₂O₂ Sensors

### Synthesis and Characterization of (1,8-Bis(2,5-dihydroxybenzyl)-1,4,8,11tetraazacyclotetradecane)manganese(II) triflate ([Mn(H₃qp4)](OTf), 1)

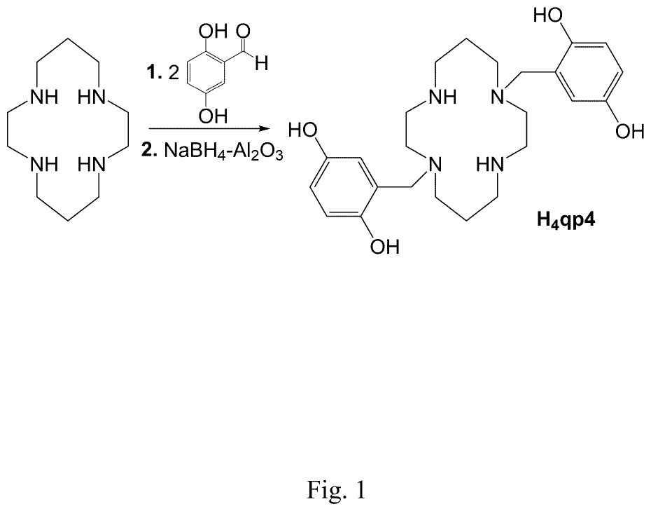

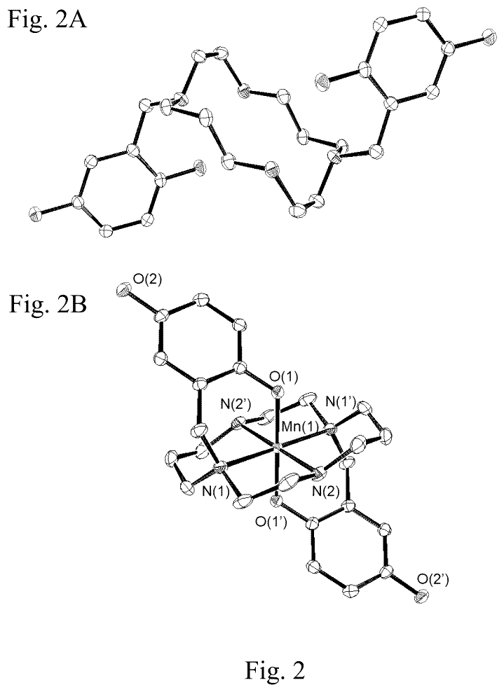

The H₄qp4 ligand was synthesized in one step from cyclam, two equiv. of 2,5-dihydroxybenzaldehyde, and excess NaBH₄—Al₂O₃(FIG. 1). The synthesis was inspired by that used to prepare 1,8-bis(2-hydroxybenzyl)-1,4,8,11-tetraazacyclotetradecane (H₂bcyclamb), which features phenols in place of the quinol groups (Luo, H. et al., 2001, Can. J. Chem., 79:1105). The preparation of H₄qp4 was complicated by the sensitivity of the bisaminal intermediate to air, necessitating that the addition of the quinols be done in a one-pot reaction, rather than over two discrete steps. The one-pot reaction had the unexpected benefit of modestly improving the yield of H₄qp4 (38%); the overall yield of H₂bcyclamb was 28%. The purity and identity of H₄qp4 were confirmed by NMR and HR-MS. The triflic acid salt of the ligand, [H₆qp4](OTf)₂ was also crystallized from MeOH (FIG. 2).

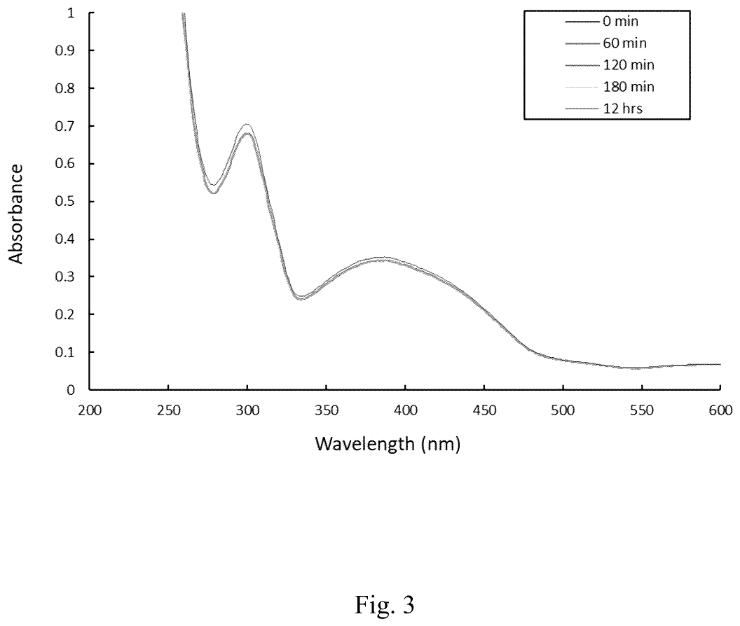

A Mn(II) complex with H₄qp4, [Mn(H₃qp4)](OTf) (1), was prepared by refluxing the ligand and Mn(OTf)₂ in 1:1 MeCN/THF for 2 d. The complexation reaction required a much higher temperature and a much longer reaction time than the syntheses of [Mn(H₂qp1)(MeCN)](OTf)₂ (2) and [Mn(H₄qp2)Br₂] (3). The incorporation of metal ions into macrocycles often requires such measures. Complex 1 differed from previously isolated Mn(II) complexes with polydentate quinol-containing ligands in that it featured a deprotonated quinol. Elemental analysis of powdered samples of 1 indicated that there is a single triflate per manganese. The EPR and the magnetic susceptibility measurements both indicated that the metal ion is high-spin Mn(II). Since there is only one counteranion, this thereby necessitates a −1 charge on the polydentate ligand (H₃qp4⁻). The presence of a quinolate was further supported by the presence of two bands in the UV/vis spectrum of the isolated product in MeCN (FIG. 3). The feature at 304 nm is consistent with a neutral quinol; bands at similar energies are the sole UV/vis features observed above 250 nm for both 2 and 3 in MeCN. The additional band at 388 nm has an energy that is more consistent with a quinolate group; these have been observed for the H₂qp1 and H₄qp2 complexes in water.

Complex 1 was stable to air in the solid and solution states for prolonged periods of time. Samples of 1 in MeCN displayed negligible changes to their UV/vis features over a 12 h exposure to air. If solutions of 1 in either aqueous or organic solvents were kept under air for 1-2 weeks, the compound eventually oxidized to [Mn^{III}(H₂qp4)](OTf) (4), where H₂qp4²⁻ is the doubly deprotonated form of the ligand.

1,4,8,11-tetracyclotetradecane (cyclam) (1.00 g, 4.99 mmol) and 2,5-dihydroxybenzaldehyde (1.37 g, 9.91 mmol) were combined in 15 mL of dry MeOH. The mixture was heated at reflux for 4 h under N2. The reaction mixture was then cooled to 0° C. with an ice bath. Once the temperature reached 0° C., 20 mL of additional dry MeOH and NaBH₄—Al₂O₃ (wt. 10%, 0.83 g, ˜0.02 mol) were gradually added to the solution. The resultant solution was heated at reflux for 6 h under N2 and then cooled to 0° C. The residual reductant was titrated with 1 M HCl until the solution reached pH 8, depositing the crude product as a solid which was collected via filtration. The solid was dissolved in acetone and filtered. The acetone was rotavapped to yield the product as a yellow powder (842 mg, 38% yield). Typical yields range from 38 to 42%. ¹H NMR (400 MHz, DMSO-d6, 297 K): S 8.55 (s, 2H), 6.97 (s, 2H), 6.50-6.56 (m, 4H), 6.45 (s, 2H), 3.16 (s, 4H), 2.45-2.59 (m, overlap with solvent peak), 2.28 (s, 4H), 1.69 (s, 4H), 1.14 (s, 2H). ¹³C NMR (100 MHz, DMSO-d6, 297 K): S 149.98, 149.17, 124.98, 118.02, 117.10, 115.48, 53.80, 53.11, 50.50, 49.26, 46.38, 24.71. MS (ESI): calcd for MH, 445.2815; found, 445.2821.

H₄qp4 (500 mg, 1.12 mmol) and Mn(OTf)₂ (397 mg, 1.12 mmol) were dissolved in 5 mL of dried 1:1 MeCN-THF under N2. The mixture was stirred at 60° C. for 48 h; over this time, a green solid precipitated from the solution. The crude product was collected via filtration and washed with cold MeCN to yield the product as a green powder (577 mg, 76% yield). Typical yields range from 70 to 75%. MS (ESI): calcd for [Mn(H₂qp4)]⁺, 497.1961 and [Mn(H₂qp4)(OTf)]⁺, 646.1481; found, 497.1931 and 646.1470. Solid-state magnetic susceptibility (294 K): μ_{eff}=5.6μ_{B}. Optical spectroscopy (MeCN, 294 K): 300 nm (6800 M⁻¹ cm⁻¹), 388 nm (3500 M⁻¹ cm⁻¹). IR (cm⁻¹): 3282 (m), 3069 (w), 2852 (w), 1611 (w), 1511 (m), 1483 (m), 1361 (m), 1279 (s), 1191 (s), 1238 (s), 1212 (s), 1180 (s), 1150 (s), 1090 (m), 1060 (m), 1026 (s), 992 (m), 916 (m), 868 (m), 815 (s), 751 (m), 631 (s), 572 (m), 510 (m). Elemental analysis (powder) calcd for C₂₅H₃₅N₄O₇F₃S₁Mn·1.5 H₂O: C, 44.51%; H, 5.67%; N, 8.30%. Found: C, 44.27%; H, 5.14%; N, 8.09%.

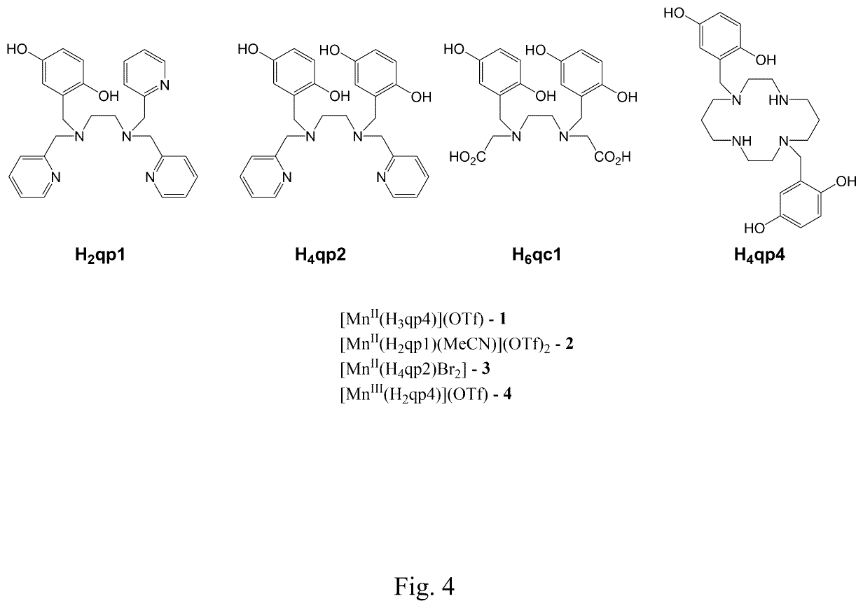

Both H₄qp4 and [Mn(H₃qp4)](OTf) (1) were prepared in straightforward manners using techniques slightly modified from previously successful procedures. The synthesis for a closely related cyclam derivative with two phenols appended to two of the amines was done in two distinct steps (Luo, H. et al., 2001, Can. J. Chem., 79:1105), but the heightened air-sensitivity of the quinols under basic conditions led to the exploration of a one-pot reaction. Once the ligand was prepared, the installation of the Mn(II) into the macrocycle proceeded cleanly using protocols commonly used for other macrocycle complexation reactions (McGowan, P. C. et al., 2001, Inorg. Chem., 40:1445; Major, J. L. et al., 2007, Proc. Natl. Acad. Sci., 104:13881; Regueiro-Figueroa, M. et al., 2014, Chem. Eur. J. 20:17300; Wang, S. et al., 2009, Inorg. Chem., 48:719; Phukan, B. et al., 2018, Inorg. Chem. 57:2631). Unexpectedly, the Mn(II) was bound to the singly deprotonated ligand H₃qp4⁻, rather than neutral H₄qp4, in the solid isolated from precipitation of the Mn(II) complex from organic solvents. Analogous complexes with H₂qp1 and H₄qp2 (FIG. 4), [Mn(H₂qp1)(MeCN)](OTf)₂ (2) and [Mn(H₄qp2)Br₂](3), contain exclusively quinols rather than quinolates. It was speculated that residual metal-free H₄qp4 served as the base that deprotonated the metal-bound ligand. Although the protonated ligand byproduct(s) has not been isolated, this was a likely explanation for the deprotonation of the Mn(II) complex due to the ligand's high affinity for protons and the ˜75% yield of 1, which would provide enough residual ligand to serve as a base.

As anticipated, 1 contained a high-spin Mn(II) metal center as evidenced by EPR, UV/Vis, and solid-state magnetic susceptibility data. The UV/Vis features corresponded to intraligand transitions for the quinol and quinolate groups; these provided convenient spectroscopic signatures to follow the oxidation state of the ligand.

Structures of [H₆qp4](OTf)₂ and 4

The crystal structure of the doubly protonated H₄qp4 ligand was generated (FIG. 2A). The protonation state of the ligand was deduced from the 1:2 ligand/triflate ratio of the solid. Each additional proton bridges the two N atoms from a 1,2-ethanediamine portion of the macrocycle. One of the O atoms from the nearest quinol is centered over each 1,2-ethanediamine moiety, with nearly equal distances between the O atom and each N (2.94 and 2.95 Å).

Attempts to crystallize 1 were unsuccessful, but 4 was crystallized by slowly diffusing CH₂Cl₂ into a saturated solution of 1 in MeCN under air over 2 weeks (FIG. 2B). The reddish color of the crystals suggested that the manganese had been oxidized to either the +3 or +4 oxidation state. Single crystal x-ray diffraction data unambiguously assigned the metal center as Mn(III). The Mn—N and Mn—O bonds for 4 average 2.16 Å and 1.89 Å, respectively. Typical bonds between Mn(II) and neutral N-donors are longer, ranging from 2.2-2.3 Å; whereas bonds between Mn(II) and even anionic O-donors usually exceed 2.0 Å (Zhang, Q. et al., 2011, Inorg. Chem., 50:9365; Goldsmith, C. R. et al., 2005, J. Am. Chem. Soc., 127:9904; Coates, C. M. et al., 2009, Inorg. Chim. Acta., 362:4797; Klein Gebbink, R. J. M., 2002, Inorg. Chem., 41: 4633). The Mn—N and Mn—O bond distances observed for 4 were instead more consistent with a Mn(III) ion bound to neutral N-donors and anionic 0-donors (Goldsmith, C. R. et al., 2005, J. Am. Chem. Soc., 127:9904). Additionally, the coordination complex displayed a rhombic [2+2+2] Jahn-Teller distortion, with pairs of short (Mn—O(1), Mn—O(1′)), intermediate (Mn—N(2), Mn—N(2′)) and long (Mn—N(1), Mn—N(1′)) metal-ligand bonds (Shongew, M. S. et al., 1994, J. Chem. Soc., Chem. Commun., 887). Such distortions would be anticipated for a high-spin d⁴ electronic configuration but not for a d³ metal ion. The metal center was therefore more likely to be Mn(III) than Mn(IV).

### Investigation of the Stability and Speciation of 1 in Water, Air, and Adventitious Metal Ions

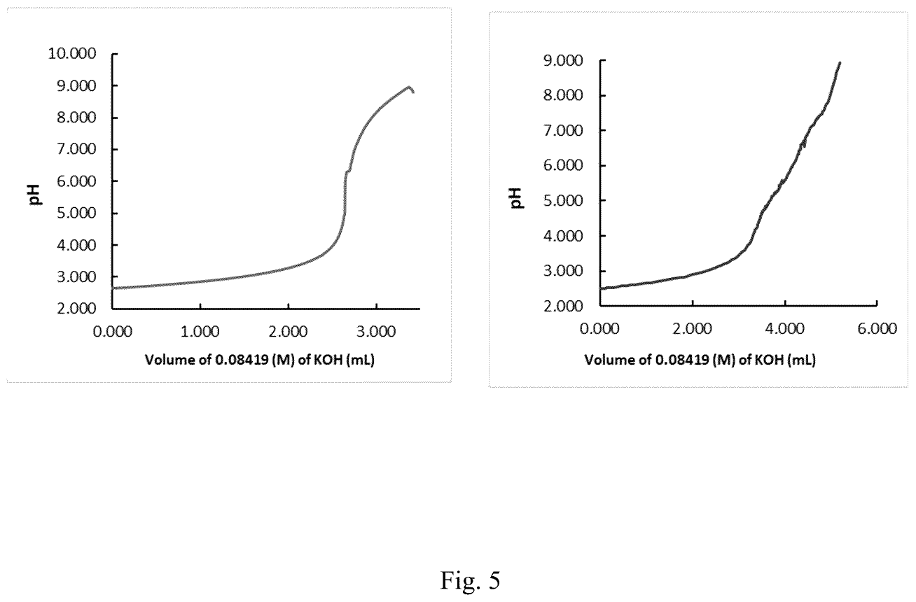

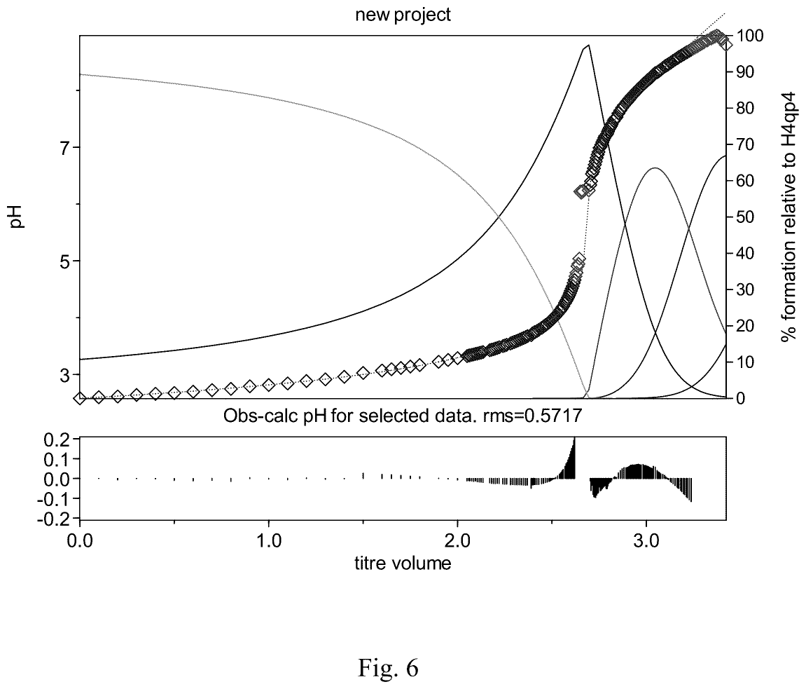

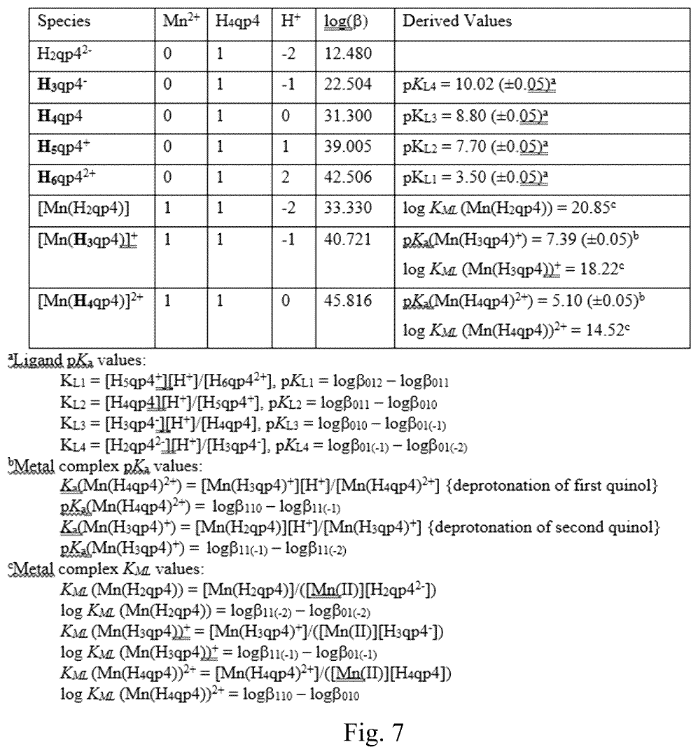

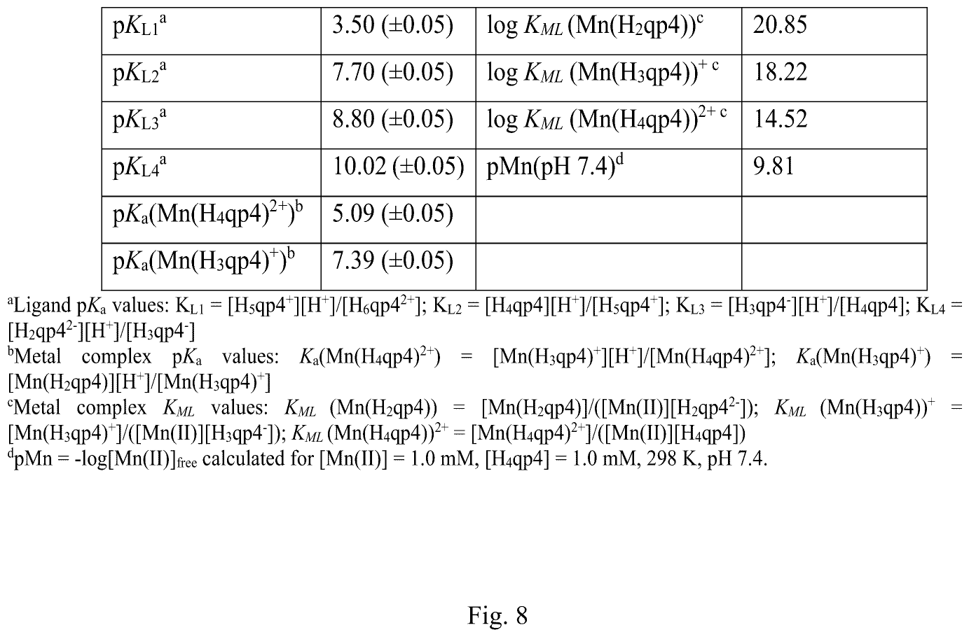

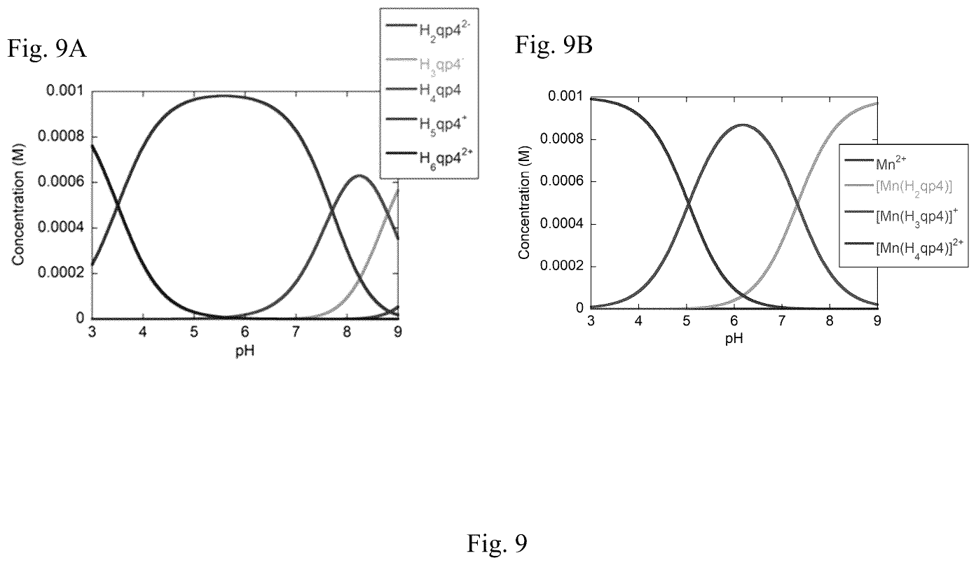

The speciation of the free H₄qp4 ligand was investigated from pH 3 to 9 (FIG. 5). The best-fitting model to the potentiometric pH titration data is comprised of four ionization events corresponding to pKₐ values of 3.5, 7.7, 8.8, and 10.0 (FIG. 6, FIG. 7, FIG. 8). Cyclam by itself is quadruply protonated under extremely acidic conditions, with two of the protons being retained from pH 2 to pH 10 (Motekaitis, R. J. et al., 1996, Inorg. Chem., 35:3821). The H₄qp4 ligand appeared to behave similarly, and the species at pH 3 was assigned as H₆qp4²⁺. The ligand existed primarily as Hsqp4⁺ at pH 7.0, with a considerable amount of H₄qp4 (FIG. 9A). Traces of doubly deprotonated H₂qp4²⁻, which would feature two quinolates, were seen at the basic end-point of the titration.

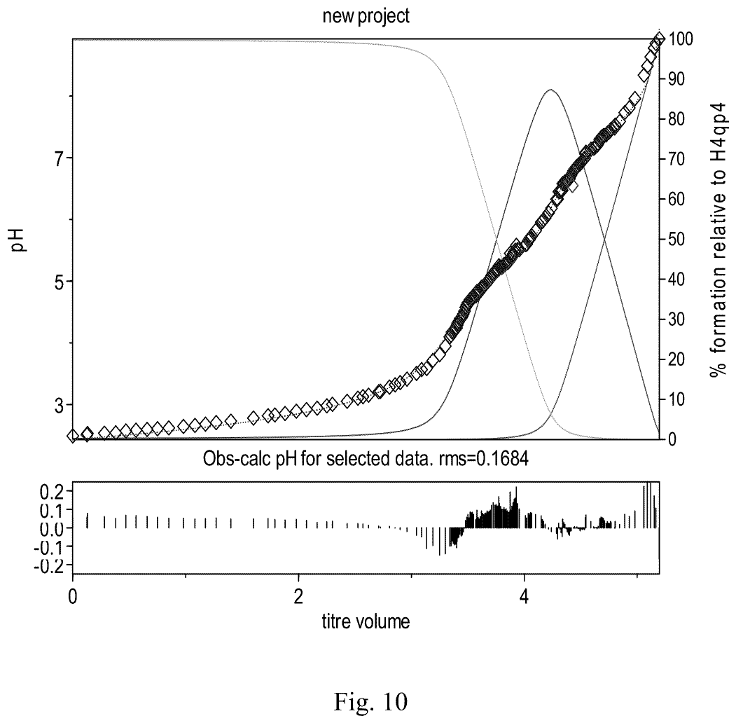

The inclusion of a macrocycle into the ligand framework greatly stabilized 1 in water relative to previously prepared contrast agents. The stability and speciation of 1 were assessed using potentiometric pH titration data acquired from pH 3 to pH 9. The best-fitting model for the data suggested that there was negligible Mn(II) release from the ligand even at pH 3 (FIG. 9B, FIG. 10). The pMn at pH 7.4 with 1.0 mM of Mn(II) and ligand was calculated to be 9.81. Two ionization events were observed between pH 3.0 and pH 9.0. The associated pKₐ values of 5.09 and 7.39 were consistent with the sequential deprotonation of two Mn(II)-bound quinols as the solution was made more basic (Sahoo, S. C. et al., 2010, Inorg. Chim. Acta, 363:3055). The calculated log K_{ML} values for Mn(II) bound to H₄qp4, H₃qp4⁻, and H₂qp4²⁻ all exceeded 14, with the binding affinity becoming stronger as the ligand deprotonates to more anionic forms.

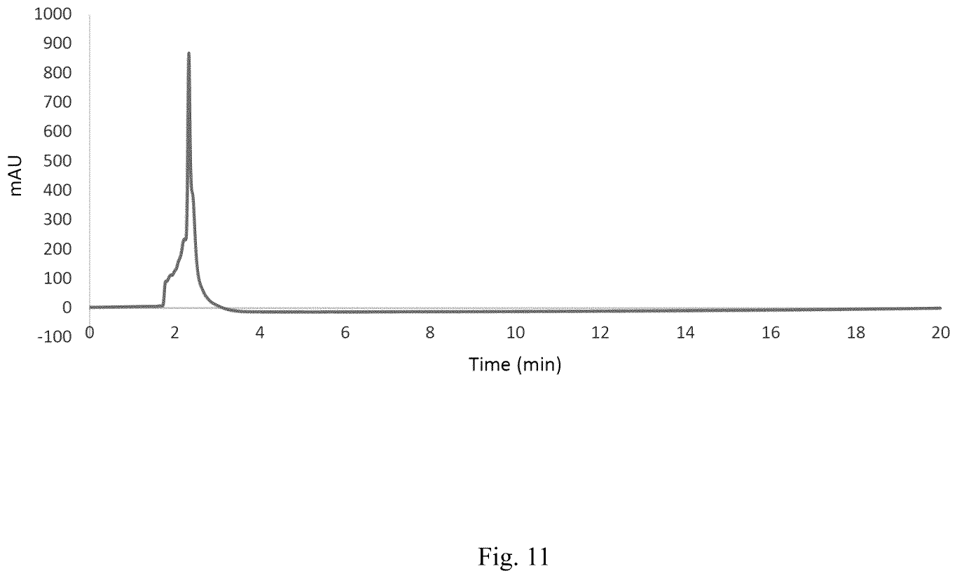

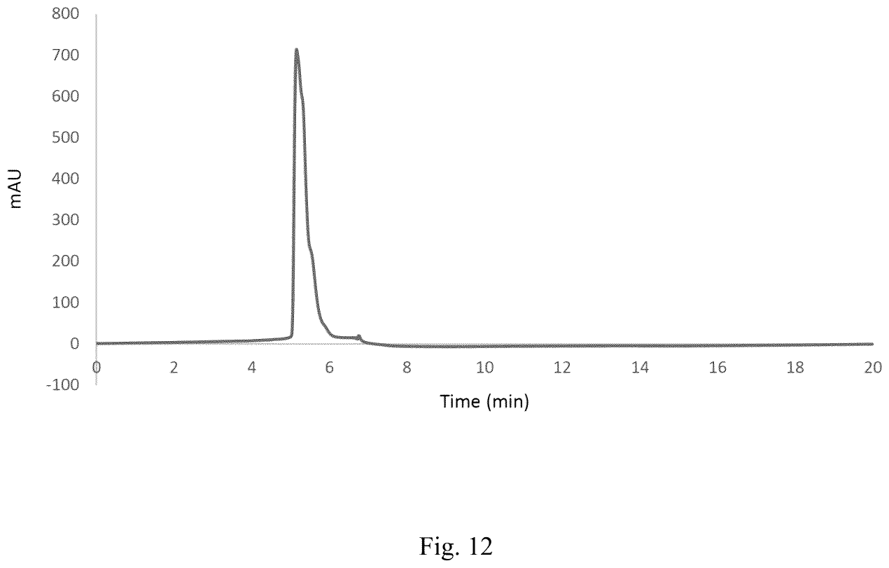

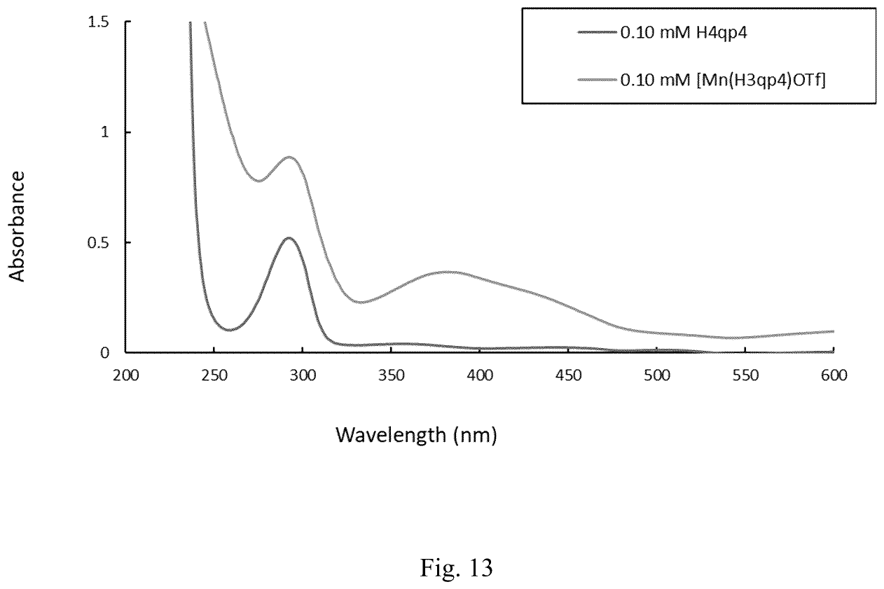

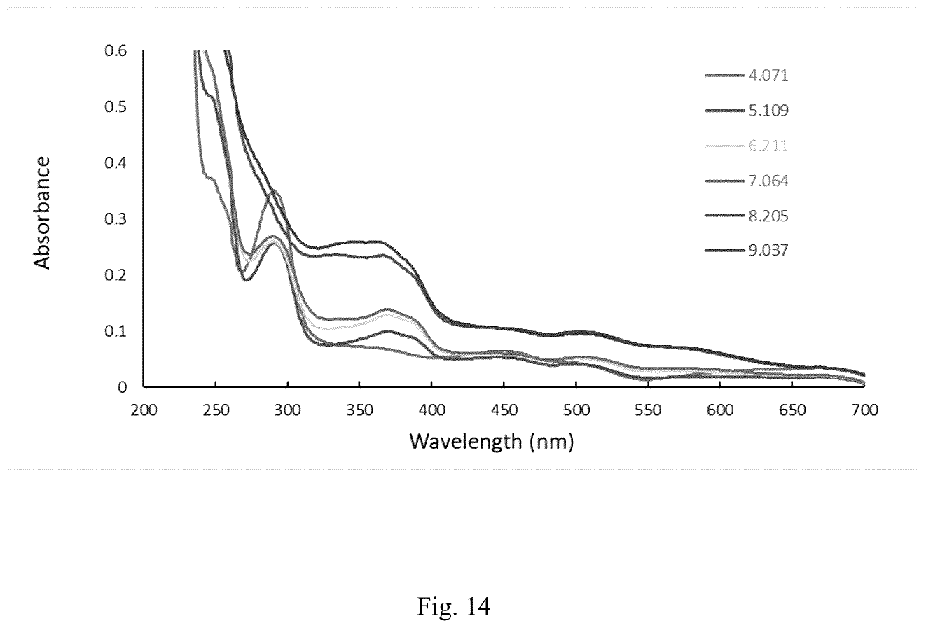

The stability of the Mn(II)-H₄qp4 complex in water was confirmed by high performance liquid chromatography (HPLC) (FIG. 11, FIG. 12). The H₄qp4 ligand and 1 each gave rise to single LC peaks with distinct retention times. The partial deprotonation of the metal-bound quinols in 1 at pH 7.00 was supported by UV/vis measurements. The spectrum of 1 in 50 mM HEPES solution buffered to pH 7.00 displayed an intense band at 388 nm that was absent in the spectrum for metal-free H₄qp4 under the same conditions (FIG. 13). This energy of this new band was consistent with a phenolate or quinolate group. The assignment of the 5.09 and 7.39 pKₐ values to the deprotonation of the metal-bound quinols was also supported by a parallel spectrophotometric pH titration (FIG. 14). The UV/vis spectrum of 1 changed markedly and continually as the pH rose from 4 to 9. Since Mn(II) does not generally support charge transfer or d-d bands, these changes could be assigned to the sequential deprotonation of the ligand's two quinols.

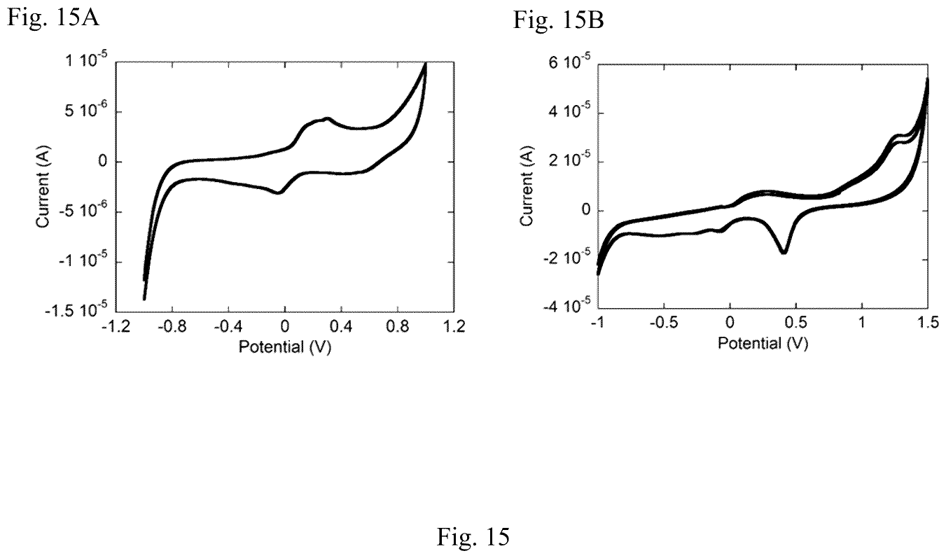

Complex 1 was electrochemically characterized by cyclic voltammetry (CV) in an aqueous 50 mM phosphate solution buffered to pH 7.2. An irreversible feature with Eₚₐ=1.25 V vs. Ag/AgCl was observed and assigned to the oxidation of the metal to Mn(III). In addition, a redox feature with E_{1/2} of 100 mV vs. Ag/AgCl was detected (295 mV vs. NHE, FIG. 15). The separation between the anodic and cathodic peaks (ΔE) was approximately 260 mV. Since redox processes with similar E_{1/2} values were found for manganese and zinc complexes with polydentate quinol-containing ligands, the 100 mV vs. Ag/AgCl feature was assigned to the oxidation and reduction of the ligand, rather than the manganese (Ward, M. B. et al., 2018, Nature Chem. 10:1207). The ΔE for the 100 mV redox event was larger than the 230 mV value measured for 3; the poor reversibility of both features was attributed to the more extensive acid/base chemistry associated with having two, rather than one, quinol/quinolate groups in these coordination complexes.

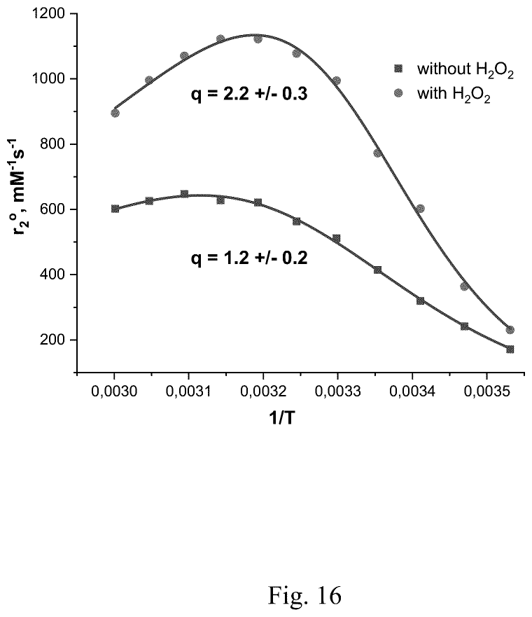

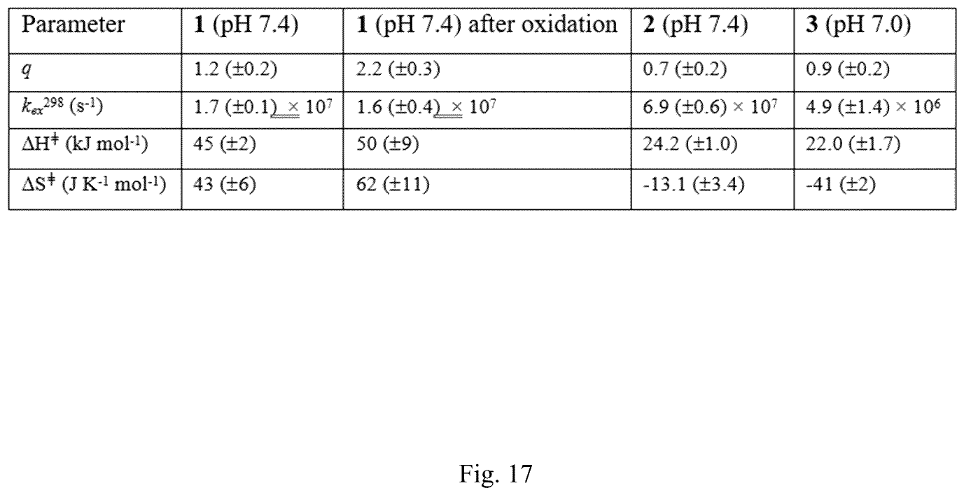

The ability of 1 to interact with water was studied using variable temperature ¹⁷O NMR using the methodology pioneered by Gale et al (FIG. 16) (Gale, E. M. et al., 2013, J. Am. Chem. Soc., 135:18600). The results at pH 7.4 are consistent with q=1.2 (FIG. 17). When 1 is dissolved in pH 7.4 water, the predominant species is therefore [Mn(H₃qp4)(H₂O)]⁺, with next most prevalent species being [Mn(H₂qp4)(H₂O)]. The calculated rate constant for water exchange at 298 K is 1.7×10⁷ s⁻¹, which is at the slower end of the range typically seen for Mn(II) complexes (Dees, A. et al., 2007, Inorg. Chem., 46:2459; Kenkel, I. et al., 2017, J. Am. Chem. Soc., 139:1472; Lieb, D. et al., 2013, Inorg. Chem., 52:222; Gale, E. M. et al., 2015, J. Am. Chem. Soc., 137:15548; Troughton, J. S. et al., 2004, Inorg. Chem., 43:6313; Molnar, E. et al., 2014, Inorg. Chem., 53:5136; Botar, R. et al., 2020, J. Am. Chem. Soc., 142:1662). The ΔS^{‡} was highly positive, consistent with a dissociate mechanism for water exchange at the metal center.

Complex 1 did not display any noticeable short-term reactivity to air. The UV/vis spectrum of 1 in MeCN did not appreciably change over the course of a 12 h exposure to air (FIG. 16, FIG. 17). Both 2 and 3, conversely, appeared to oxidize slightly (5-10%) to Mn(II) para-quinone complexes under the same conditions. O₂ did eventually oxidize 1, with the Mn(III)-containing 4 depositing over 1-2 weeks (FIG. 2B).

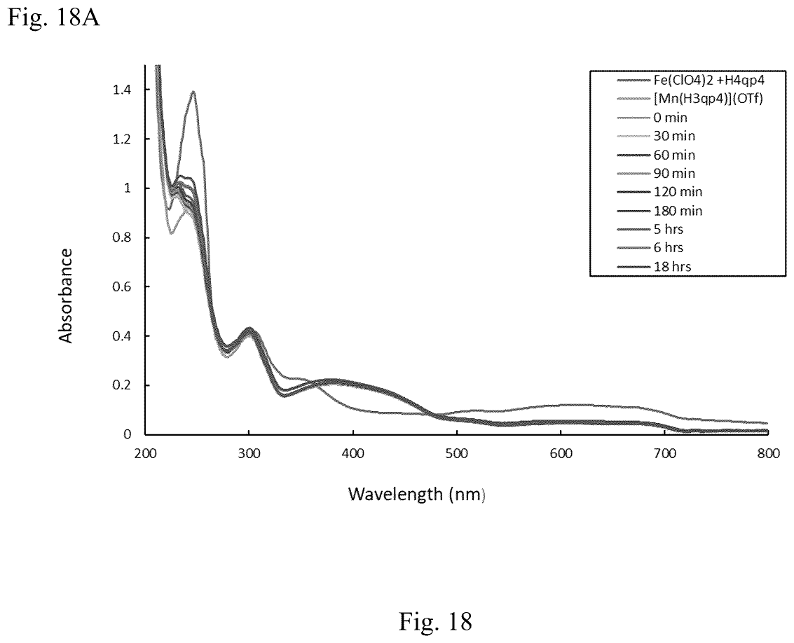

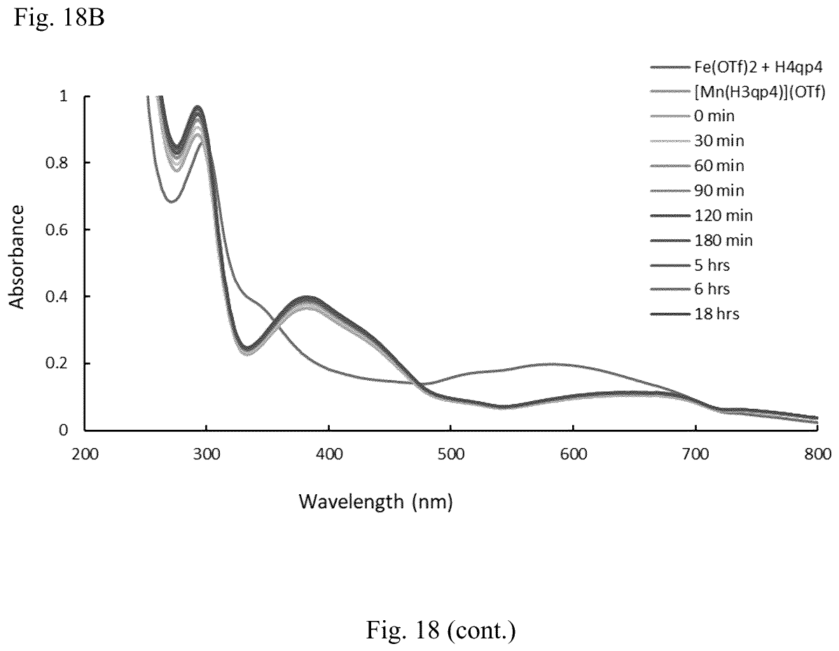

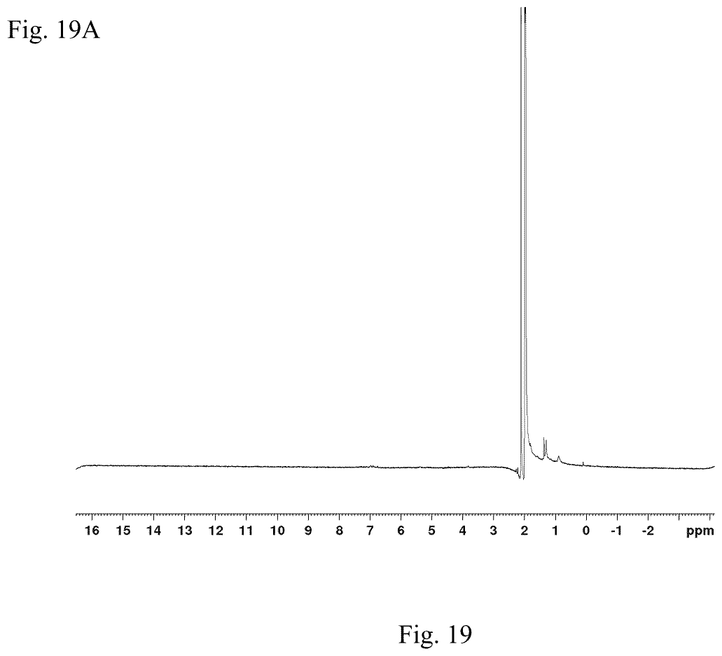

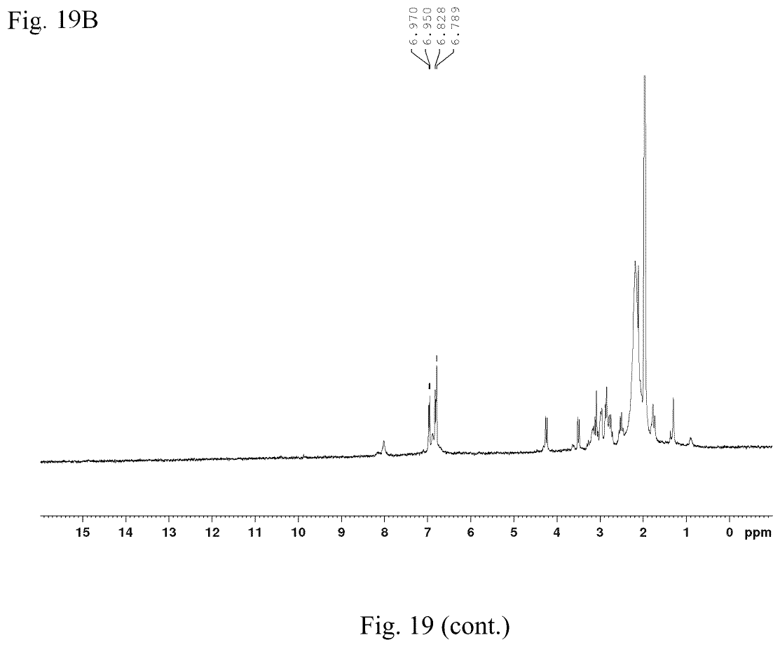

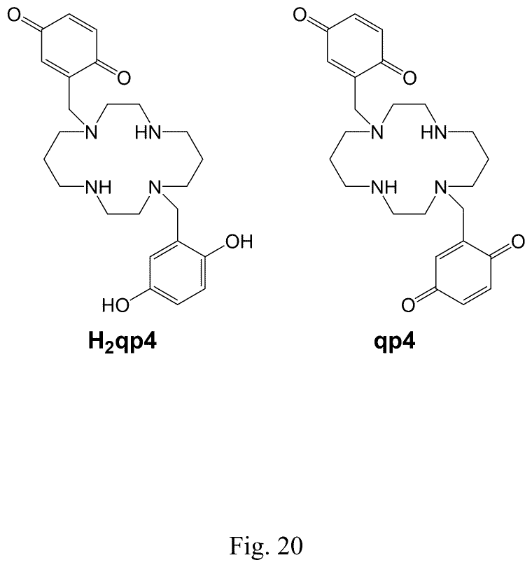

Complex 1 differed from 2 and 3 in that it strongly resisted metal ion exchange. The reaction between 0.1 mM Fe(ClO₄)₂ and 0.1 mM 1 in either MeCN or buffered water did not yield UV/vis-detectable quantities of [Fe(H₃qp4)]⁺, even at 18 h (FIG. 18). The changes to the UV/vis spectrum of 1 over this time were negligible. Complex 2, conversely, slowly exchanged Fe(II) for Mn(II) in MeCN, with approximately 10% of the Mn(II) being displaced by an equimolar amount of Fe(II) by 15 h. Complex 3 was the most susceptible of the three Mn(II)-quinol complexes to metal ion displacement, and 80% of its Mn(II) was displaced by an equimolar amount of Fe(II) by 3 h. Both the H₂qp1 and H₄qp2 complexes with Mn(II) reacted readily with Zn(II), with the strong diamagnetic ¹H NMR features of the Zn(II)-H₂qp1 and Zn(II)—H₄qp2 complexes appearing within 2 h. The reactions between 20 mM Zn(ClO₄)₂ and 10 mM 1 in CD₃CN or D₂O, however, failed to dislodge the Mn(II) from the ligand, as assessed by H NMR (FIG. 19). The ¹H NMR spectra of the reactions were featureless aside from solvent peaks even 24 h after the introduction of the Zn(II). When 20 mM H₂O₂ was added to a mixture of 20 mM Zn(ClO₄)₂ and 10 mM 1, the Mn(II) likewise remained in the oxidized forms of the ligand (H₂qp4 and qp4, FIG. 20) as assessed by ¹H NMR.

Complex 1 was much more thermodynamically stable in water than the previously characterized 3, which had a similar coordination sphere around the metal center in aqueous solution. The pMn value measured at pH 7.4 with 1.0 mM concentrations of ligand and Mn(II) was 9.81, which represented over four orders of magnitude of improvement over the 5.36 value measured for 3. The gains in stability could be attributed largely to macrocyclic effects since H₄qp2 and H₄qp4 provide similar coordination spheres: four neutral N-donors in addition to the two quinols/quinolates. Complex 1 was also more stable than 2, which had a pMn of 7.25 under the standard conditions (33).

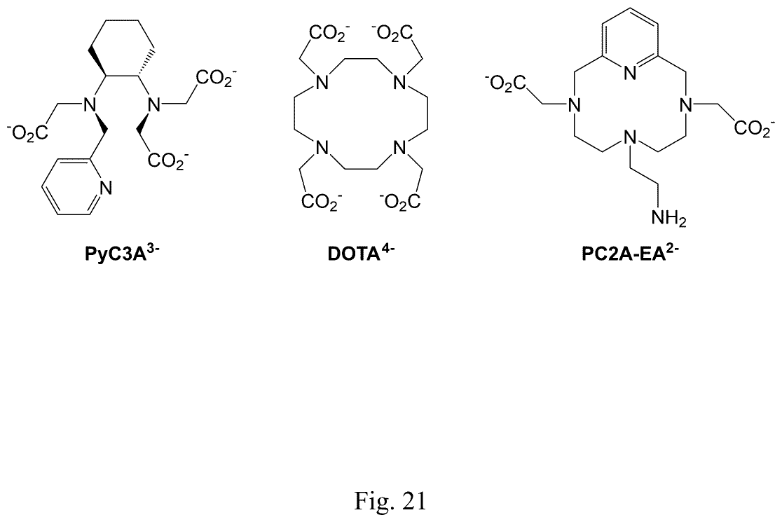

The stability of 1 also exceeded those of most other reported mononuclear Mn(II)-containing MRI contrast agents (Phukan, B. et al., 2018, Inorg. Chem., 57:2631; Gale, E. M. et al., 2016, J. Am. Chem. Soc., 138:15861; Geraldes, C. F. G. C. et al., 1986, Magn. Reson. Med. 3:242). The Gale and Caravan groups have recently reported a series of linear ligands with multiple carboxylate donors that coordinate tightly to Mn(II). One representative example, PyC3A³⁻, formed a Mn(II) complex with a log K_{ML} of 14.14 (FIG. 21). The H₆qc1 ligand (FIG. 4) was inspired by this work, and the triply deprotonated H₃qc1³⁻ formed a Mn(II) complex with a log K_{ML} of 15.59. The log K_{ML} values for the Mn(II) complexes with H₂qp4²⁻ and H₃qp4⁻ both exceeded 18, demonstrating that the macrocycle could stabilize Mn(II) complexes more efficiently than more highly anionic linear ligands. The DOTA⁴⁻ ligand represents a combination of these strategies in that it is comprised of four carboxylates tethered to a cyclen framework (FIG. 21). The log K_{ML} value for its Mn(II) complex (19.89) is higher than the 18.22 value for H₃qp4⁻ but less than the 20.85 value measured for H₂qp4²⁻ (Chavez, S. et al., 1992, Talanta, 39:249). The 19.01 log K_{ML} for the Mn(II) complex with the macrocyclic PC2A-EA²⁻ (FIG. 21) is also similar to that of 1.

The inclusion of the cyclam into the ligand also endowed 1 with a high level of kinetic stability as assessed by metal competition experiments. Once in the macrocycle, the Mn(II) could not be facilely displaced by either Fe(II) or Zn(II), two of the most common transition metal ions in biology. Complexes 2 and 3, conversely, gradually reacted with equimolar amounts of free Fe(II) and quickly reacted with Zn(II). The inertness of 1 towards metal ion exchange compared well to those of other Mn(II)-containing MRI contrast agents with macrocyclic organic components. The kinetic stability extended to Mn(II) complexes with oxidized forms of the H₄qp4 ligand. Oxidation by H₂O₂ yielded a mixture of Mn(II) complexes with the monoquinol/monoquinone and diquinone ligands H₂qp4 and qp4 (FIG. 20). ¹H NMR analysis of the reaction between these oxidized complexes and Zn(II) revealed that the Zn(II) did not noticeably displace the Mn(II). The oxidized forms of complex 3, conversely, exchanged Zn(II) for Mn(II) under these conditions, leading to intense diamagnetic peaks when visualized by NMR.

Like 2 and 3, 1 is a redox-active T₁-weighted MRI contrast agent. Curiously, the pre-oxidation relaxivity of 1 (3.15 mM⁻¹ s⁻¹) was much lower than that of 3 (5.46 mM⁻¹ s⁻), despite the two compounds having similar coordination spheres and acid/base behavior. Both r₁ values are the weighted averages of the relaxivities of the individual Mn(II) species present at pH 7.00: [Mn(H₃qp4)(H₂O)]⁺ and [Mn(H₂qp4)(H₂O)] in the case of 1. The average aquation number measured for 1 was slightly higher than that of 3, but this would be anticipated to raise rather than lower the T₁-weighted relaxivity, r₁. The pKₐ values for the two Mn(II)-bound quinols in 1 and 3 were also similar: 5.82 and 7.14 for 3 versus 5.09 and 7.39 for 1. The higher pKₐ value in each pair would be anticipated to modulate the rate of proton transfer (Aime, S. et al., 2018, Inorg. Chem., 57:5567). The slightly more basic quinolate in 1 could slow the rate of proton transfer between the Mn(II)-quinols and the bulk water enough to substantially reduce its contribution to the measured r₁, but further studies are needed to fully elucidate that possible relationship. The rate constants for water exchange at 298 K differed the most, with the kₑₓ value measured for 3 (4.9×10⁶ s⁻¹) being approximately a third of that of 1 (1.7×10⁷ s⁻¹). Complex 1, unlike 3, appeared to exchange water molecules through a dissociative mechanism, as evidenced by the highly positive entropy of activation (FIG. 17).

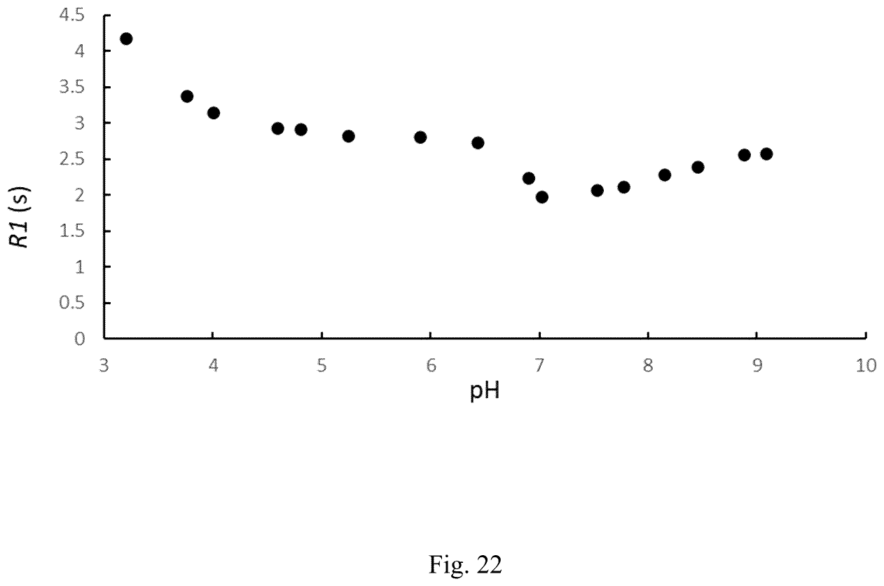

The relaxivity measured for non-oxidized 1, like that of 3, was higher under acidic conditions (FIG. 22). This may be consistent with water molecules displacing the quinol portions of the ligand from the metal. Alternatively, the protonation of the quinolate groups under more acidic conditions may increase the relaxivity by enabling more extensive exchange with the protons from the bulk water. As the pH becomes more basic, the metal-bound quinols deprotonate to anionic quinolates that can outcompete water for coordination sites on the metal center.

Investigation of Reactivity Between 1 and H₂O₂

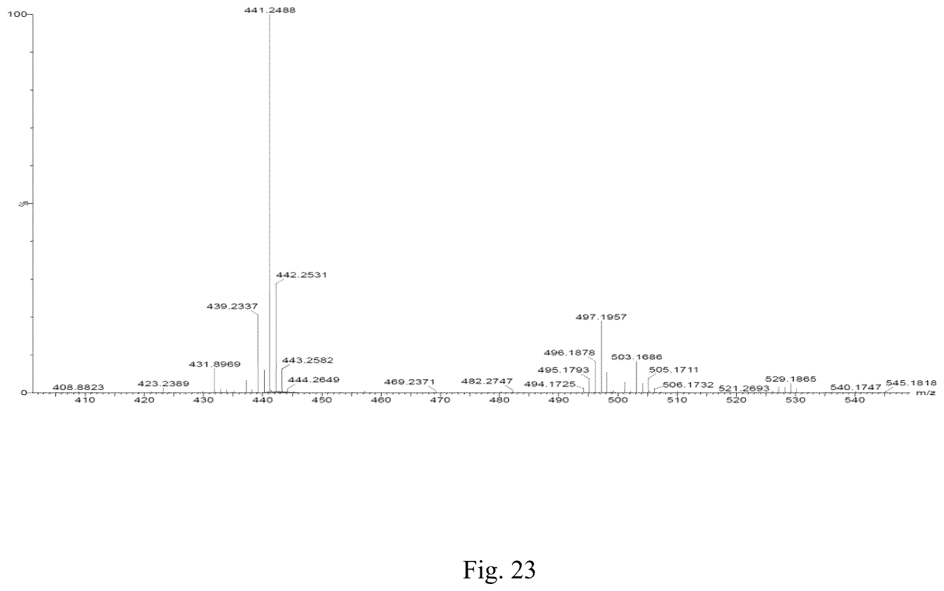

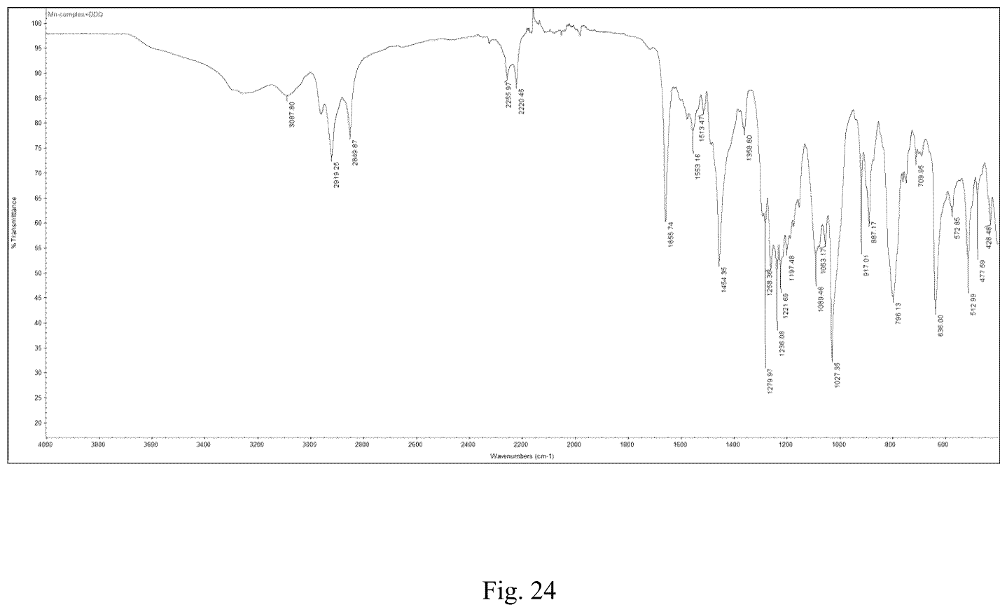

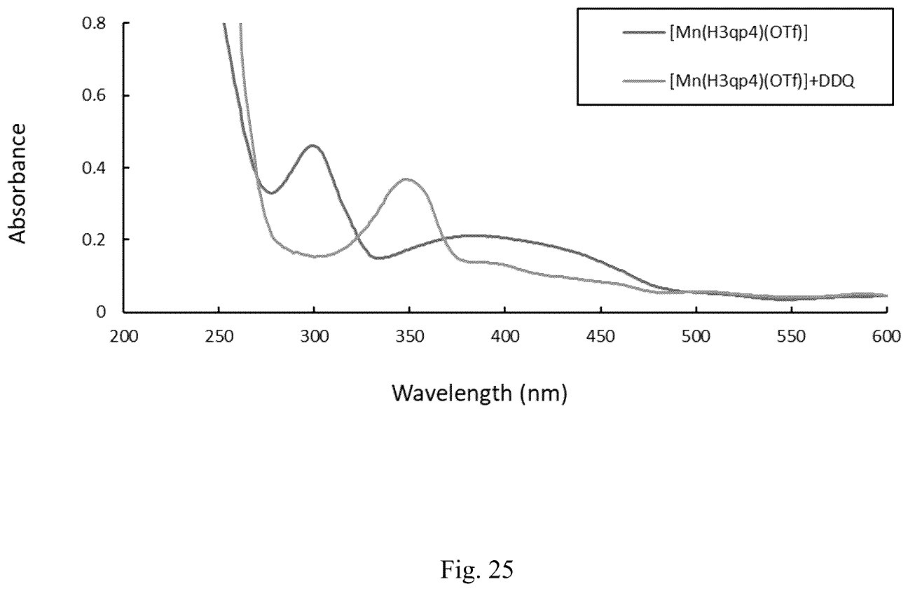

Upon reaction with 2,3-dichloro-5,6-dicyano-1,4-benzoquinone (DDQ), the quinols in 1 appeared to be partially oxidized to para-quinones as assessed by mass spectrometry (MS), ultraviolet-visible spectrometry (UV/Vis), and infrared spectroscopy (IR) (FIG. 20, FIG. 23, FIG. 24, FIG. 25). A new IR feature at 1656 cm⁻ provided strong evidence for the formation of the C═O bonds associated with the para-quinone.

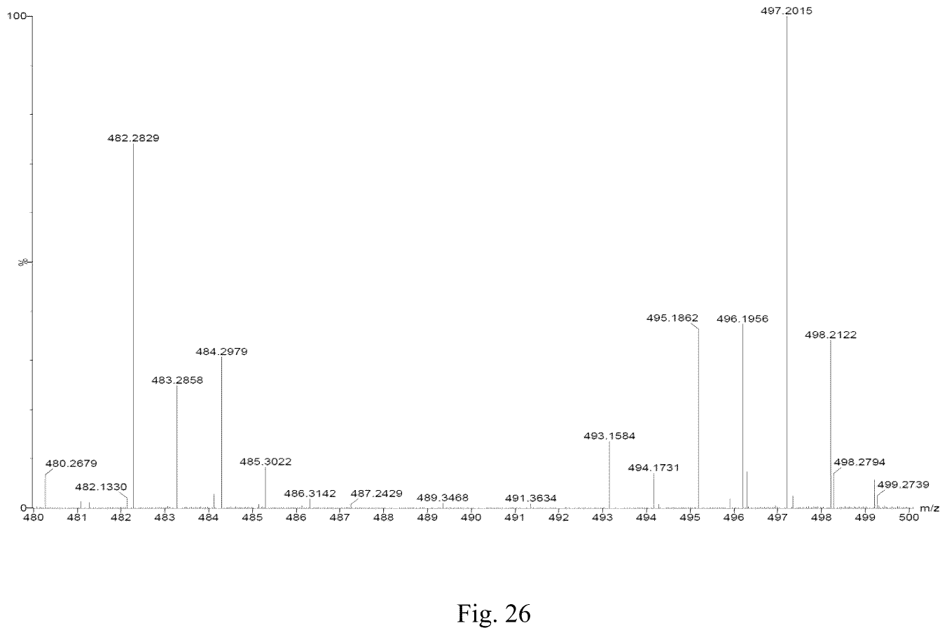

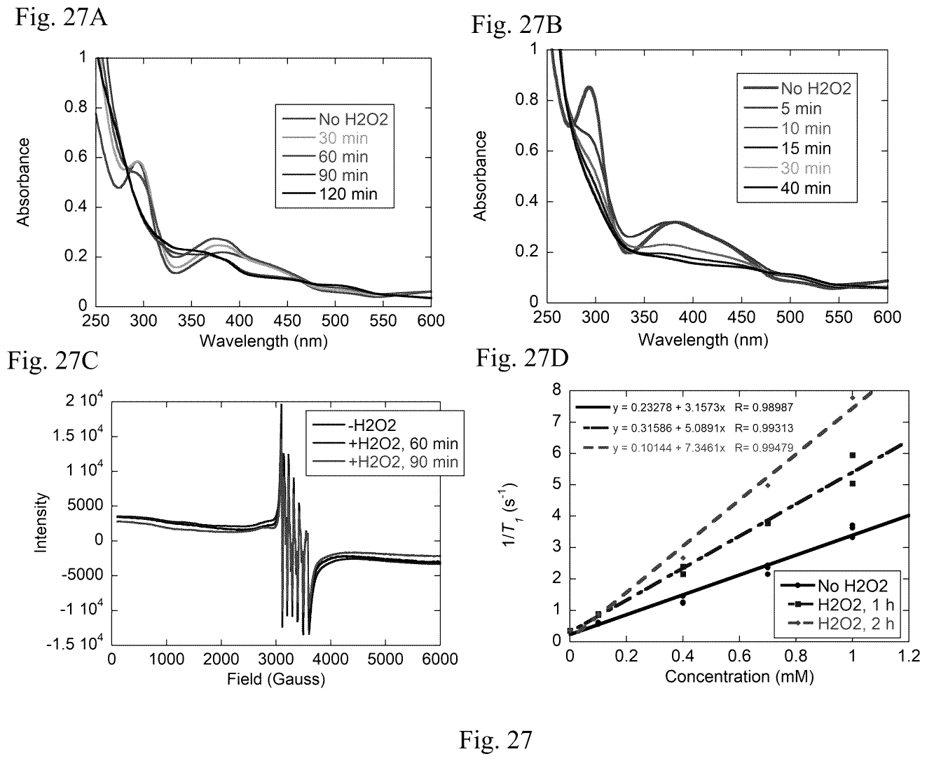

When 1 reacted with a large 10 mM excess of H₂O₂, MS revealed similar m/z features to those seen for the oxidation of the Mn(II) complex by DDQ, suggesting that the quinols were likewise converted to para-quinones by this oxidant (FIG. 26). Further investigation revealed that the speed of the reaction between 1 and excess H₂O₂ was significantly slower than analogous reactions with 2 and 3. Curiously, the changes to the optical spectra during the first 30 min were slight, consistent with an induction period (FIG. 27A). The reaction then accelerated and finished by 90 min. The most noticeable optical changes were the disappearance of the peaks at 293 and 388 nm; features with similar energies have been observed for 2 and 3 and assigned to intraligand transitions for quinol and quinolate moieties. When a smaller amount of H₂O₂ (0.6 mM) was added to 1, the quinol peak decreased immediately with the reaction completing in 20 min, indicating that the induction period only occurred when H₂O₂ was present in a large excess.

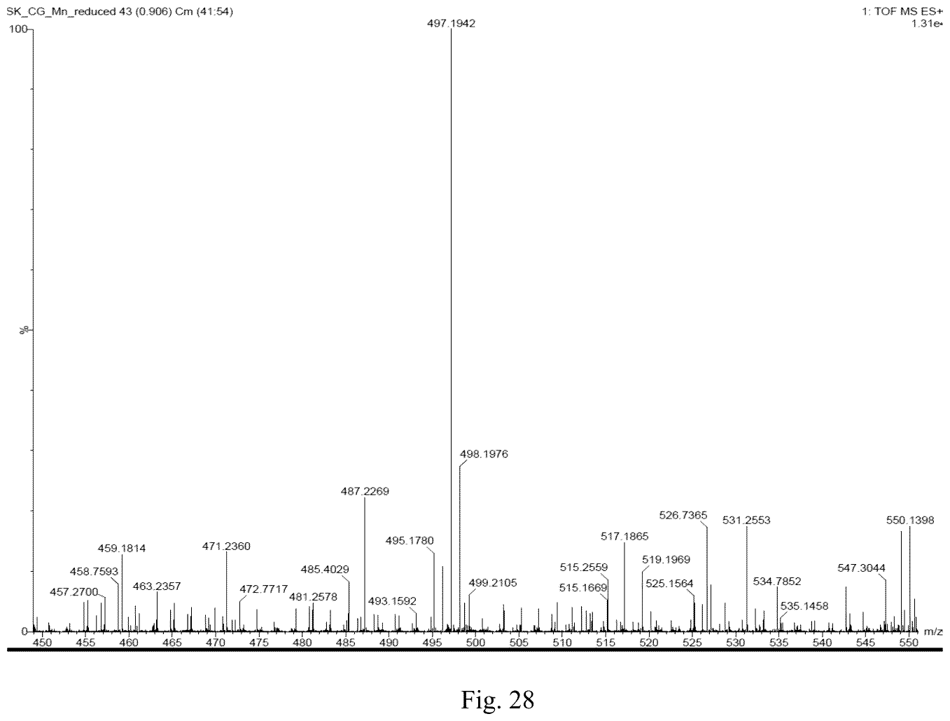

When the reaction between 1.0 mM 1 and 10 mM H₂O₂ in pH 7.0 HEPES buffer was monitored by electron paramagnetic resonance spectroscopy (EPR), the spectrum taken before the oxidant was added looked nearly identical to those taken at 60 min and 90 min, suggesting that the manganese largely remained in the +2 oxidation state throughout the reaction (FIG. 27B). As with prior quinol-containing H₂O₂ sensors, not all of the quinols were oxidized to para-quinones by excess H₂O₂. The Mn(II) existed as a mixture of unreacted 1, [Mn(Hqp4)]⁺, and [Mn(qp4)]²⁺, where Hqp4⁻ and qp4 corresponded to the mono-para-quinone/quinolate and di-para-quinone oxidized forms of the ligand. The oxidation of the quinols was potentially reversible. When 1 was oxidized by H₂O₂ in MeOH, the H₃qp4⁻ complex could be regenerated by subsequently adding sodium dithionite (FIG. 28).

Upon oxidation by H₂O₂, the aquation number of the Mn(II) center in 1 increased by approximately one water molecule, resulting in an average of 2.2 water molecules bound to each metal center (FIG. 16, FIG. 17). The rate of water exchange did not significantly change, with the rate constant being identical within error to that measured before oxidation. The ΔS^{‡} for water exchange remained highly positive after the reaction with H₂O₂, suggesting that this process still occurred through a dissociative pathway.

In addition to the higher stability, the inclusion of the cyclam into the ligand framework had the non-intuitive benefit of improving the relaxivity response to H₂O₂. The 130% increase in r₁ was approximately quadruple the percentile increase observed for 3. Complex 3 rapidly destabilizes as the pH drops below 7.0 due to the protonation of the Mn(II)-quinolates, and it was reasonable to assume that the oxidation of the quinols to para-quinones likewise weakens the binding affinity of the ligand enough to trigger release of the Mn(II). The H₂O₂-enhanced r₁ for 3, however, could not be attributed to the release of the metal. The T₁-weighted relaxivity of [Mn(H₂O)₆]²⁺ was measured independently (5.26 mM⁻¹ s⁻) and found to be approximately equal to that of the pre-activated form of 3 (5.46 mM⁻¹ s⁻). Although one may expect [Mn(H₂O)₆]²⁺ to have a higher r₁ due to its higher aquation number, this was not observed. Proton exchange between water molecules and the Mn(II)-bound quinols/quinolates would be anticipated to markedly increase the r₁ values of 1, 2, and 3 relative to q=1 systems that lack metal-bound hydroxyl groups from their organic ligands. Counter-intuitively, Mn(II) ion release from the oxidized forms of H₄qp2 may actually curtail the response of 3 to H₂O₂.

If 1 were to release free Mn(II) upon oxidation, an increase in r₁ due to the lower starting value would be anticipated, but this mechanism was not consistent with the data. NMR measurements indicated that the oxidation of 1 by H₂O₂ did not release significant amounts of Mn(II). Further, the maximum r₁ exceeds that of [Mn(H₂O)₆]²⁺. Instead, it was believed that the increase in relaxivity results from the formation of more highly aquated Mn(II) species with the oxidized forms of the ligand. Since the H₂O₂ reaction did not make either [Mn(Hqp4)(H₂₀)ₓ]⁺ or [Mn(qp4)(H₂O)ₓ]²⁺ cleanly, the individual r₁ values of these two species could not be measured to ascertain their contributions to the overall relaxivity. Oxidation by H₂O₂ did improve the aquation of the metal center, as evidenced by variable temperature ¹⁷O NMR measurements (FIG. 16, FIG. 17). On average, the metal centers coordinated one additional water molecule after oxidation.

### MRI Properties of 1

The relaxivities of complex 1 before and during its reaction with H₂O₂ were assessed using a 3 T MRI scanner (FIG. 27D). T₁ values were measured for aqueous solutions containing 0-1.0 mM 1 and 50 mM HEPES buffered to pH 7.00. For each concentration of 1, an oxidized sample was also prepared by adding 10 mM H₂O₂; the large excess of oxidant was used to ensure as full a turn-on as possible at the timepoints and to facilitate comparisons to manganese-containing MRI contrast agents that were previously prepared and characterized. The T₁ values for the H₂O₂-containing solutions were measured 1 h and 2 h after the reagents were initially mixed. Full series of data were collected for two independently prepared batches of 1 in order to confirm that the results were replicable.

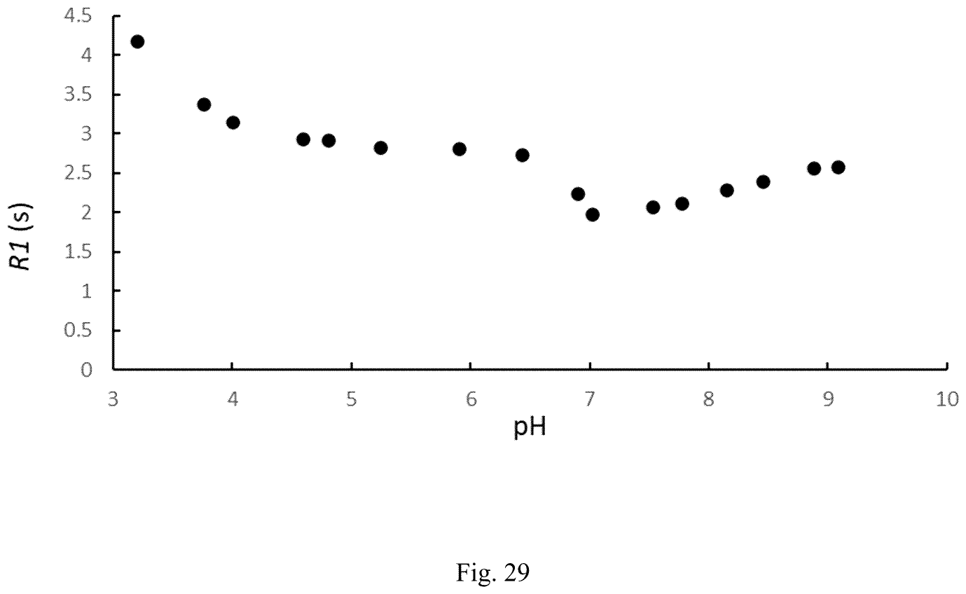

Relaxivities (r₁) were obtained from the slopes of plots of 1/T₁ versus manganese concentration. Prior to oxidation by excess H₂O₂, the r₁ was 3.16 mM⁻¹ s⁻. The data taken for samples kept under air for 1 h and 2 h overlaid well, suggesting that the short-term reactivity with air was slight. After oxidation by H₂O₂, the relaxivity rose, reaching 5.09 mM⁻¹ s⁻ by 1 h and peaking at 7.35 mM⁻¹ s⁻¹ as assessed by measurements taken at 2 h (FIG. 27C). The pH-dependence of the relaxivity was investigated from pH 3 to pH 9 (FIG. 29). R₁ values were measured for a 0.50 mM sample of 1. The R₁ was highest at pH 3 and was lowest at pH 7. As the pH increased, the R₁ dropped from pH 3 to pH 4, remained approximately constant from pH 4 to pH 6.5, decreased from pH 6.5 to pH 7, then rose slightly from pH 7 to pH 9.

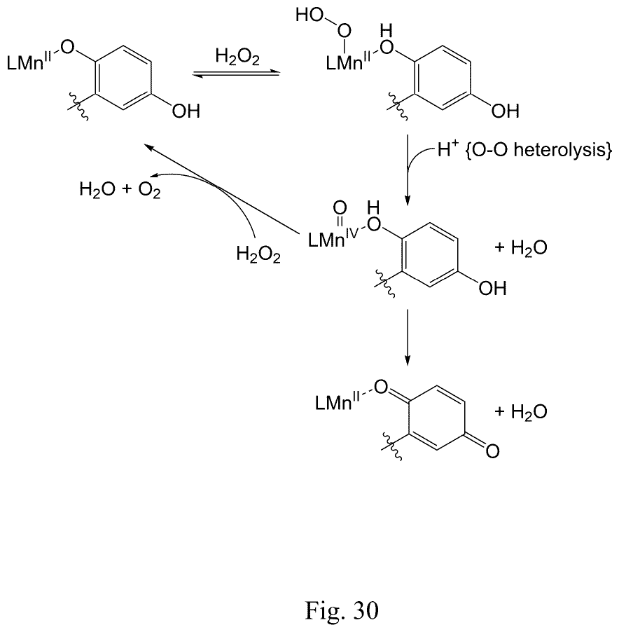

Complex 1 differed substantially from 2 and 3 in that its response to H₂O₂ depends on the manner in which the oxidant is administered. When a large excess of H₂O₂ was added to 1 in a single portion, the oxidation of the quinols occurs after an induction period. The oxidation by 10 mM of H₂O₂ took approximately 90 min to complete, as assessed by changes to both the relaxivity and the UV/vis spectrum. When a smaller portion of H₂O₂ is added, the quinols are oxidized more quickly and without a noticeable induction period. Based on these observations, it was proposed that the initial reaction between H₂O₂ and 1 generated an oxidant that can react either unimolecularly to oxidize one of the quinols to a para-quinone or bimolecularly with another equiv. of H₂O₂ to yield 02 and regenerate 1 (FIG. 30). In high concentrations of H₂O₂, the second pathway dominates, and the manganese complex primarily acted as a catalase mimic. Complexes 2 and 3, conversely, quickly reacted with excess H₂O₂ to yield Mn(II) para-quinone complexes, and these reactions did not feature induction periods. It was speculated that efficient oxidation of quinols to para-quinones may require that the quinols be cis to the H₂O₂-derived ligand in a transient higher-valent intermediate, which are depicted as a Mn(IV)-oxo complex (FIG. 30). If the macrocycle coordinates the manganese in a square planar fashion as it does to the Mn(III) in 4 (FIG. 2B), an incoming H₂O₂ likely displaced a quinol/quinolate, forcing the H₂O₂-derived ligand to be trans to the remaining metal-bound quinol/quinolate. This would hinder intramolecular oxidation and enable bimolecular reactions with additional equiv. of H₂O₂ to proceed. A similar hindrance of intramolecular quinol oxidation may also explain the reaction between 1 and O₂. The product of this reaction was [Mn^{III}(H₂qp4)](OTf) (4, FIG. 2B) rather than a Mn(II) complex with a para-quinone containing ligand; the latter of which might be anticipated to be more thermodynamically stable based on the electrochemistry (FIG. 15).

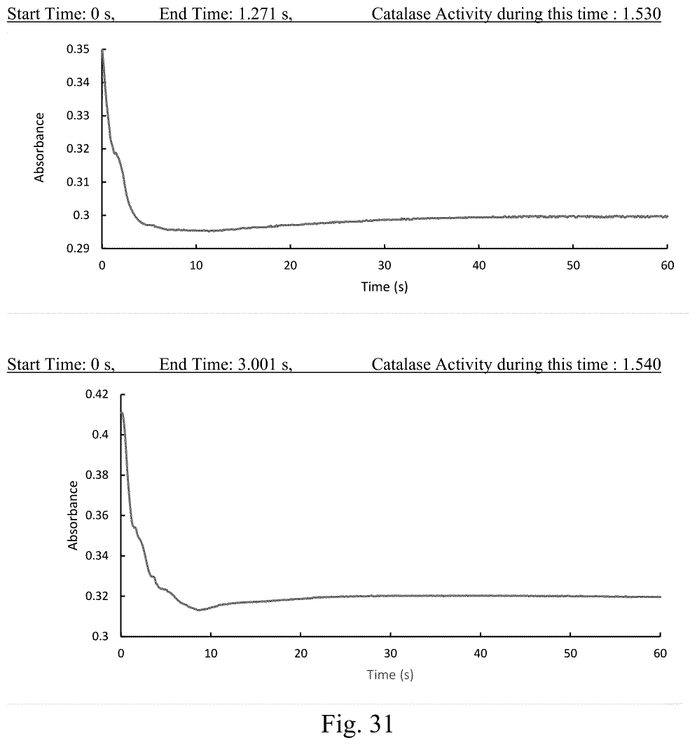

Preliminary data suggested that 1 can indeed catalyze the degradation of H₂O₂. When reactions between 100 nM 1 and 10 mM H₂O₂ were followed spectrophotometrically, the absorbance of the H₂O₂ peak at 240 nm decreased quickly (FIG. 31). From these data, the initial rate, vₒ/[1]T, was estimated to be 6.6 (±2.3)×10³ s⁻¹.

Biological environments generally provide low but rapidly replenishing concentrations of H₂O₂ that are closer to 0.6 mM than 10 mM (Kinnula, V. L. et al., 1991, Am. J. Physiol., 261:L84; Lyublinskaya, O. et al., 2019, Redox Biol., 24:101200; Sies, H. 2014, J. Biol. Chem., 289:8735). It was therefore anticipated that 1 would provide a fast r₁ response to physiologically generated H₂O₂ (FIG. 4B). Even with this in mind, it was uncertain whether the sensor would respond quickly enough to oxidant to activate before circulating out of an area with elevated levels of H₂O₂. Other challenges exist in translating probes such as 1 to the clinic. The non-ratiometric response of 1, for instance, makes it difficult to distinguish regions under oxidative stress from sites that merely accumulate more of the pre-activated sensor. Although 2 and 3 seem to be reasonably tolerated by cells, the potential toxicity of 1 also needs to be considered and assessed.

A Mn(II) complex with a cyclam macrocycle derivatized with two quinols is a highly water-stable MRI contrast agent that displays a positive r₁ response to H₂O₂, one of the most prevalent reactive oxygen species in biology. The percentile relaxivity response was approximately four times that of a Mn(II) complex with a linear ligand that provided a similar set of donor atoms: two quinols/quinolates and four neutral N-donors. In addition to boosting the thermodynamic stability, the macrocycle also provided a kinetic barrier for metal ion dissociation, and the Mn(II) complex appeared to retain the metal after the oxidation of the quinols to more poorly metal-binding para-quinones. The greater stability of the current complex addresses a key concern about other quinol-containing MRI contrast agent sensors that were previously prepared and should smooth the pathway towards using such complexes to monitor biologically relevant oxidative stress.

The reactivity with H₂O₂ appeared to proceed through two competing pathways. With low H₂O₂ levels, intramolecular oxidation of the quinols to para-quinones occurs. This process appeared to be slow relative to analogous reactions seen with manganese complexes with linear quinol-containing ligands. With high—and physiologically unrealistic—H₂O₂ concentrations, catalase activity was observed. Under such conditions, the quinol oxidation and the concomitant increase in r₁ only occurred after much of the H₂O₂ has been consumed.

### Example 2: A Highly Water- and Air-Stable Iron-Containing MRI Contrast Agent Sensor for H₂O₂

The previously prepared probes exhibit changes to their T₁-weighted relaxivity (r₁) upon oxidation by H₂O₂. The r₁ of a ¹H-based contrast agent is influenced by the nature and extent of its interactions with bulk water molecules and the electronic properties of the metal ion component. With respect to the interactions with water molecules, groups that can exchange protons with bulk water and sites for the direct coordination of water to the metal ion both improve the relaxivity. The number of water coordination sites on the metal is commonly referred to as the aquation number (q). The electronic structure of the metal ion is connected to two important parameters: the paramagnetism and the electron spin relaxation time. Highly paramagnetic metal ions with slow electron spin relaxation times, such as high-spin Mn(II) and Gd(III), enable high r₁ values. Conversely, metal ions with fast electron spin relaxation times, such as Fe(II), are associated with low r₁ values and near negligible impact on MRI contrast even when they are highly paramagnetic.

Most of the prior sensors were air-stable Mn(II) complexes with polydentate quinol-containing ligands (Karbalaei, S. et al., 2021, Inorg. Chem., 60:8368; Yu, M. et al., 2014, J. Am. Chem. Soc., 136:12836; Yu, M. et al., 2017, Inorg. Chem., 56:2812). Upon reacting with H₂O₂, the quinols oxidize to para-quinones. Water molecules displace the para-quinone portions of the ligand, and the higher aquation thereby both increases the r₁ of the complex and improves MRI contrast. Although the manganese may be transiently oxidized, it mostly reverted back to the +2 oxidation state. The Mn(II) complexes could be modified to be exceptionally water-stable and could respond to H₂O₂ with a 130% increase in r₁, but the high background relaxivities of the pre-activated sensors complicated analysis of biological redox environments. Enhanced contrast in a region could have resulted from a combination of two factors: oxidation of the sensor to its more emissive form and the mere accumulation of the sensor in its pre-activated and/or oxidized forms in the area of interest.

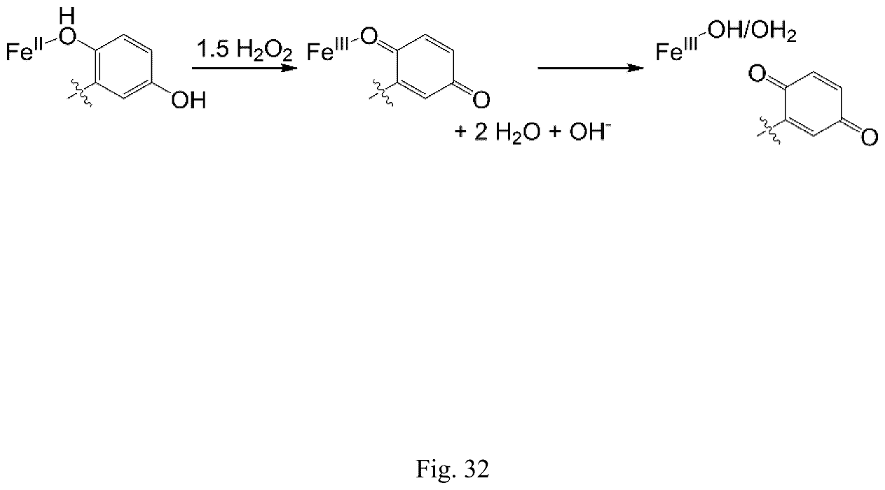

In order to decrease the background signal provided by the pre-activated form of the sensor, the Mn(II) in the most successful sensor, [Mn(H₃qp4)](OTf), was replaced with Fe(II). Relative to Mn(II), Fe(II) complexes had a much lesser impact on the T₁ of water molecule ¹H nuclei due to their much faster electron spin relaxation (Wang, H. et al., 2019, J. Am. Chem. Soc., 141:5916). Fe(II) also differed from Mn(II) in that it could be oxidized to the +3 oxidation state much more facilely (Cotton, F. A. 1988, Advanced Inorganic Chemistry, 5 ed., John Wiley & Sons). When the metal centers are high-spin, the resultant Fe(III) complexes are more paramagnetic and exhibit slower electron spin relaxation; as such, they can interact with water molecules to substantially improve T₁-weighted MRI contrast (Hoener, B.-A. et al., 1991, J. Magn. Reson., 1:357; Schwert, D. D. et al., 2002, Top. Curr. Chem., 221:165). Gale and Caravan recently designed a redox-responsive MRI contrast agent that relied on the oxidation of Fe(II) to Fe(III) to detect biologically relevant oxidants. Although the percentile increase in r₁ was large and the pre-activated ferrous complex had little impact on the MR image, the activated form of the sensor had a relatively small r₁. The r₁ of the presently described iron-containing sensor, conversely, could potentially be enhanced by both ligand and metal oxidation (FIG. 32).

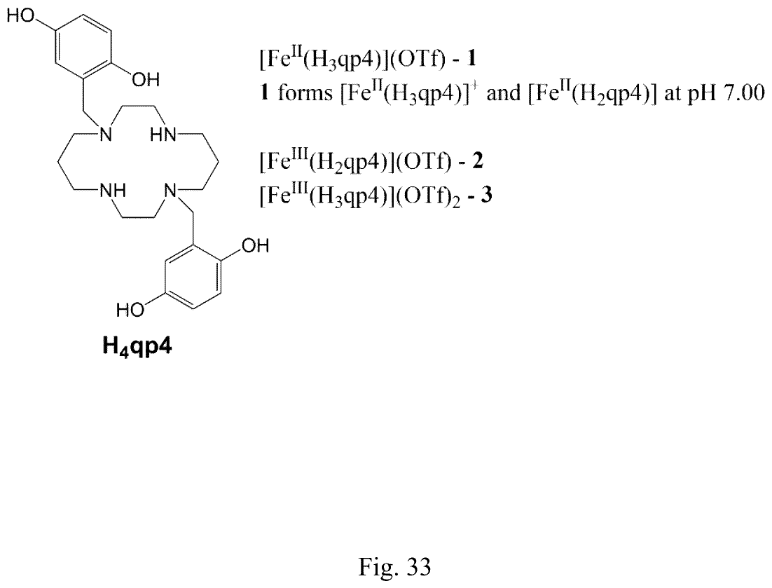

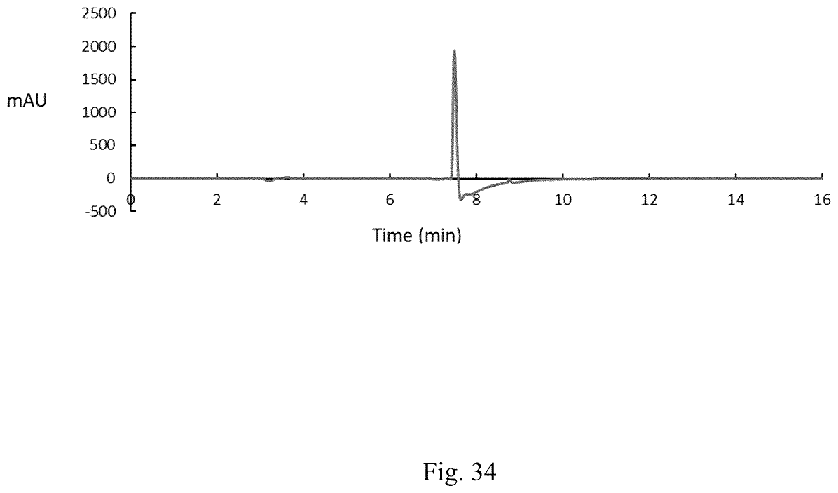

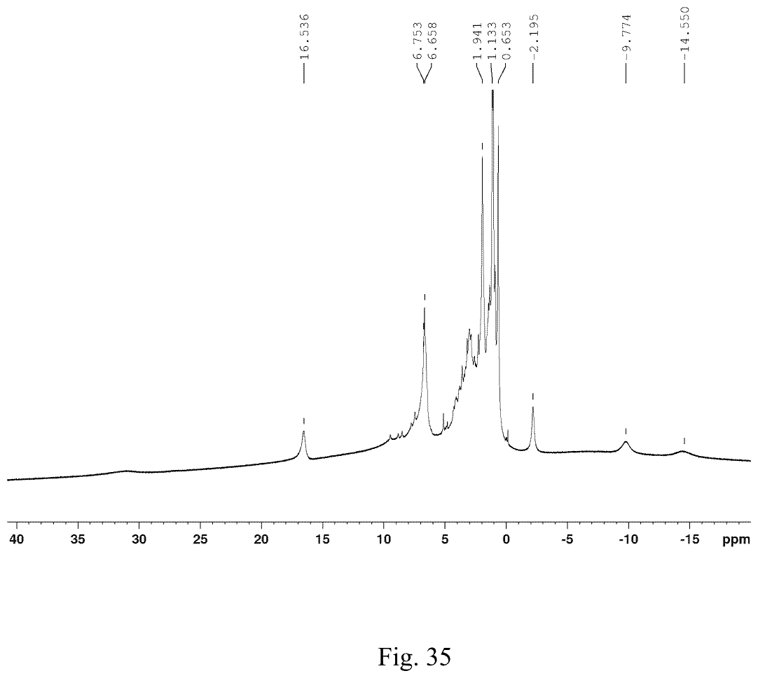

### Synthesis and Characterization of (1-(2,5-dihydroxybenzyl)-8-(2,5-dihydroxybenzylalkoxide)-1,4,8,11-tetraazacyclotetradecane)iron(II) triflate ([Fe(H₃qp4)](OTf), 1)

[Fe^{II}(H₃qp4)](OTf) (1) was prepared by mixing the H₄qp4 ligand (FIG. 33) with an equimolar amount of Fe(OTf)₂ in MeCN. Adding CH₂Cl₂ deposited the product as a blue powder in high purity and yield (83%). An analogous reaction was used to prepare [Mn^{II}(H₃qp4)](OTf), which likewise was obtained in a sub-quantitative yield. The free ligand had a strong affinity for protons, and it was believed that residual H₄qp4 ligand deprotonates the metal-bound ligand to H₃qp4⁻ in both of these reactions. Although 1 was not structurally characterized, its composition was confirmed by mass spectrometry and elemental analysis. The purity was further corroborated by high-performance liquid chromatography (HPLC) (FIG. 34). Solid-state magnetic susceptibility measurements (μ_{eff}=4.8±0.1μ_{B}), solution-state magnetic susceptibility measurements (μ_{eff}=4.7±0.3μ_{B}), NMR data (FIG. 35), and the absence of an EPR signal indicated that the metal center was unambiguously high-spin Fe(II).

H₄qp4 (500 mg, 1.12 mmol) and Fe(OTf)₂ (400 mg, 1.13 mmol) were dissolved in mL of dry MeCN under N2. The mixture was stirred at 60° C. for 48 h. The slow addition of CH₂Cl₂ deposited the product as a dark blue powder, which was collected via filtration (628 mg, 83% yield). MS (ESI): calcd for [Fe(H₂qp4)]⁺, 498.1929; found, 498.1888. Solid-state magnetic susceptibility (294 K): μ_{eff}=4.8μ_{B}. Solution-state magnetic susceptibility (CD₃CN, 298 K): μ_{eff}=4.7μ_{B}. Optical spectroscopy (MeCN, 294 K): 299 nm (ε=10800 M⁻¹ cm⁻¹), 595 nm (ε=2200 M⁻¹ cm⁻¹). IR (KBr, cm⁻¹): 3378 (s), 3229 (s), 3070 (m), 2855 (w), 2323 (w), 1612 (w), 1512 (w), 1485 (s), 1469 (w), 1449 (m), 1364 (w), 1219 (s), 1151 (s), 1115 (w), 1079 (w), 1024 (s), 992 (w), 916 (w), 869 (m), 814 (s), 792 (w), 762 (m), 633 (s), 600 (w), 542 (w), 514 (m), 478 (w), 421 (w). ¹H NMR (500 MHz, CD₃CN, 298 K): S 16.54, 6.75, 6.65, 5.0-2.0 (m), 1.13, 0.65, −2.20, −9.77, −14.55. Elemental analysis (powder) calcd for C₂₅H₃₅N₄O₇F₃S₁Fe·1.5H₂O·1CH₂Cl₂: C, 42.70%; H, 5.30%; N, 7.38%. Found: C, 42.82%; H, 4.83%; N, 7.88%. HPLC (method 1): t_{R}=7.50 (min).

### Synthesis of (1-(2,5-dihydroxybenzyl)-8-(2,5-dihydroxybenzylalkoxide)-1,4,8,11-tetraazacyclotetradecane)iron(III) triflate ([Fe(H₃qp4)](OTf)₂, 3)

H₄qp4 (500 mg, 1.12 mmol) and Fe(OTf)₃ (637 mg, 1.13 mmol) were dissolved in 5 mL of dry MeCN under N2. The mixture stirred at 60° C. for 48 h. Upon the slow addition of ether to the MeCN solution, the product deposited as a dark brown powder that could be isolated by filtration (780 mg, 83% yield). MS (ESI): calcd for [Fe(H₂qp4)]⁺, m/z 498.1929; found, m/z 498.1921. Solid-state magnetic susceptibility (294 K): μ_{eff}=5.7μ_{B}. Optical spectroscopy (MeCN, 294 K): 299 nm (ε=7900 M⁻¹ cm⁻¹). IR (KBr, cm⁻¹): 3458 (s), 3302 (s), 3182 (s), 3098 (w), 2957 (w), 2890 (w), 2825 (m), 1655 (w), 1549 (w), 1520 (m), 1479 (w), 1448 (s), 1390 (w), 1342 (w), 1280 (w), 1247 (w), 1223 (w), 1192 (w), 1156 (s), 1131 (w), 1091 (m), 1052 (w), 1025 (s), 992 (w), 934 (w), 920 (w), 892 (w), 868 (w), 823 (m), 755 (m), 636 (m), 583 (w), 511 (w), 470 (w). Elemental analysis (powder) calcd for C₂₆H₃SN₄O₁₀F₆S₂Fe·0.5 (C2H₅)₂O (powder): C, 40.29%; H, 4.83%; N, 6.71%. Found: C, 40.16%; H, 4.91%; N, 7.05%. HPLC (method 1): t_{R}=8.02 (min).

### Investigation of the Stability and Speciation of 1 in Water

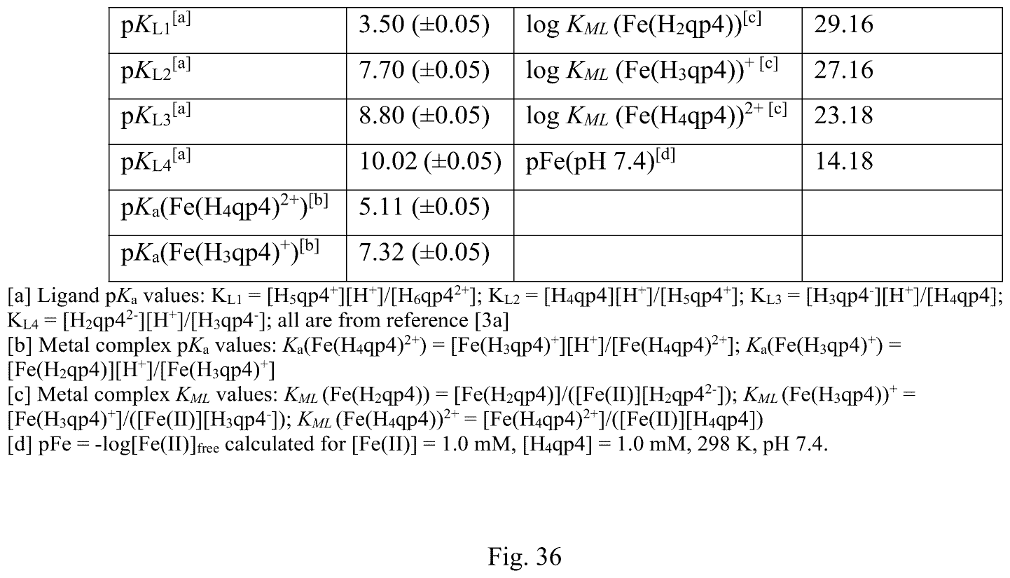

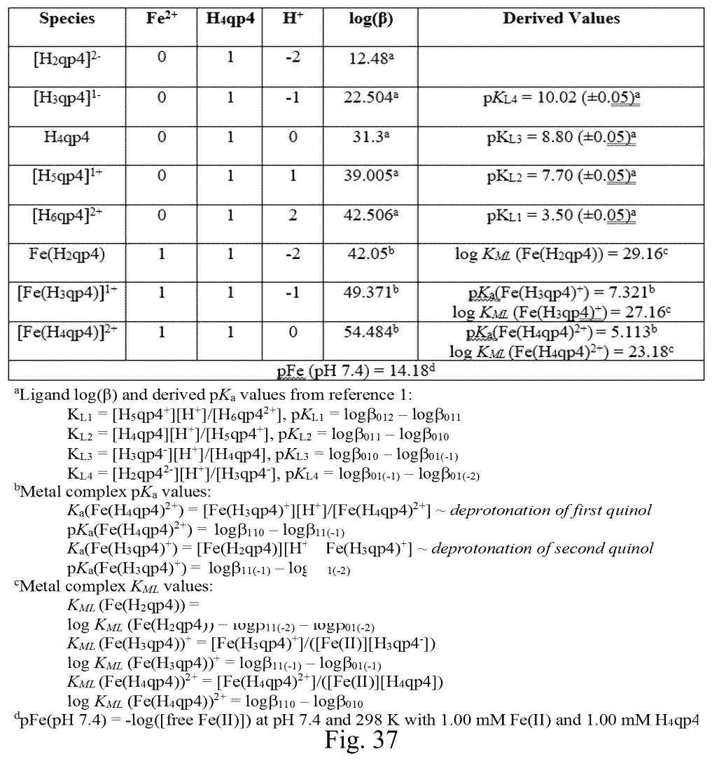

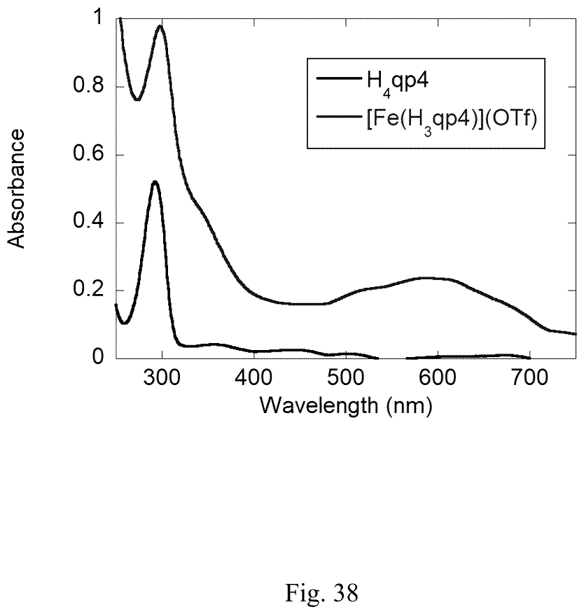

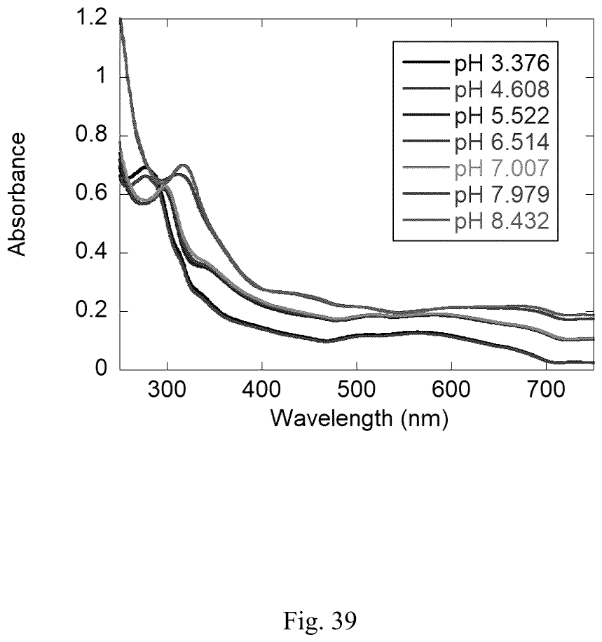

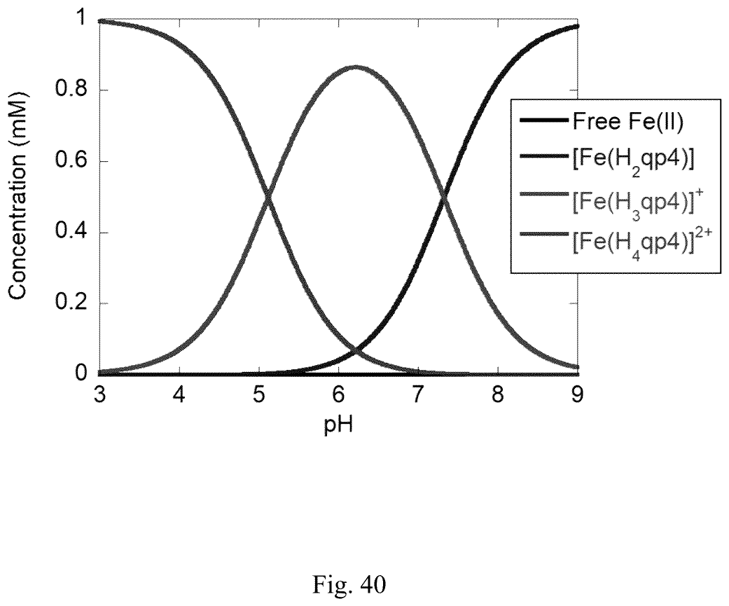

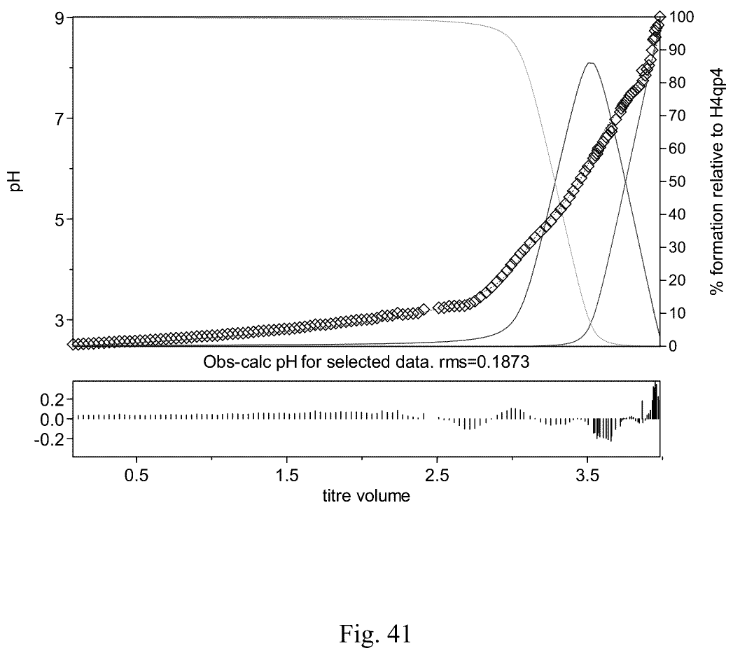

Complex 1, like its Mn(II) analog, was found to be exceptionally stable in water (FIG. 36, FIG. 37). The aqueous behavior of 1 was studied between pH 2.5 and 9.0 and compared to that of the free H₄qp4 ligand. As the pH increased, two ionization events were observed, corresponding to pKₐ values of 5.11 and 7.32; these were nearly identical to those observed for [Mn^{II}(H₃qp4)](OTf). The ionization events for the free ligand centered at pH 3.50 and pH 7.70, conversely, were not observed, suggesting that the sample contained negligible amounts of free ligand. At pH 7.0, the UV/vis spectra of 1 and H₄qp4 differed markedly (FIG. 38), with the former having a relatively intense band at 589 nm; this provided further support that the isolated 1 was an intact Fe(II) complex rather than a 1:1 mixture of Fe(OTf)₂ and unbound ligand. The 589 nm feature likely resulted from a charge transfer process with the Fe(II); the most intense band for [Mn^{II}(H₃qp4)](OTf) was at 388 nm and likely corresponded to an intraligand transition. The two pKₐ values for 1 were consistent with the deprotonation of phenols ligated to M(II) ions (Gale, E. M. et al., 2014, Inorg. Chem., 53:10748; Sahoo, S. C. et al., 2010, Inorg. Chim. Acta, 363:3055), corroborating the oxidation state assignment from the magnetic susceptibility data. The UV/vis spectrum changed as the pH rose from 4.0 to 9.0; such shifts would be anticipated from the sequential deprotonation of the quinols (FIG. 39). Complex 1 therefore existed as a mixture of [Fe^{II}(H₃qp4)]⁺ and [Fe^{II}(H₂qp4)] between pH 7.0 and 7.4, where H₃qp4⁻ and H₂qp4²⁻ are the singly and doubly deprotonated forms of the H₄qp4 ligand (FIG. 33, FIG. 40).

The titration data were consistent with negligible metal ion dissociation from 1, even under highly acidic conditions (FIG. 40, FIG. 41). The log K_{ML} values for [Fe^{II}(H₃qp4)]⁺ and [Fe^{II}(H₂qp4)] were 27.16 and 29.16, respectively, with the Fe(II) complex with the dianionic H₂qp4²⁻ being more stable (FIG. 36). As anticipated from the Irving-Williams series (Irving, H. 1953, J. Chem. Soc., 3192), both forms of the Fe(II) complex were more water-stable than their Mn(II) counterparts, which have log K_{ML} values of 18.22 and 20.85. The magnitude of the enhanced stability, however, was surprising in that the K_{ML} values normally increase by 2-3 orders of magnitude for most ligands (Martell, A. E., 1974, Critical Stability Constants, Plenum Press). Transition metals with macrocyclic ligands, however, do not seem to follow Irving-Williams patterns as strictly, as assessed by the relative stabilities of Ni(II), Zn(II), and Cd(II) complexes with a variety of macrocycles (Antunes, P. et al., 2003, Dalton Trans., 1852; Davies, P. J. et al., 1996, Inorg. Chim. Acta, 246:1).

### Investigation of the Redox Stability of 1

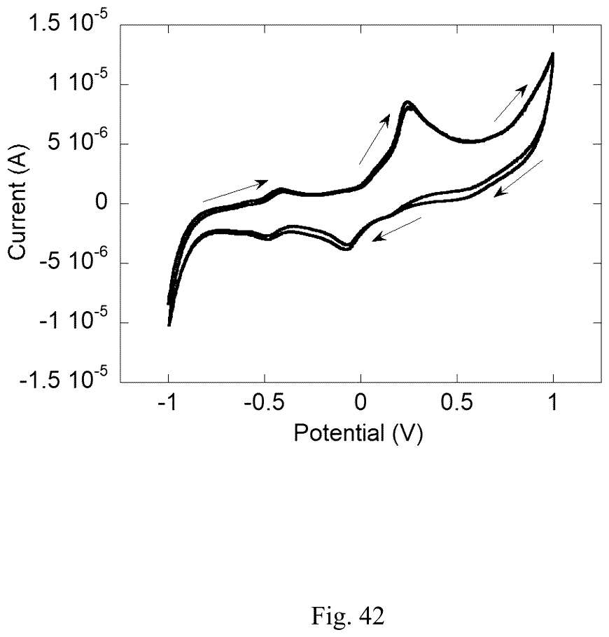

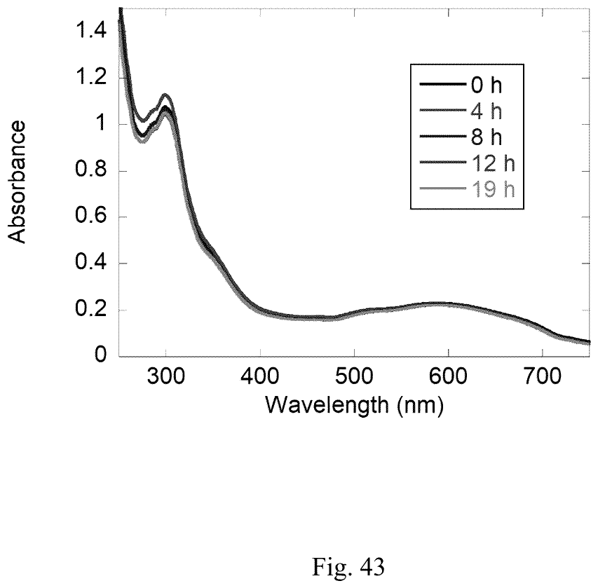

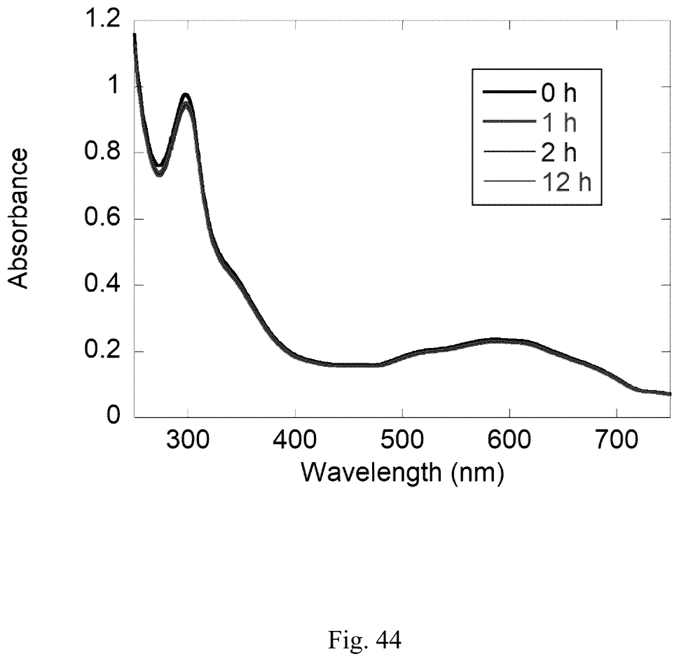

Cyclic voltammetry (CV) analysis of 1 in an aqueous solution containing 0.10 M phosphate buffered to pH 7.2 revealed two redox events (FIG. 42). An irreversible feature centered at 90 mV vs. Ag/AgCl (ΔE=300 mV) was assigned to the oxidation and reduction of the quinols within the ligand since a feature with a nearly identical E_{1/2} was observed for the Mn(II) analog. A much more reversible redox event at −450 mV vs. Ag/AgCl (ΔE=60 mV) was also observed. It was proposed that this corresponded to the Fe(III/II) redox couple. Although the CV data confirmed the prediction that the Fe(II) in 1 was more susceptible to oxidation than the Mn(II) in [Mn^{II}(H₃qp4)]⁺, 1 was not readily oxidized by air. Solutions of 1 in MeCN and HEPES-buffered water (pH 7.00) did not noticeably react with 02 over 12 h as assessed by UV/vis; the intensities of the peaks changed by less than 5% (FIG. 43, FIG. 44).

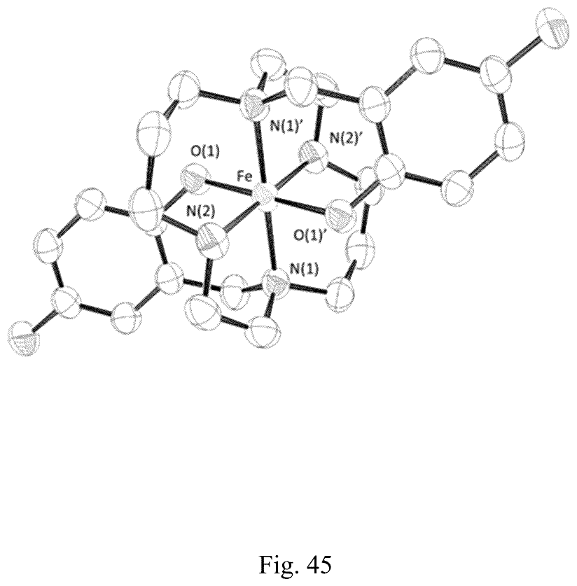

As with the Mn(II) analog, prolonged (>1 week) exposure to air did eventually oxidize the metal, but not the ligand, in 1 to yield [Fe^{III}(H₂qp4)](OTf) (2, FIG. 45). The reaction with air therefore appeared to be thermodynamically favorable but slow. The ferric product was crystallized from MeCN/ether mixtures. In 2, the cation features a hexacoordinate metal center bound to the full set of N404 donor atoms from the H₂qp4²⁻ ligand. The ligand was bound in a trans-III conformation (Liang, X. et al., 2003, Chem. Eur., 9:4709), with the N-donors from the macrocycle coordinating to the Fe(III) in a square planar fashion and the quinolates binding trans to each other. The structural data confirmed that the ligand was not oxidized by 02. The 1.89 Å Fe—O bonds were consistent with Fe(III)—O bonds to alkoxide ligands (Goldsmith, C. R. et al., 2002, J. Am. Chem. Soc., 124:83). The C—O bond lengths of 1.35 Å (Fe-bound) and 1.38 Å (para to the Fe-bound 0) were longer than those found in crystallographically characterized para-quinones (Chan, T.-L., 1983, J. Chem. Soc., Perkin Trans. 2, 777). With respect to the oxidation states of the metal ion and ligand and the conformation of the cyclam portion, 2 resembled [Mn^{III}(H₂qp4)](OTf), which resulted from exposing [Mn^{II}(H₃qp4)](OTf) to air for over a week.

Investigation of Reactivity of 1 with H₂O₂

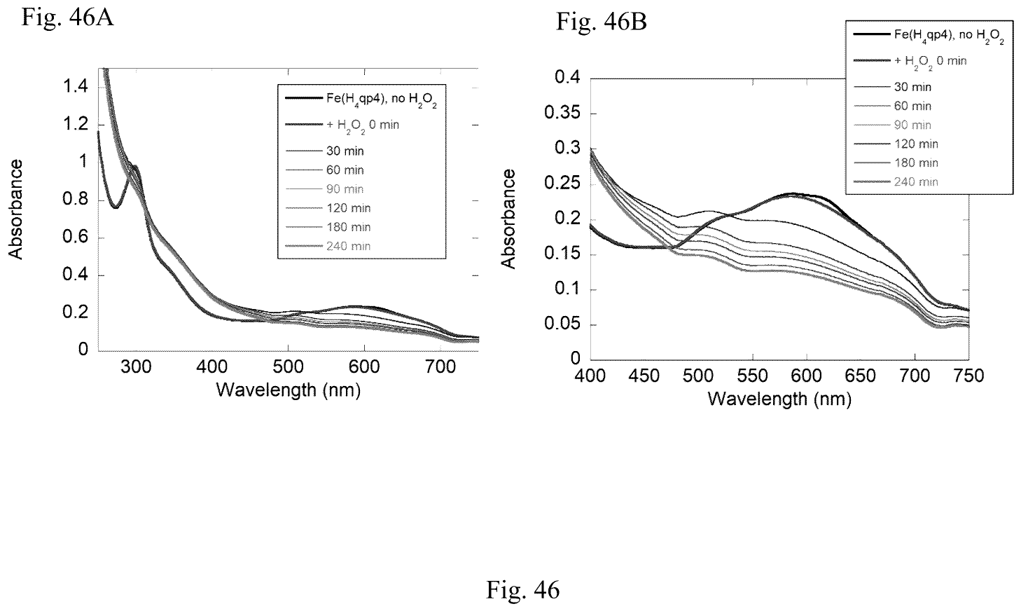

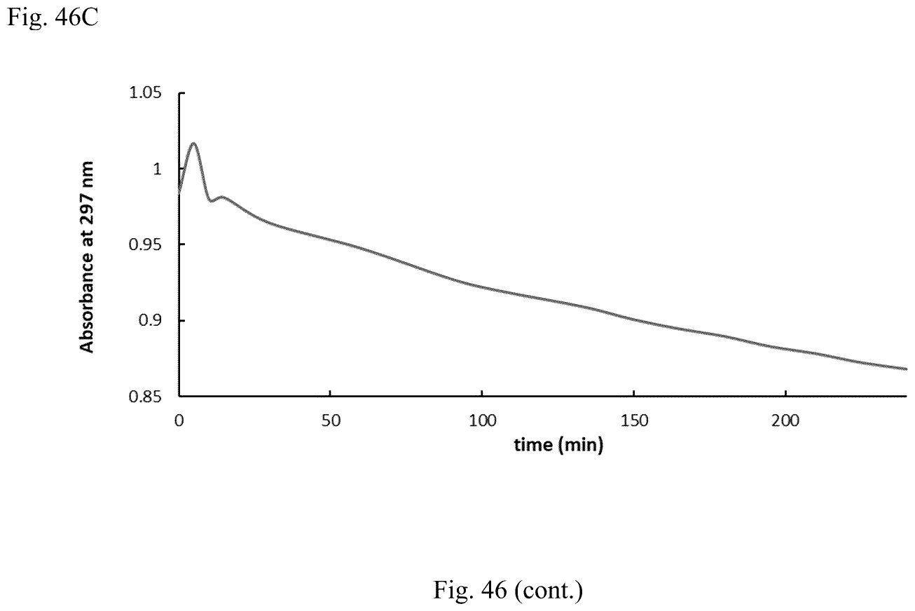

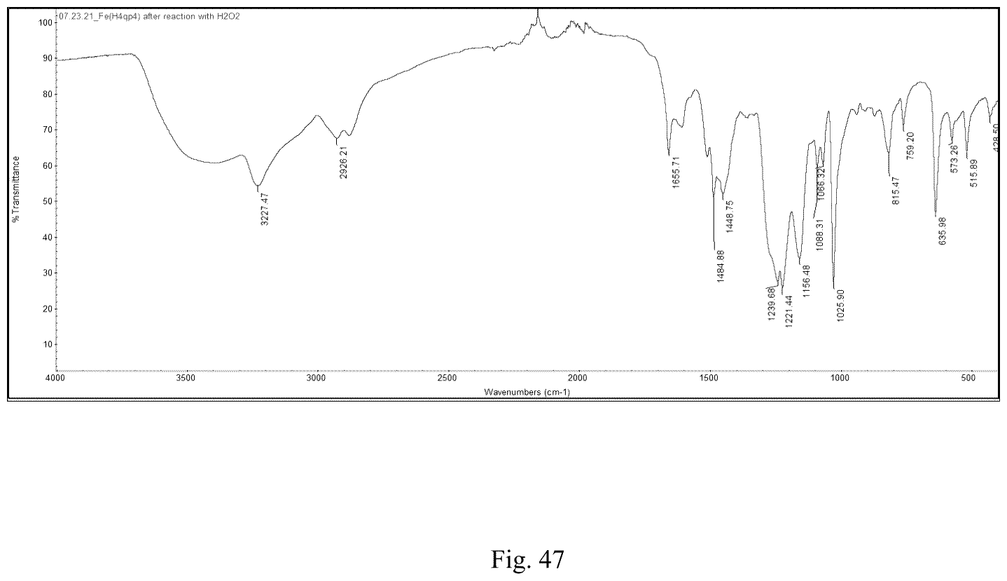

Complex 1 reacted with H₂O₂ to yield Fe(III) species with oxidized ligands. Evidence for the oxidation of the quinols in the ligand to para-quinones was provided by UV/vis and IR (FIG. 46, FIG. 47). The loss of the feature at UV/vis 299 nm was consistent with the oxidation of quinols. With previous quinol-containing ligands, the quinols did not get fully converted to the para-quinone upon oxidation by H₂O₂, and it was likely that the H₄qp4 ligand in the oxidized products was a mixture of unreacted ligand, H₂qp4 (quinol/para-quinone) and qp4 (di-para-quinone), as was found for the Mn(II) analog. Individual oxidation products were not isolated, and the presence of residual H₂O₂ precluded analysis of the oxidized reaction mixtures by HPLC due to the risk of damage to the instrument. With prior ligands, the extent of ligand oxidation were quantitatively assessed by exchanging Zn(II) for the Mn(II) after the addition of H₂O₂; this yielded diamagnetic Zn(II) compounds with the ligands that could be studied by ¹H NMR. With the H₄qp4 ligand and its oxidized products, Zn(II)-for-Fe(III) exchange did not readily occur, precluding this sort of analysis (vida infra).

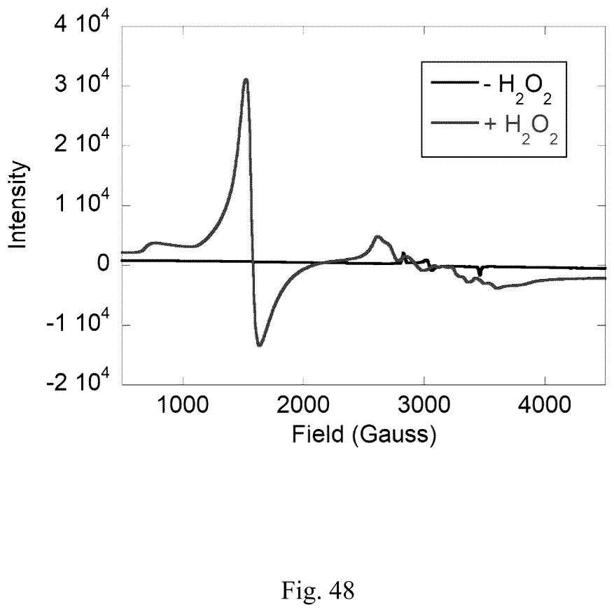

The oxidation of the metal to Fe(III) was confirmed with EPR (FIG. 48). At 77 K, the oxidized product displayed signals consistent with both high-spin and low-spin Fe(III), suggesting that the products may include spin-crossover species. The reaction was also studied at room temperature (RT) using the Evans' method to measure solution-state magnetic susceptibilities. After the reaction with H₂O₂, the μ_{eff} increased to 5.7±0.3μ_{B}, consistent with most of the metal in the oxidized product being high-spin Fe(III) at RT.

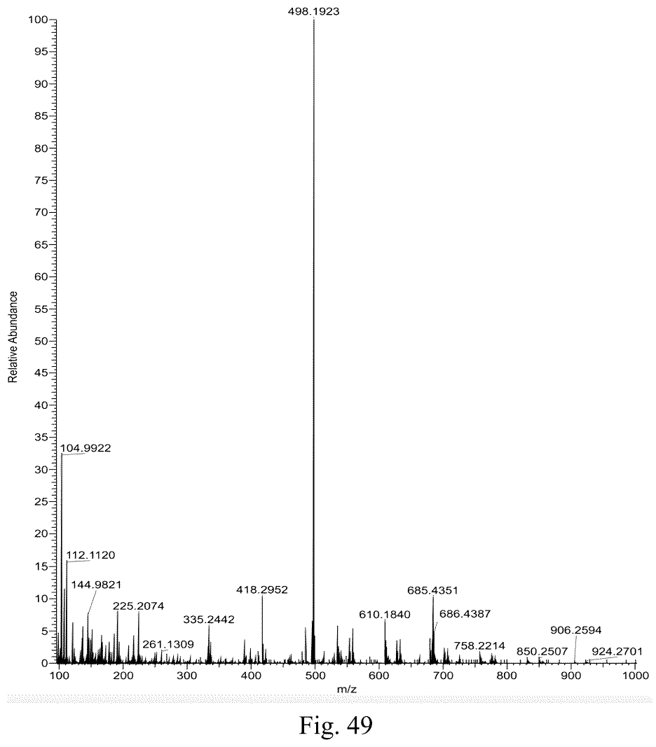

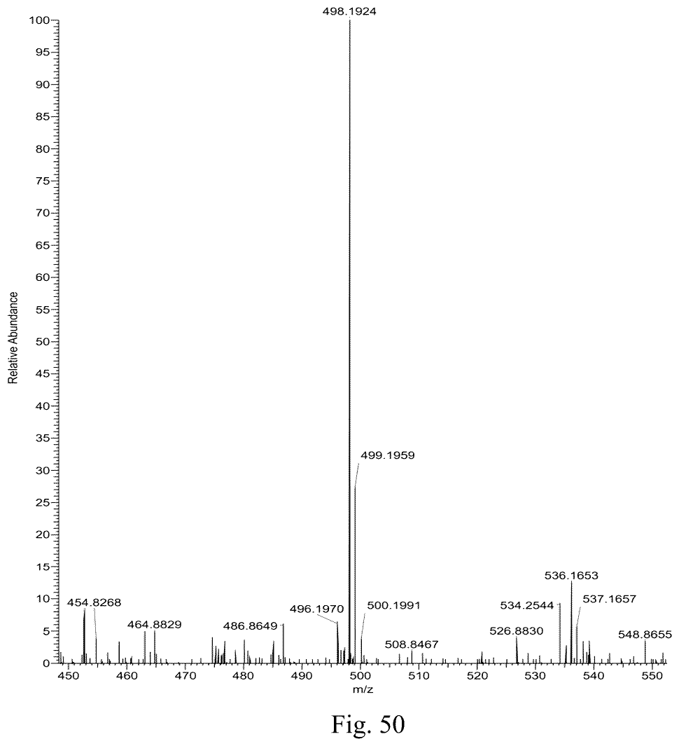

The oxidation of 1 by H₂O₂ appeared to be partly reversible in that the ligand could be reduced back to the diquinol form but the metal remained in the +3 oxidation state. When 1 was oxidized by 4 equiv. of H₂O₂ for 60 min, the subsequent reaction with 4 equiv. of either cysteine or dithionite yielded a species with a m/z feature at 498.19, which was consistent with an Fe(III) complex with the reduced and doubly deprotonated form of the ligand (FIG. 49, FIG. 50). When 0.1 mM of the Fe(III) complex with the reduced ligand, [Fe^{III}(H₃qp4)](OTf)₂ (3), was allowed to react with 10 mM of L-cysteine in pH 7.4 HEPES buffer for 4 h, the 589 nm feature associated with ferrous 1 was not restored, which led to the conclusion that the metal ion remained in the +3 oxidation state.

### Magnetic Resonance Imaging

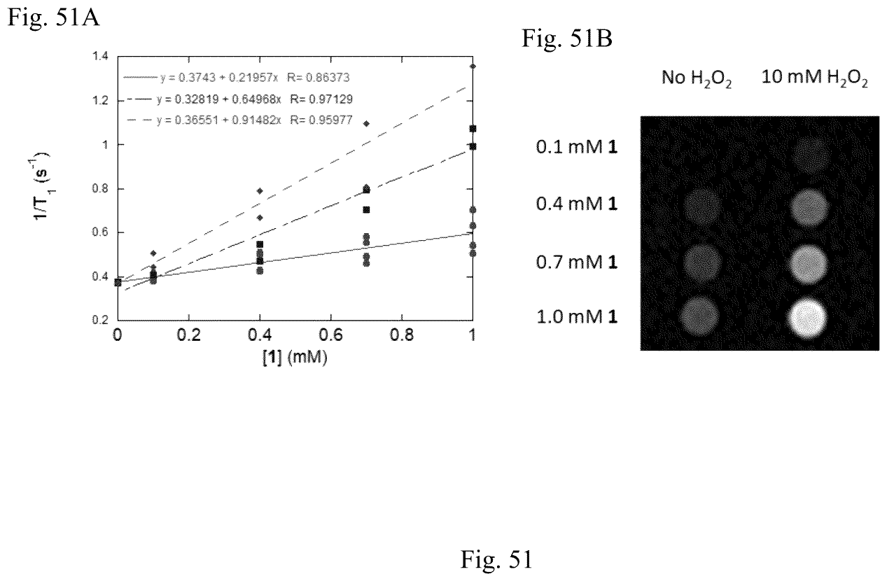

The MRI properties of 1 were assessed using methods that were previously employed in studies of manganese-containing MRI contrast agents. The relaxivity of 1 was measured before and after its reaction with excess H₂O₂ using a 3 T MRI scanner (FIG. 51). The r₁ for the pre-activated complex was calculated from the T₁ values of aqueous solutions containing 50 mM HEPES buffered to pH 7.00 and 0-1 mM 1. T₁ measurements were also acquired for oxidized samples that contained 10 mM H₂O₂ in addition to the aforementioned reagents. The T₁ values were measured 30 min and 60 min after the solution samples were initially prepared.

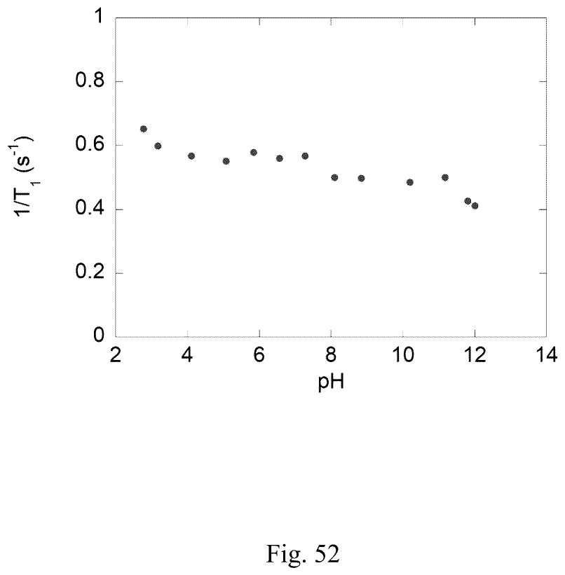

The r₁ value of pre-activated 1 was found to be 0.22 (±0.09) mM⁻¹ s⁻¹, which was similar to values measured for other Fe(II) complexes. The relaxivity of pre-activated 1 was also measured at various pH values between 2 and 12 (FIG. 52). As the solution was made more basic, the R₁ gradually decreased from 0.65 s⁻¹ to 0.41 s⁻, with the iron-free water reference having a R₁ value of 0.36 s⁻. Between pH 6.5 and 8.0, which should encompass the range of physiologically relevant pH values that a sensor could encounter in vivo, the R₁ decreased by a mere 0.06 s⁻. Slight changes to the local pH should not significantly impact the relaxivity of 1.

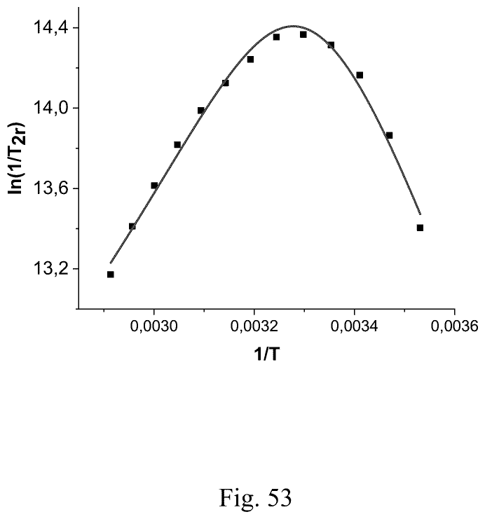

The quinol- and Mn(II)-containing H₂O₂ sensors previously reported displayed more drastic drops in their relaxivity upon basification. The decrease in R₁ was attributed to the weakly metal-binding quinols getting deprotonated to much more strongly binding quinolates. Under acidic conditions, water molecules can displace the quinols, leading to higher aquation numbers and thereby higher relaxivities. It was confirmed that water exchange occurred on the Fe(II) metal center at pH 7.4 with ¹⁷O NMR (FIG. 53). The data were consistent with a kₑₓ²⁹⁸=2.7×10⁶ s⁻, ΔH^{‡}=54.5±3.2 kJ mol⁻¹, ΔS^{‡}=61±11 J mol⁻¹ s⁻¹, and an aquation number (q) of 1.6. The highly positive ΔS^{‡} was consistent with a dissociative mechanism for water exchange on the metal center.

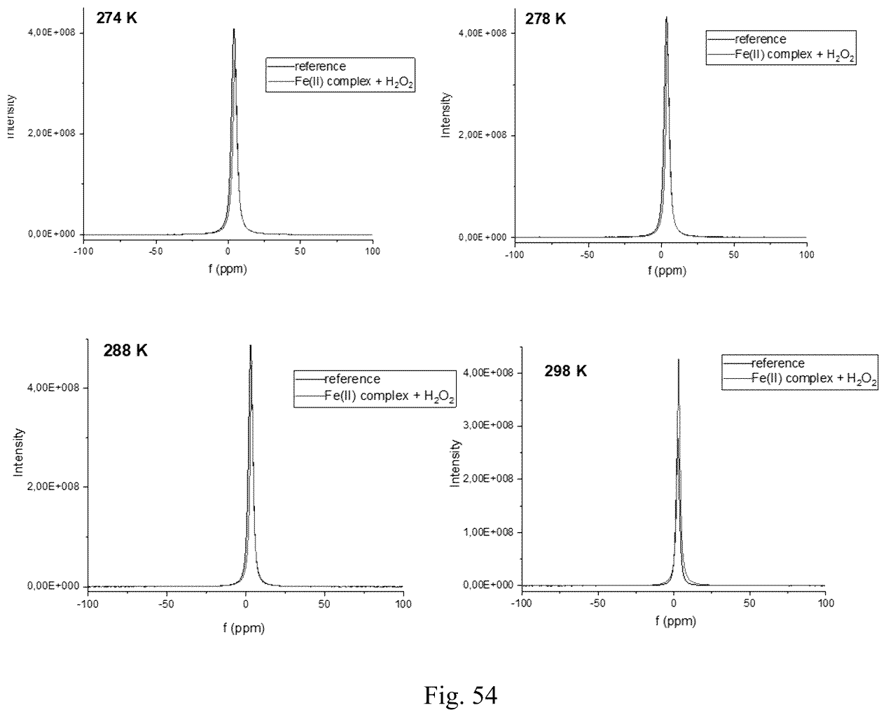

Upon oxidation by H₂O₂, the r₁ increased over 4-fold to 0.91 (±0.26) mM⁻¹ s⁻¹. Gale's Fe(II)-PyC3A complex, by comparison, exhibited a 10-fold increase in relaxivity at 1.4 T as the complex is oxidized to Fe(III), with even larger responses under stronger magnetic fields. As with the Mn(II) complex with H₄qp4, the enhancement in r₁ occurred gradually when a large excess of H₂O₂ was added in a single portion. The r₁ required 60 min to reach its maximum value after 10 mM H₂O₂ was added. The maximum r₁ was in the middle of the range for Fe(III)-containing MRI contrast agents (Snyder, E. M. et al., 2020, Angew. Chem. Int. Ed., 59:2414). The relatively low value of r₁ for the activated sensor may suggest that the Fe(III) may lack an inner-sphere water. When mixtures of 1 and H₂O₂ were analyzed by ¹⁷O NMR, it was found that the iron did not alter the line-width of the water peak, confirming negligible water exchange on the NMR timescale for the oxidized product(s) (FIG. 54).

### Preparation and Characterization of a Ferric Oxidized Standard

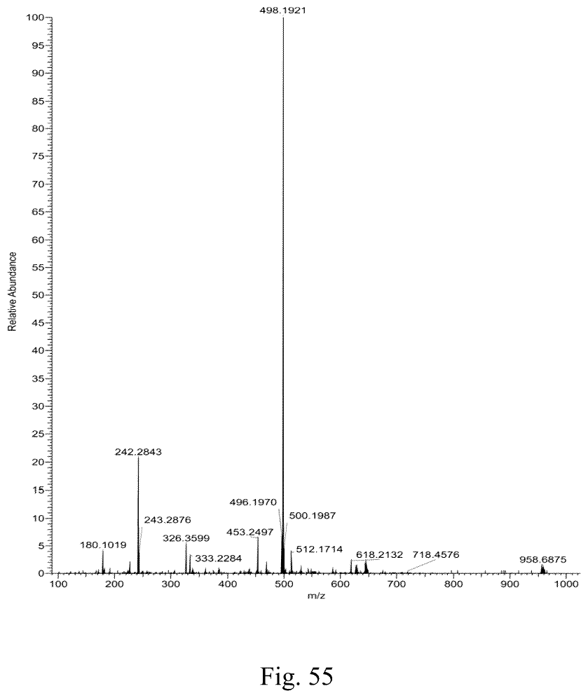

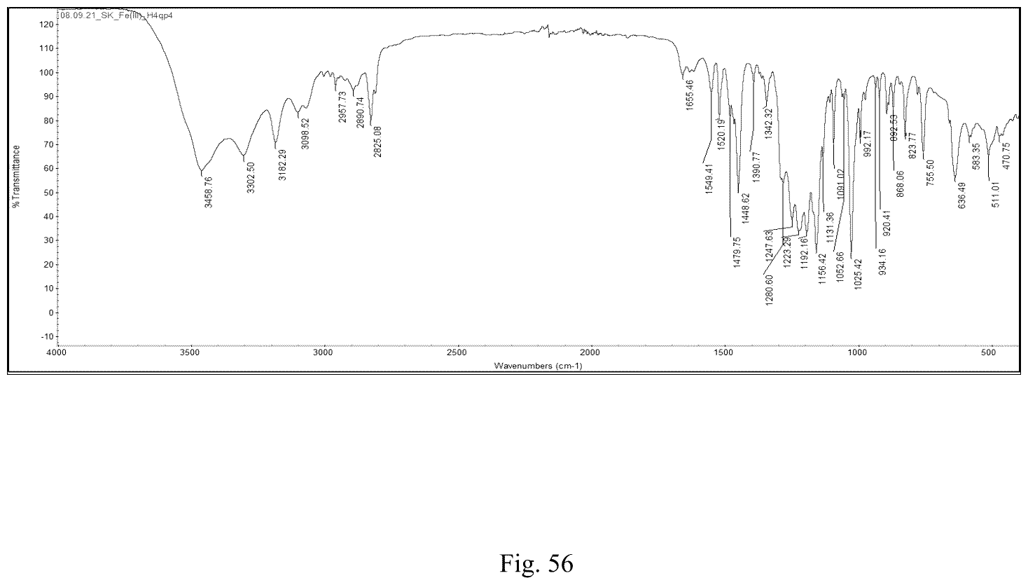

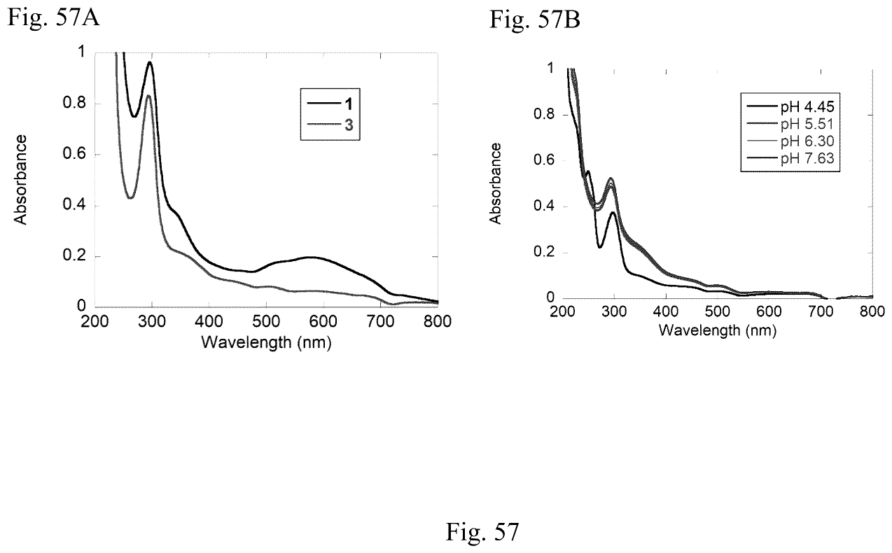

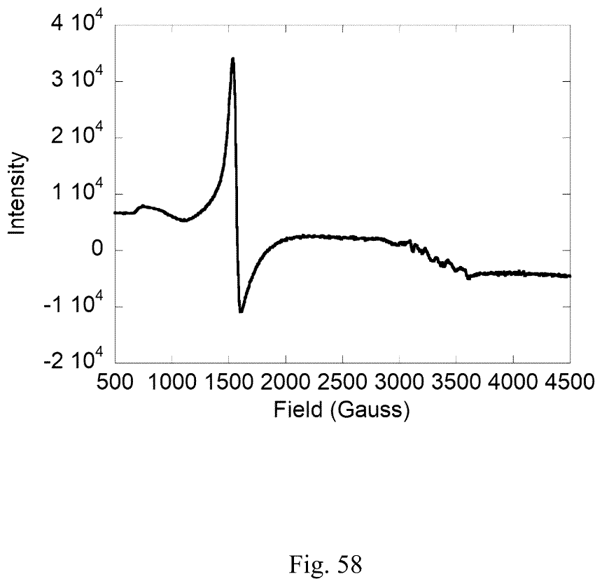

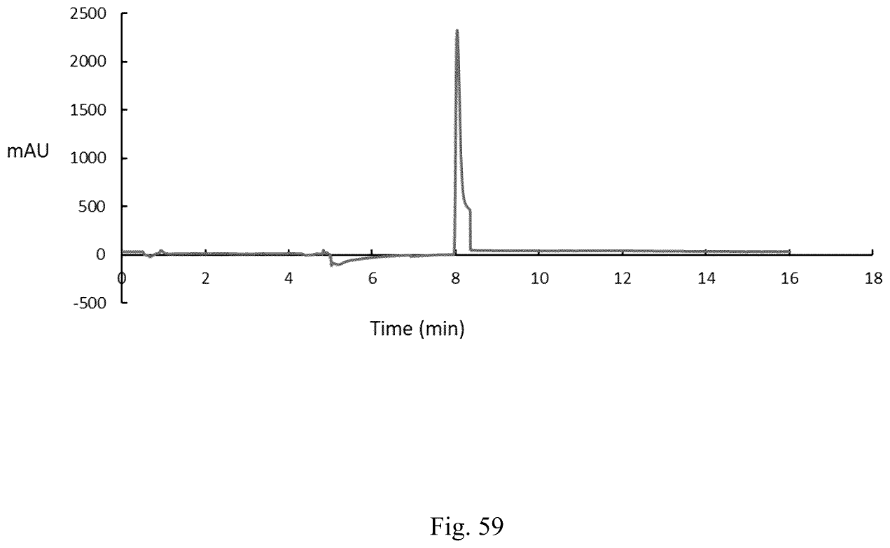

Complex 2, which featured Fe(III) bound to the reduced form of the H₄qp4 ligand, was prepared through aerobic oxidation of 1 in trace quantities. The conjugate acid of 2, [Fe^{III}(H₃qp4)](OTf)₂ (3), could also be prepared by directly reacting H₄qp4 with Fe^{III}(OTf)₃ in MeCN. Although it was not structurally characterized, 3 was characterized by elemental analysis, MS, IR, UV/vis, and EPR (FIG. 55, FIG. 56, FIG. 57, FIG. 58). The UV/vis spectrum lacked the intense 589 nm band observed for 1. The EPR displayed an intense signal at g=4.3, confirming a high-spin Fe(III) species. HPLC data confirmed both the purity of the complex and the complexation of the ligand to the metal center (FIG. 59). Only a single peak was observed in the trace, and its 8.02 min retention time differed from both those of both 1 (7.50 min) and free H₄qp4 (2.32 min) under the same conditions.

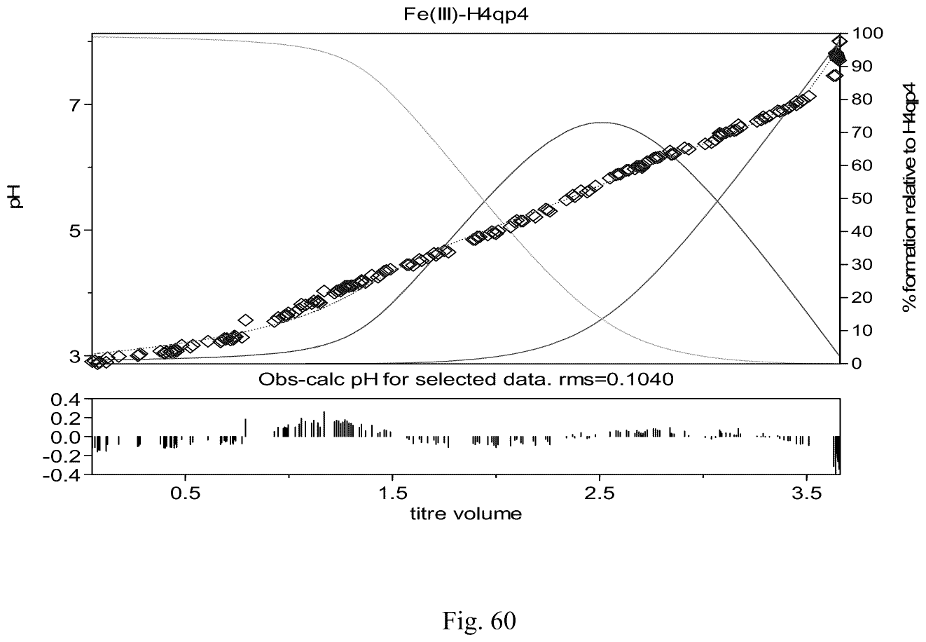

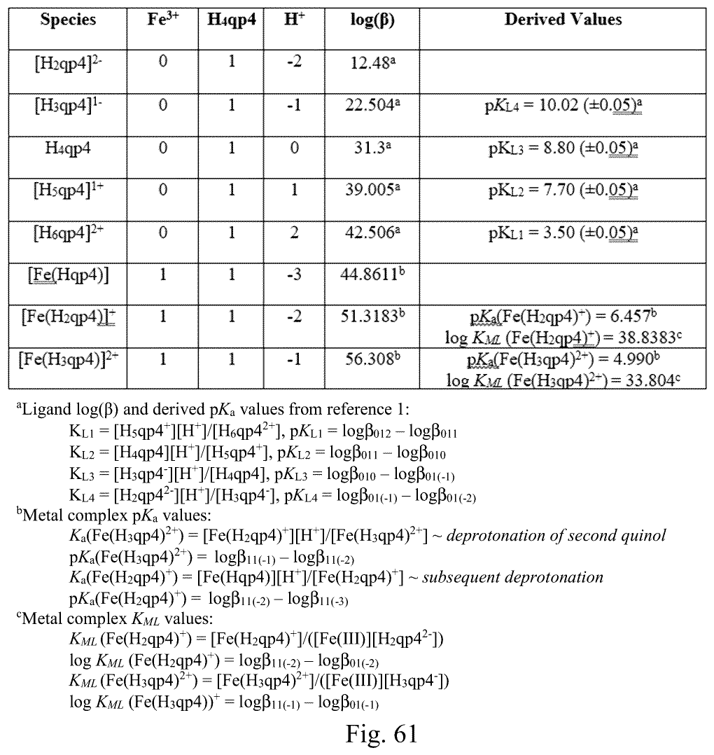

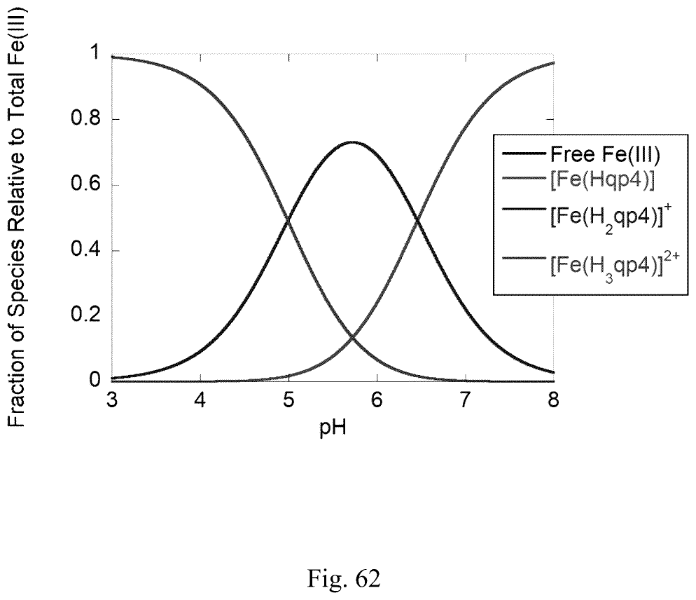

The speciation of Fe(III)/H₄qp4 mixtures was analyzed between pH 3.0 and 8.0 using potentiometric pH titrations (FIG. 60). As the pH increased, two ionization events were observed, consistent with pKₐ values of 4.99 and 6.46 (FIG. 61, FIG. 62). The UV/vis spectra did not change appreciably between pH 5.5 and 7.6, suggesting that the second ionization event did not correspond to the loss of the first proton from one of the quinol groups (FIG. 57B)—this normally induces large changes to the UV/vis features (FIG. 39). The first Fe(III)-quinol group likely deprotonated below pH 3.0, and it was believed that the 4.99 pKₐ value instead corresponded to the deprotonation of the second quinol: [Fe^{III}(H₃qp4)]²⁺→[Fe^{III}(H₂qp4)]⁺+H⁺. The second ionization event was more difficult to assign. It could have corresponded to the deprotonation of the non-metal-coordinating hydroxy group of one of the quinols. Alternatively, it could have corresponded to the deprotonation of a Fe(III)-bound water to OH⁻. Precipitate was observed for 3 at approximately pH 8, further differentiating this titration from that of 1. The log K_{ML} values for [Fe^{III}(H₃qp4)]⁺ and [Fe^{III}(H₂qp4)] were 33.80 and 38.84, respectively (FIG. 61), which were much greater than the analogous values with Fe(II). Other iron complexes with macrocyclic ligands showed similarly large gains to their stabilities upon exchanging Fe(II) for Fe(III) (Martell, A. E. et al., 1996, Can. J. Chem. 74:1872).

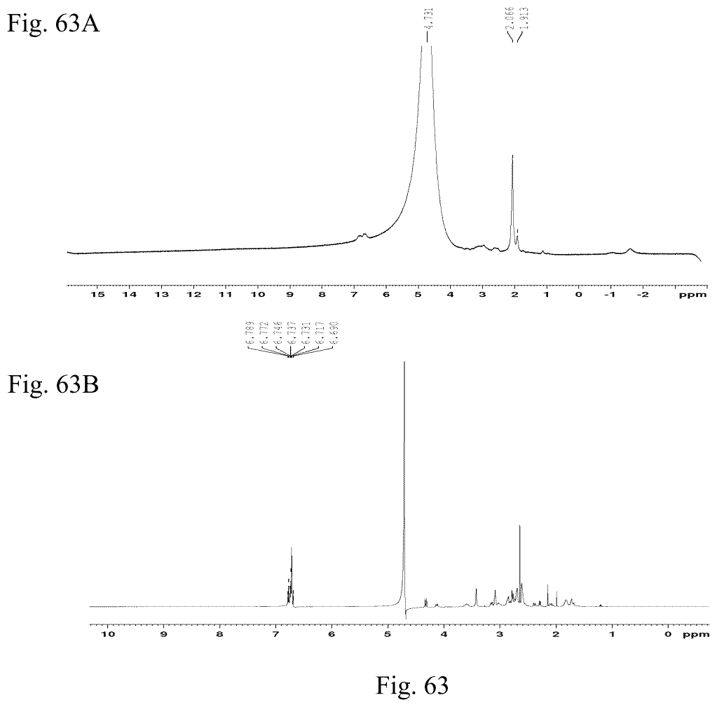

The stability of 3 was assessed in the presence of a competing metal ion. When the reaction was monitored between 10 mM 3 and 20 mM Zn(ClO₄)₂ by ¹H NMR, only trace amounts of the Zn(II) complex were observed with H₄qp4 at 48 h (FIG. 63). Previously, it was found that the products of the reaction between [Mn^{II}(H₃qp4)](OTf) and H₂O₂ likewise did not exchange metal ions readily.

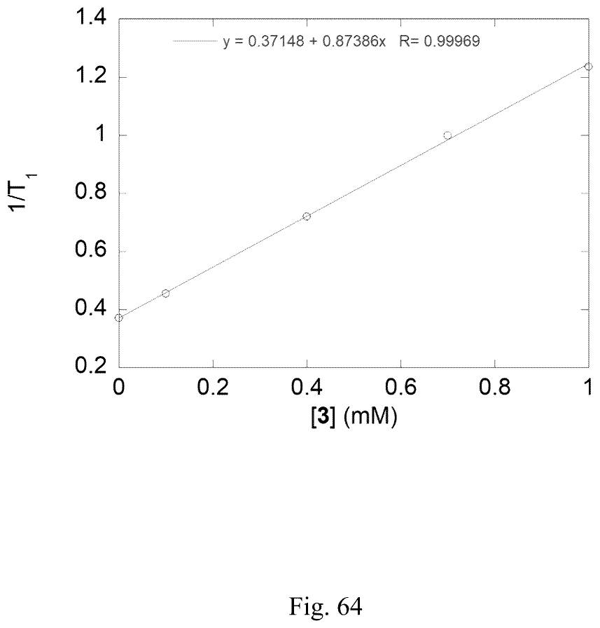

The relaxivity of 3, which will spontaneously deprotonate to 2 at pH 7.0, was assessed in order to determine how much metal oxidation by itself contributes to the H₂O₂ response of 1. The measured r₁ of 0.87 mM⁻¹ s⁻ was within error of the 0.91 mM⁻¹ s⁻ value (FIG. 64), confirming that the relaxivity response of 1 to H₂O₂ resulted almost entirely from metal oxidation. This result also suggested that subsequent reduction of the oxidized form of the sensor would not reverse the r₁ response. This differed from the H₂O₂ response observed for [Mn^{II}(H₃qp4)]⁺, which had been correlated to oxidation of the ligand to a less highly chelating form that opens new water coordination sites on the Mn(II) ion. The smaller size of Fe(III) relative to both Fe(II) and Mn(II) should also favor lower coordination numbers and thereby lower values of q (Casanova, D. et al., 2003, Chem. Eur. J., 9:1281).

### Preliminary Catalase Activity

The Mn(II) complex with H₄qp4 likewise displayed a delayed response to H₂O₂. Counterintuitively, adding a smaller concentration of H₂O₂ accelerated the oxidation of the Mn(II) complex to its higher-relaxivity form. Based on these observations, it was previously proposed that the oxidation of the H₄qp4 complex proceeds through a transient higher-valent metal complex that can either oxidize the quinols through a relatively slow intramolecular reaction or react with a second equiv. of H₂O₂. The intramolecular reaction would become more prominent as the H₂O₂ is depleted. With high concentrations of H₂O₂, conversely, the compound acts as a functional mimic of catalase.

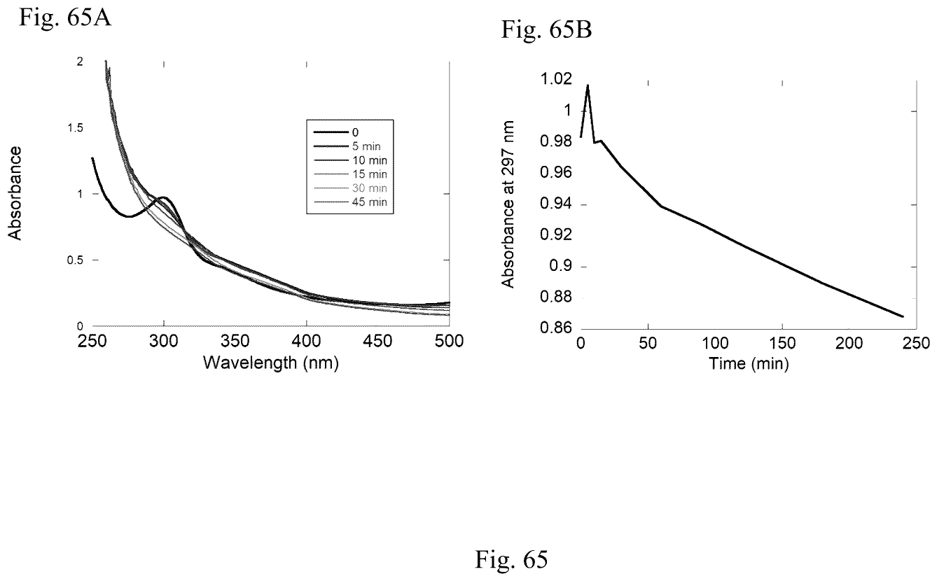

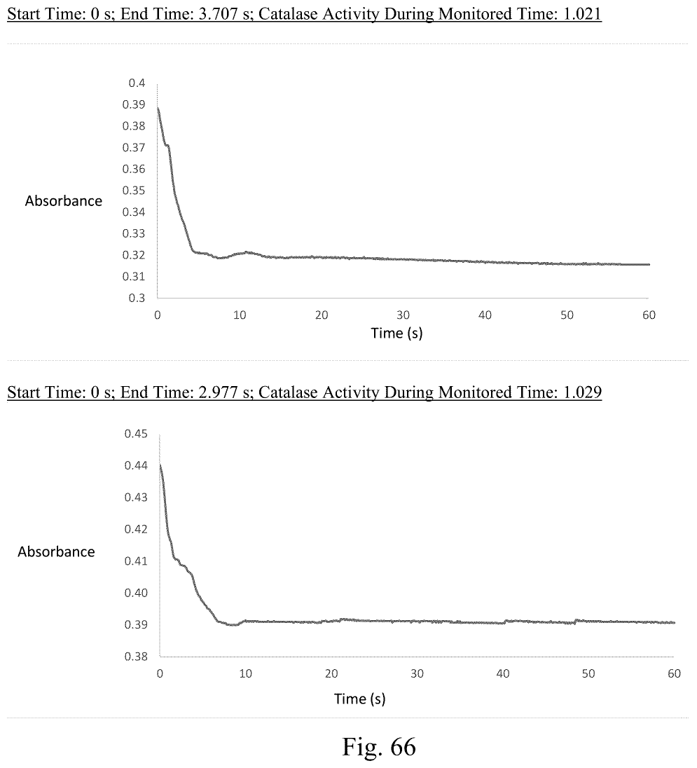

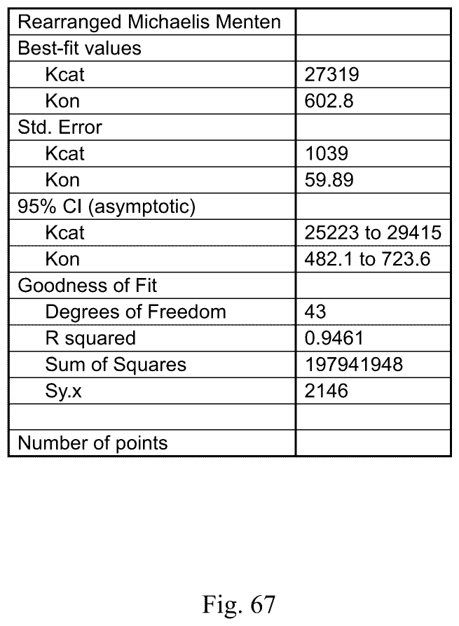

When a lower amount of H₂O₂ was added to oxidize 1, the quinol-derived features in the UV/vis vanished more quickly (FIG. 65). With 0.60 mM H₂O₂, the complex oxidation appeared to finish within 30 min, rather than 60 min. Since biologically relevant concentrations of H₂O₂ are believed to be sub micromolar (Giorgio, M. et al., 2007, Nat. Rev. Mol. Cell. Biol., 8:722), the observed catalase activity would not be anticipated to compete with the oxidation reactions that lead to changes in r₁ in vivo. The iron-catalyzed decomposition of H₂O₂ was further analyzed and an initial rate of nₒ/[1]_{T} of 4.35×10³ s⁻ was calculated (FIG. 66), which was slightly slower than the 6.6×10³ s⁻¹ value for the manganese analog. The activity's dependence on the concentration of H₂O₂ could be fit to the Michaelis Menten equation. The best fitting model was consistent with k_{cat}=2.73 (±0.10)×104 s⁻ and kₒₙ=6.03 (±0.60)×10⁵ M⁻¹ s⁻¹ (FIG. 67). Further studies on the antioxidant properties of 1 are underway.

### Lipophilicity and Cytotoxicity

The lipophilicity of MRI contrast agents can impact how quickly they clear the body, with more lipophilic compounds possibly getting indefinitely trapped within cells (Carney, C. E. et al., 2015, J. Biol. Inorg. Chem., 20:971). The lipophilicity of 1 was assessed by first measuring the n-butanol/water partition coefficients and then correlating it to a n-octanol/water value using an established calibration curve (Ran, Y. et al., 2002, Chemosphere, 48:487; Engelmann, F. M. et al., 2007, Int. J. Pharm., 329:12). The log P_{BW} value was calculated to be −0.00047 (Eq. 1), which translated to a log P_{OW} value of −0.5407 (Eq. 2). The results indicated that 1 was relatively hydrophilic and should not be cell-permeant.

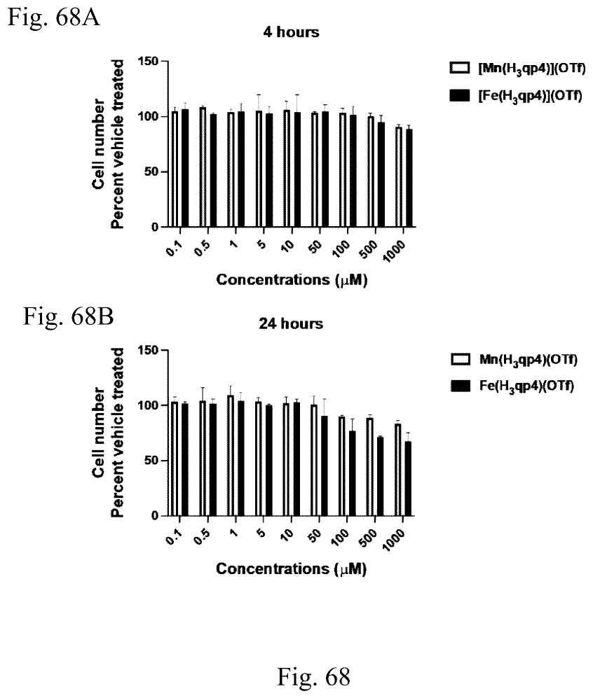

The cytotoxicity of 1 was investigated using rat cardiac cells (H9c2). Although uncomplexed iron is highly toxic, it was found that H₉c2 cells can tolerate high doses of 1 (FIG. 68). When the cells were incubated with 1 for 4 h, no significant impact on their viability was observed with concentrations up to 500 μM. This same concentration did kill approximately 25% of the cells at 24 h, but a freely circulating MRI contrast agent would be expected to clear the body well before this time. Over 24 h, the iron complex was slightly more toxic than its manganese analog. Both H₄qp4 complexes were less toxic than prior reported sensors, which begin to noticeably impact cell viability at 50 μM.

To conclude, it was found that substituting Fe(II) for Mn(II) in the H₄qp4 framework resulted in a highly water- and kinetically air-stable complex that exhibited a higher percentile increase in r₁ upon reaction with H₂O₂. Despite the similar aqueous speciations of the Fe(II) and Mn(II) compounds, the responses to H₂O₂ relied on fundamentally different mechanisms. Whereas the higher r₁ of the manganese sensor was connected to an increase in q enabled by oxidation of the organic component, that of the iron system appeared to result almost entirely from changes to the characteristics of the oxidized metal center.

These data suggest the compounds may provide improved detection of H₂O₂ and other ROS molecules for diagnostic purposes. However, overall the invention is very early in development and has yet to be tested within animals or compared to existing FDA-approved contrasting agents. Hence, significant R&D and financial resources will be required to enter clinical trials and achieve FDA approval. Nevertheless, further development of this technology could lead to a new class of contrast agents and better visualization of tissues and disease diagnosis. Key benefits include a novel class of compounds that improve the imaging and analysis of ROS activity within the body, several prototype compounds have been developed with data showing the ability to be used as contrast agents in a concentration-dependent manner in vitro, and the potential to improve the diagnostic accuracy of MRI and potentially other imaging modalities for many diseases.

### Materials and Methods

### Materials

All chemicals and solvents were purchased from Sigma-Aldrich and used as received unless otherwise noted. All deuterated solvents were bought from Cambridge Isotopes. Diethyl ether (ether) and methanol (MeOH) were bought from Fisher. Methylene chloride (CH₂Cl₂) was purchased from Mallinckrodt Baker. 1,8-Bis(2,5-dihydroxybenzyl)-1,4,8,11-tetraazacyclotetradecane (H₄qp4) was prepared through a previously described procedure (Karbalaei, S. et al., 2021, Inorg. Chem., 60:8368).

### Instrumentation

All ¹H and ¹³C nuclear magnetic resonance (NMR) spectra were recorded on either a 400 MHz or a 600 mHz AV Bruker NMR spectrometer. All reported NMR resonance peak frequencies were referenced to internal standards. ¹⁷O NMR data were collected on a Bruker AVANCE DRX 400WB spectrometer with a superconducting wide-bore magnet operating at a 54.24 MHz resonance frequency and a 9.4 T magnetic induction. A Varian Cary 50 spectrophotometer was used to collect optical data, which were then processed using software from the WinUV Analysis Suite. Electron paramagnetic resonance (EPR) spectra were collected using a Bruker EMX-6/1 X-band EPR spectrometer operated in the perpendicular mode and subsequently analyzed with the program EasySpin. All EPR samples were run as frozen solutions in quartz tubes. A Johnson Matthey magnetic susceptibility balance (model MK I #7967) was used to measure the magnetic moments of solid samples of the metal complexes and estimated the diamagnetic component of the susceptibility using Pascal's constants (Bain, G. A. et al., 2008, J. Chem. Educ. 85:532). Solution-state magnetic moments were obtained using the Evans method (Evans, D. F. 1959, J. Chem. Soc., 2003). Cyclic voltammetry (CV) was performed under N2 at 294 K with an Epsilon electrochemistry workstation (Bioanalytical System, Inc.). The working, auxiliary, and reference electrodes were gold, platinum wire, and silver/silver(I) chloride, respectively. High-resolution mass spectrometry (HR-MS) data were collected at the Mass Spectrometer Center at Auburn University on a Bruker microflex LT MALDI-TOF mass spectrometer via direct probe analysis operated in the positive ion mode. Solid samples of the Mn(II) complex were dried, stored under N2, and sent to Atlantic Microlabs (Norcross, GA) for elemental analysis.

### X-Ray Crystallography

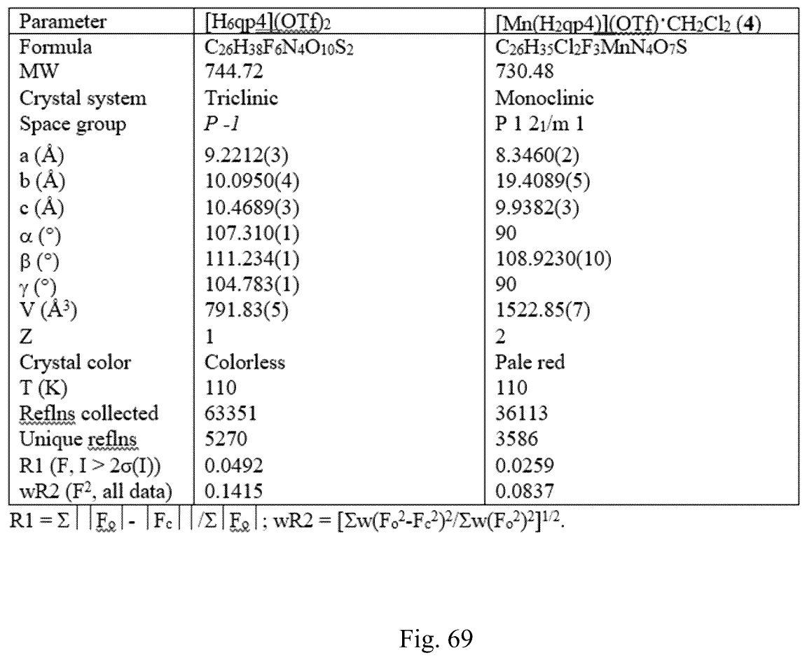

Crystallographic data for (H₆qp4)(OTf)₂ and the oxidized product [Mn(H₂qp4)](OTf) were collected using a Bruker D8 VENTURE κ-geometry diffractometer system equipped with a Incoatec IμS 3.0 microfocus sealed tube and a multilayer mirror monochromator (Mo Kα, λ=0.71073 Å). Diffraction data were integrated with the Bruker SAINT software package using a narrow-frame algorithm. Data were corrected for absorption effects using the Multi-Scan method (SADABS). The structure was solved and refined using the Bruker SHELXTL Software Package. Selected crystallographic data is presented in FIG. 69.

### Potentiometric Titrations

The aqueous speciations of H₄qp4 and its Mn(II) complex were assessed using a METROHM 765 Dosimat with a jacketed, airtight glass titration vessel. A Fisher Scientific Accumet Research AR15 pH meter was used to monitor the pH of the sample solutions during the titrations. The electrode was calibrated before each titration using commercially available standard solutions buffered to pH 4.0, 7.0, and 10.0. All samples were purged with argon prior to analysis and subsequently analyzed under an argon atmosphere at 25° C. to prevent carbonate contamination. All solution samples were prepared in solutions of 100 mM KCl in deionized Millipore water. The titrations investigating metal-ligand speciation were run with solutions that contained a 1:1 molar mixture of the ligand and MnCl₂·(4H₂O). Carbonate-free solutions of 0.10 M KOH and 0.10 M HCl were prepared using argon-saturated deionized Millipore water. The titration data were analyzed and fit to speciation models using the Hyperquad2006 program (Gans, P. et al., 1996, Talanta, 43:1739).

The aqueous speciation of H₄qp4 was previously determined. Those for its Fe(II) and Fe(III) complexes were assessed using a METROHM 765 Dosimat with a jacketed, airtight glass titration vessel. A Fisher Scientific Accumet Research AR15 pH meter was used to monitor the pH of the sample solutions during the titrations. The electrode was calibrated before each titration using commercially available standard solutions buffered to pH 4.0, 7.0, and 10.0. All samples were purged with argon prior to analysis and subsequently analyzed under an argon atmosphere at 25° C. to prevent carbonate contamination. All solution samples were prepared in solutions of 100 mM KCl in deionized Millipore water. The titrations investigating metal-ligand speciation were run with solutions that contained a 1:1 molar mixture of the ligand and FeCl₂·(4H₂O). Carbonate-free solutions of 0.10 M KOH and 0.10 M HCl were prepared using argon-saturated deionized Millipore water. The titration data were analyzed and fit to speciation models using the Hyperquad2006 program.

### High-Pressure Liquid Chromatography (HPLC)

HPLC was performed with UV detection at 254 nm using an Agilent 1100 series apparatus and an Agilent Zorbax SB-C18 column (4.6×150 mm, 5 μm pore size). The following eluents were used: A) 99.9% water with 0.1% trifluoroacetic acid (TFA) and B) 99.9% MeCN with 0.1% TFA. The following method was used:

Gradient 90% A and 10% B to 100% B over 20 min. Flow rate=0.20 mL/min, injection volume=25.0 μL, column temperature=37.0° C. Before each run, the HPLC instrument was flushed with eluent 100% A to 100% B over 16 min with a flow rate of 0.49 ml/min and an injection volume of 25.0 μL.

### Measurement of Aquation Numbers (q)

Aquation numbers (q) were calculated from the maximum ¹⁷O transverse relaxivity, r₂ₘₐₓ°, and the equation: q=r₂ₘₐₓ°/510; Gale, Zhu, and Caravan previously used this relationship to estimate the inner-sphere hydration state of Mn(II) in coordination complexes (Gale, E. M. et al., 2013, J. Am. Chem. Soc., 135:18600). Relaxation rates were measured both for aqueous solutions containing Mn(II) complexes and for metal-free solutions buffered to pH 7.4. The linewidths at half-height of the signal were determined by a deconvolution procedure on the real part of the Fourier transformed spectra with a Lorentzian shape function in the data analysis module of Bruker Topspin 1.3® software. The measurements were performed with a commercial 5 mm Bruker broadband probe thermostat with a Bruker B-VT 3000 variable temperature unit. Samples were prepared by adding a solution of solid dissolved in a minimal amount of MeCN to an aqueous solution containing either 60 mM HEPES or 60 mM MOPS buffered to pH 7.4. 100 (v/v) of ¹⁷O-labeled water (10%, D-Chem Ltd. Tel Aviv, Israel) was added to these solutions resulting in a total enrichment of 1% 170 in the studied samples. The resultant mixtures contained either 6.0 mM or 2.5 mM of the Mn(II) complex. The 2.5 mM sample was oxidized by 15 equiv. of H₂O₂ for 15 min prior to data acquisition. The temperature-dependence of ¹⁷O-line broadening was studied from 274.2 to 338.2 K.

### Magnetic Resonance Imaging (MRI)

All MRI data were collected at the Auburn University MRI Research Center on a Siemens Verio open-bore 3-T MRI clinical scanner. A 15-channel knee coil was used to simultaneously image 12-15 samples. The imaging procedure was identical to those used for similar studies (Zhang, Q. et al., 2011, Inorg. Chem. 50, 9365; Yu, M. et al., 2014, J. Am. Chem. Soc., 136:12836; Yu, M. et al., 2017, Inorg. Chem., 56:2812; Yu, M. et al., 2012, Inorg. Chem. 51:9153). An inversion recovery (IR) sequence was used that featured a non-selective adiabatic inversion pulse followed by a slice-selective gradient recalled echo (GRE) readout after a delay period corresponding to the inversion time (TI) (Bernstein, M. A. et al., 2004, Handbook of MRI Pulse Sequences; Haacke, E. M. et al., 1999, Magnetic Resonance Imaging: Physical Principles and Sequence Design). The GRE was a saturation readout, such that only one line of k-space was acquired per repetition time (TR), in order to maximize both signal strength and the accuracy of the T₁ estimates. The specific imaging parameters were as follows: TR was set to 10 s, TI was varied from 10 to 2600 ms over 20 steps, the echo time (TE) was set to 2.75 ms, the flip angle equaled 90°, averages=1, slice thickness=10 mm, field of view=64×64 mm, matrix=64×64, resulting in a pixel size of 1.0×1.0×10.0 mm. All samples were run in 50 mM solutions of HEPES in water, buffered to pH 7.0 and kept at 22° C. The manganese content or iron content was systematically varied from 0.10 to 1.00 mM. The inverses of the T₁ values from two separate batches of contrast agent were plotted versus the concentration of Mn(II) to obtain r₁ values.

### MRI Data Analysis

Image analysis was performed using custom Matlab programs (Mathworks, Natick, MA). The initial TI=4.8 ms image was used as a baseline to determine circular region of interest (ROI) boundaries for each sample; from these, the mean pixel magnitudes for each ROI were calculated. For each of the 36 subsequent TI images, the same ROI boundaries were applied, and the mean pixel magnitude calculations were repeated. This gave consistent ROI spatial definitions and a corresponding time course of magnitudes for each of the samples over all the TI time points. Each sample's complex phase was used to correct the magnitude polarity to produce a complete exponential T₁ inversion recovery curve. The Nelder-Mead simplex algorithm (Nelder, J. A. et al., 1965, Comput. J., 7:308) was applied to each sample's exponential curve to estimate its corresponding T₁ value.

### Preliminary Analysis of Catalase Activity

In order to assess the ability of the Mn(II) complex to catalyze the degradation of H₂O₂, we reacted 100 nM 1 with 10 mM H₂O₂ in 100 mM phosphate solution buffered to pH 7.0 and monitored the absorbance at 240 nm over time. H₂O₂ has a molar extinction coefficient of 39.4 M⁻¹ cm⁻at this wavelength (Nelson, D. P. et al., 1972, Anal. Biochem. 49:474). The consumption of H₂O₂ was evaluated using a UV-1601 Shimadzu spectrophotometer.

### ¹⁷O NMR Water Exchange Measurements

The aquation numbers (q_{H2O}), rate constants and activation parameters for the water exchange at Fe(II) and Fe(III) centers were determined from the temperature dependence of the ¹⁷O-line broadening measured for aqueous solutions containing Fe(II) or Fe(III) complexes and for metal-free solutions buffered to pH 7.4 over the temperature range 274.2-343.2 K. The line widths at half-height of the signal were determined by a deconvolution procedure on the real part of the Fourier-transformed spectra with a Lorentzian shape function in the data analysis module of Bruker Topspin 1.3 software. The measurements were performed with a commercial 5 mm Bruker broadband probe thermostated with a Bruker B-VT 3000 variable-temperature unit. Samples were prepared by adding a solution of solid dissolved in a minimal amount of MeCN (20% (v/v)) to an aqueous solution containing 60 mM 3-(N-morpholino)propanesulfonic acid (MOPS) buffered to pH 7.4. ¹⁷O-labeled water (10%; D-Chem Ltd., Tel Aviv, Israel) was added to this solution resulting in a total enrichment of 1% 170 in the studied samples. The resultant mixture contained 9.8 mM of the Fe(II) complex. The Fe(III) complex was obtained by the oxidation of 9.8 mM Fe(II) using 10 equiv. of H₂O₂ in 60 mM MOPS buffered to pH 7.4. The reaction was allowed to proceed for 15 min prior to data acquisition. The NMR data were fit to the Swift-Connick equation (Swift, T. J. 1962, J. Chem. Phys. 37:307). The q_{H2O} variable was set as free parameter, and the B value was fixed. The number of exchanging water molecules was optimized at q_{H2O}=1.6.

### Lipophilicity Measurements

The partition coefficients were obtained in n-butanol/water (log P_{BW}), in which the Fe(II) complex was more soluble, and then correlated to a corresponding n-octanol/water value by using a calibration curve prepared with well-known standards (Ran, Y. et al., 2002, Chemosphere, 48:487). The partition between water and n-butanol was determined experimentally with the Fe(II) complex using a variation of the shake-flask method (Engelmann, F. M. et al., 2007, Int. J. Pharm., 329:12). Distilled water and n-butanol were mixed vigorously for 24 h at 25° C., to promote solvent saturation in both phases, and the solvents were separated. Then, 0.1 mL of a solution of the Fe(II)-H₄qp4 complex in water saturated with n-butanol was shaken with 1 mL of n-butanol saturated with water in a plastic tube for 3 min using a Vortex-Genie. The biphasic mixture was centrifuged (3 min at 6000 rpm), and the layers were separated. The concentration of the iron complex in each layer was measured spectrophotometrically. If dilution was needed for the UV/vis measurements, the aqueous layer was diluted with water; whereas for the organic layer, water-saturated n-butanol was used instead. The spectrum baseline was chosen accordingly. The log PBW was calculated using Eq. 1:

log P_{BW}=log(C_{nBuOH}/C_{H2O}) (1)
The log P_{BW} values were converted to the more familiar log P_{OW} using Eq. 2:

log P_{OW}=1.55(log P_{BW})−0.54 (2)

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A compound comprising a metal M and a macrocyclic ligand represented by General Formula I, and any ionic variant thereof: 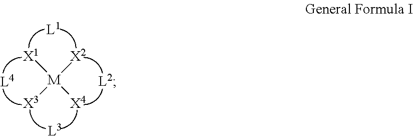
wherein M is a metal is selected from the group consisting of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, rhenium, osmium, iridium, platinum, and any oxidation state thereof,
wherein L¹ to L⁴ are divalent linking groups;
wherein X¹ to X⁴ are each independently selected from O, S, or NR¹;
wherein R¹ is selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, or any conjugate or combination thereof;
wherein at least one of X¹ to X⁴ is represented by NR¹ wherein R¹ is represented by Formula A: 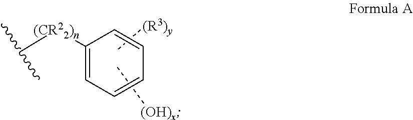
wherein R² and R³ are each independently selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, or combination thereof,
wherein x is an integer from 1 through 5;
wherein y is an integer from 1 through 4;
wherein n is an integer from 1 through 3; and
wherein when the compound is ionic, the compound further comprises a counterion.

2. The compound of claim 1, wherein X¹ and X³ are each represented by NR¹ wherein R¹ is represented by Formula A.

3. The compound of claim 1, wherein R² are each hydrogen.

4. The compound of claim 1, wherein n is 1.

5. The compound of claim 1, wherein x is 2.

6. The compound of claim 1, wherein the metal M is selected from the group consisting of manganese, iron, cobalt, nickel, molybdenum, technetium, ruthenium, cobalt, copper, and rhodium.

7. The compound of claim 1, wherein the metal is manganese or iron.

8. The compound of claim 1, wherein Formula A is represented by Formula B:

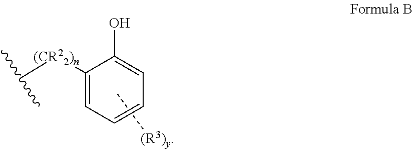

9. The compound of claim 8, wherein y is at least 1 and at least one R³ represents hydroxyl.

10. The compound of claim 8, wherein the OH is coordinated to the metal M.

11. The compound of claim 8, wherein X¹ and X³ are both represented by NR¹ wherein R¹ is represented by Formula B.

12. The compound of claim 11, wherein both OH groups are coordinated to the metal M.

13. The compound of claim 1, wherein Formula A is represented by Formula C:

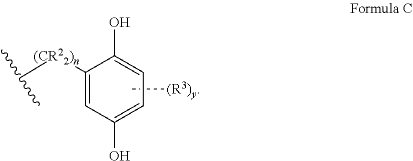

12. The compound of claim 13, wherein X¹ and X³ are both represented by NR¹ wherein R¹ is represented by Formula C.

13. The compound of claim 1, wherein M is further bonded to water.

14. A contrast agent comprising the compound of claim 1.

15. The contrast agent of claim 14, wherein the contrast agent is used in an imaging technique selected from the group consisting of magnetic resonance imaging, photoacoustic imaging, thermal imaging, photothermal imaging, and any combination thereof.

16. A method of enhancing magnetic resonance imaging (MRI) in a living subject, the method comprising the steps of:
administering to a subject an effective amount of a composition comprising a contrast agent; and
imaging the patient by MRI, wherein the MRI image is enhanced as compared to an MR image obtained without said contrast agent;
wherein the contrast agent comprises a metal M and a macrocyclic ligand represented by General Formula I, or a salt thereof: 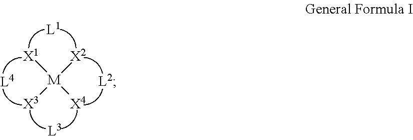
wherein M is a metal is selected from the group consisting of scandium, titanium, vanadium, chromium, manganese, iron, cobalt, nickel, copper, zinc, yttrium, zirconium, niobium, molybdenum, technetium, ruthenium, rhodium, palladium, and silver;
wherein L¹ to L⁴ are divalent linking groups;
wherein X¹ to X⁴ are each independently selected from O, S, or NR¹;
wherein R¹ is selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, or any conjugate or combination thereof;
wherein at least one of X¹ to X⁴ is represented by NR¹ wherein R¹ is represented by Formula A: 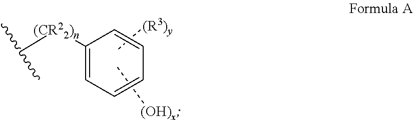
wherein R² and R³ are each independently selected from the group consisting of hydrogen, deuterium, halogen, hydroxyl, thiol, nitro, cyano, nitrile, isonitrile, sulfinyl, mercapto, sulfo, carboxyl, hydrazine, carbonyl, acyl; substituted or unsubstituted: aryl, cycloalkyl, cycloalkenyl, heterocyclyl, heteroaryl, alkyl, alkenyl, alkynyl, amino, monoalkylamino, dialkylamino, monoarylamino, diarylamino, alkoxy, aryloxy, haloalkyl, aralkyl, ester, alkoxycarbonyl, acylamino, alkoxycarbonylamino, aryloxycarbonylamino, sulfonylamino, sulfamoyl, carbamoyl, alkylthio, ureido, phosphoramide, silyl, polymeric, or any conjugate or combination thereof,
wherein x is an integer from 1 through 5;
wherein y is an integer from 1 through 4;
wherein n is an integer from 1 through 3; and
wherein when the compound is ionic, the compound further comprises a counterion.

17. The method of claim 16, further comprising the step of oxidizing the contrast agent with a reactive oxygen species.

18. The method of claim 17, wherein the reactive oxygen species comprises H₂O₂.

19. The method of claim 16, wherein the contrast agent is administered in a concentration of 0.10 to 1.00 mM.

20. The method of claim 16, wherein the contrast agent is administered subcutaneously, intravenously, peritoneally, orally, intramuscular, topical, nasally, intradermally, ocularly, rectally, vaginally, or combinations thereof.
